(19) United States
(12) Patent Application Publication
(10) Pub. No.: US 2016/0253448 A1
(43) Pub. Date: Sep. 1, 2016

(54) CIRCUIT BOARD DESIGN SYSTEM, CIRCUIT BOARD DESIGN METHOD AND PROGRAM RECORDING MEDIUM

(71) Applicant: NEC Corporation, Minato-ku, Tokyo (JP)

(72) Inventor: Masashi OGAWA, Tokyo (JP)

(21) Appl. No.: 14/442,467

(22) PCT Filed: Nov. 18, 2013
(86) PCT No.: PCT/JP2013/006761

§ 371 Date: May 13, 2015

(30) Foreign Application Priority Data
Nov. 21, 2012 (JP) 2012-255557

(51) Int. Cl. G06F 17/50

(52) U.S. Cl. CPC G06F 17/5081

(57) ABSTRACT

Provided is a circuit board design system for designing a circuit board which is mounted with a semiconductor component and is with a cable connected to it. The circuit board design system comprises: an input means which inputs board design information on a circuit board; an EMI characteristic derivation means which derives a characteristic of EMI generated from the circuit board, on the basis of the board design information; a storage means which stores a cable length correction characteristic for deriving the EMI characteristic; and an output means which outputs the EMI characteristic derived by the EMI characteristic derivation means. The EMI characteristic derivation means comprises: an analysis model creation means which creates a simplified analysis model provided with a simplified virtual cable, as an analysis model of the circuit board, on the basis of the board design information; a board analysis means which calculates virtual cable current flowing in the virtual cable by performing electromagnetic field analysis of the simplified analysis model; and an EMI calculation means which calculates actual cable current flowing in the cable by the use of the virtual cable current and the cable length correction characteristic and then calculates a characteristic of EMI radiated from the cable by the use of the actual cable current.

### TECHNICAL FIELD

The present invention relates to a circuit board design system, a circuit board design method and a circuit board design program, all for designing a semiconductor circuit board. It particularly relates to a circuit board design system, a circuit board design method and a circuit board design program, all for designing a circuit board in consideration of electromagnetic field radiation generated from a cable which is connected to a circuit board mounted with semiconductor components.

### BACKGROUND ART

Generally, when a semiconductor integrated circuit (hereafter, also described as an LSI) mounted on a printed circuit board (hereafter, also described as a PCB) is in operation, there arises a problem in that undesirable electromagnetic field radiation to outside is generated as a result of electric current flowing on the PCB being the noise source.

Such electromagnetic field radiation (hereafter, also described as undesirable electromagnetic field radiation or EMI (Electro Magnetic Interference)) becomes a cause of false operation of an electronic device itself in which the PCB is installed or other devices. For this reason, various measures against EMI are taken in electronic devices so as to reduce EMI to be equal to or lower than a predetermined permissible value. As one of such measures, it is requested to design in advance a PCB structure or an LSI layout in a manner to make EMI generated from the PCB to become at a low level.

Common mode radiation is mentioned as one of major elements of EMI generated from a PCB. When electric current flows in a wiring on a board, there occurs electromagnetic coupling between the wiring and a cable connected to the board, and as a result, there flows electric current referred to as common mode current even in the cable. The phenomenon of electromagnetic wave generation by the common mode current being a noise source and the cable working as an antenna is referred to as common mode radiation.

There is a tendency of the common mode radiation to increase, in association with the increase in the amount of current flowing in signal wirings on a PCB and in its flowing speed. Accordingly, in order to suppress the common mode radiation, it becomes necessary to take measures with respect to the PCB structure including its layer configuration, layout and the like, with respect to the characteristics of current flowing in the signal wirings and the length and connection position of the cable, and a measure of adding a countermeasure component, and the like. However, if design change or addition of a countermeasure component is performed after PCB production, for the purpose of suppressing EMI, there occurs a large increase in the design cost. To avoid that situation, it is important, from the aspect of low cost design of a PCB, to estimate the electrical characteristics at the design stage of the PCB and, according to the estimation result, take a measure for EMI suppression as necessary.

As a method for estimating common mode radiation to occur in advance at the PCB design stage, mentioned is a method of analyzing the electrical characteristics on the basis of information on such as the board structure, the structures of components to be mounted and that of a cable. As methods for analyzing the electrical characteristics, in particular, for analyzing electromagnetic field radiation, mentioned are electromagnetic field analysis methods such as a Finite Difference Time Domain (FDTD) method, a Method of Moments (MOM) and a Finite Element Method (FEM). These methods have been widely used in design of a printed circuit board. Accordingly, there has been employed is a PCB design method which performs electromagnetic field analysis of EMI generated from a PCB by the use of the above-described analysis methods, and then performs redesign according to the calculation result, with reference to the structure and specification of the PCB. Further, if a permissive condition of EMI is set in advance, it is possible, by comparing a result of the electromagnetic field analysis of EMI with the condition, to determine whether or not a design has been performed to make EMI generated from the board become at a low level.

A person having deep knowledge in relating fields such as of electrical circuits and electromagnetics, and further of a method of suppressing common mode radiation may have also knowledge of estimating in advance a candidate of an optimum cable connection position and about what kind of countermeasure means is to be used to enable suppression of common mode radiation. The number of necessary patterns to analyze may accordingly be relatively small, and furthermore, the person may have also knowledge about to what extent the accuracy can be decreased in creation of an analysis model without causing a problem. In that case, it may become possible to create a model whose analysis accuracy is secured even with a small analysis scale. However, it is difficult for a general user to perform the same way as such a person having deep knowledge as described above does. Therefore, as a design method, desired is a method which derives common mode radiation generated from a cable, from prepared design information on a PCB, in a short time and with high accuracy, and then automatically determines whether or not the radiation satisfies a permissive condition of EMI, or extracts an optimum design pattern.

In the PCB design stage, for predicting the amount of common mode radiation from a PCB to which a cable is connected, a method capable of calculating the characteristics including common mode current to flow in the cable in a short time and with sufficient analysis accuracy is required. Also required is an analytical design system which can be used by even a user not having deep knowledge of electrical circuits and electromagnetic waves, and enables the user to design a PCB of low EMI on the basis of the calculation results.

Patent Literature 1 (PTL 1) discloses an electromagnetic field strength calculation device which designs a PCB by means of an electromagnetic field analysis method (FIG. 40).

As shown in FIG. 40, the electromagnetic field strength calculation device 101 of PTL 1 comprises a navigation file reading unit 103 which reads a navigation file 102, a “navigation-based data creation unit 104” corresponding to a model creation means, and a memory unit 105. The model creation means comprises a display unit 110 which displays a procedure for a user to input the external size of an electrical circuit device and a procedure for the user to input an analysis frequency for analyzing the electrical circuit after meshing it, and a keyboard input unit 111 for the user to interactively input the input data. The electromagnetic field strength calculation device 101 further comprises an analysis input data file writing unit 106 which writes analysis data obtained by the model creation means, and an electromagnetic field strength calculation unit 108 for calculating analysis result data 109 by using the inputted analysis data as input data for analysis 107. According to the electromagnetic field strength calculation device of PTL 1, even a beginner not skilled in creating input data can easily create input data for obtaining input data for analysis in a short time, and accordingly can efficiently perform electromagnetic field strength calculation.

When creating a model for electromagnetic field analysis of a PCB, it is difficult to increase the analysis accuracy without modeling also a cable, connected to the PCB, which is considerably larger in size compared to the PCB.

Patent Literature 2 (PTL 2) discloses an electromagnetic field strength calculation device which transforms an electrical circuit device including a cable connected to it into an equivalent model, calculates common mode current flowing in the cable by an MOM, and calculates the strength of an electromagnetic field generated by the common mode current (FIG. 41).

The electromagnetic field strength calculation device 201 of PTL 2 comprises an input means 202 for precisely inputting data on a structure of the electrical circuit device consisting of a printed board, a cable or the like, a lead or the like, and a metal housing or the like. The electromagnetic field strength calculation device 201 further comprises an electromagnetic field strength calculation means 203 which calculates the strength of an electromagnetic field radiated by the electrical circuit device on the basis of the inputted structure, and an output means 204 which outputs the calculation result. The electromagnetic field strength calculation means 203 has a partitioning means 210 which partitions the inputted structure into mesh elements. The electromagnetic field strength calculation means 203 further has a derivation means 211 which, on the basis of the partitioned structure, derives simultaneous equations of the MOM taking as unknown quantities an electric current flowing in each of metal portions of the electrical circuit device and equivalent electric and magnetic current flowing in a dielectric portion. The electromagnetic field strength calculation means 203 further has a calculation means 212 which calculates the unknown quantities by solving the simultaneous equations of the MOM derived as above, and a calculation means 213 which calculates from the calculated values the strength of an electromagnetic field radiated by the electrical circuit device. According to the electromagnetic field strength calculation device of PTL 2, as a result of considering also the strength of an electromagnetic field radiated by common mode current flowing in the metal portions other than that of the printed board, the strength of an electromagnetic field radiated by the electrical circuit device can be calculated with high accuracy.

### CITATION LIST

### Patent Literature

[PTL 1] Japanese Patent Application Laid-Open No. H11-161690

[PTL 2] Japanese Patent Application Laid-Open No. H07-302278

### SUMMARY OF INVENTION

### Technical Problem

As a method of deriving radiation from a printed circuit board by means of electromagnetic field analysis, there is one which calculates electromagnetic field radiation on the basis of common mode current flowing in a cable by modeling the whole of a system to be the subject of the analysis. However, the method has a problem in that, when calculating an electromagnetic field radiated from the whole system, the analysis space becomes considerably large because the length of a cable generally is considerably larger than the size of a printed board, and accordingly, a huge amount of calculation cost is required

In electromagnetic field analysis, an analysis space is partitioned into mesh elements, and then an electrical characteristic at each node of the mesh is derived. Therefore, the calculation cost can be reduced by reducing the number of partitioned mesh elements in the analysis space, that is, by increasing the mesh element size. However, because the calculation cost and the analysis accuracy are generally in a trade-off relationship, simply reducing the calculation cost causes decrease in the analysis accuracy, and accordingly makes it impossible to obtain a sufficiently guaranteed analysis result.

By applying the technology of PTL 2 into the technology of PTL 1, it becomes possible for even a person not having deep knowledge of electrical circuits and electromagnetic waves to create a model for electromagnetic field analysis from a PCB structure and accordingly perform quantitative calculation of EMI. However, when a cable connected to the PCB is directly modeled with no change, the analysis scale needs to be large in order to increase the analysis accuracy, which still raises the problem of a huge amount of calculation cost described above.

There is a case where, in an early stage of PCB design, analysis is performed of to which portion of the printed board a cable is to be connected to reduce common mode radiation. In that case, there are a plurality of candidates for a position at which the cable is connected to the printed board, and accordingly, if creating an analysis model and thereby performing electromagnetic field analysis for each of the connection position candidates, the analysis time comes to account for a large proportion of the design time. The analysis time for each of the patterns is desired to be short but, in order to reduce the analysis time for each of the models, the analysis scale for each of them needs to be reduced. Accordingly, even if the technology of PTL 2 is applied into the technology of PTL 1, there still is a problem in that the analysis accuracy decreases for each of the patterns when the scale of the analysis space is reduced.

The objective of the present invention is to provide a circuit board design system, a circuit board design method and a circuit board design program, all of which can solve the above-described problem.

### Solution to Problem

A circuit board design system of the present invention is a circuit board design system for designing a circuit board with semiconductor components mounted on it and with a cable connected to it, the circuit board design system comprising: an input means which inputs board design information on a circuit board; an EMI characteristic derivation means which derives a characteristic of EMI generated from the circuit board, on the basis of the board design information; a storage means which stores a cable length correction characteristic for deriving the EMI characteristic; and an output means which outputs the EMI characteristic derived by the EMI characteristic derivation means, wherein the EMI characteristic derivation means comprises: an analysis model creation means which creates a simplified analysis model with a simplified virtual cable arranged in it, as an analysis model of the circuit board, on the basis of the board design information; a board analysis means which calculates virtual cable current flowing in the virtual cable by performing electromagnetic field analysis of the simplified analysis model; and an EMI calculation means which calculates actual cable current flowing in the cable by the use of the virtual cable current and the cable length correction characteristic, and then calculates a characteristic of EMI radiated from the cable by the use of the actual cable current.

A circuit board design method of the present invention is a circuit board design method for designing a circuit board with semiconductor components mounted on it and with a cable connected to it, the circuit board design method comprising: inputting board design information on a circuit board; creating a simplified analysis model with a simplified virtual cable arranged in it, as an analysis model of the circuit board, on the basis of the board design information; calculating virtual cable current flowing in the virtual cable by performing electromagnetic field analysis of the simplified analysis model; calculating actual cable current flowing in the cable by the use of the virtual cable current and a cable length correction characteristic for deriving an EMI characteristic; and calculating a characteristic of EMI radiated from the cable by the use of the actual cable current.

A circuit board design program of the present invention causes a computer, in a circuit board design system for designing a circuit board with semiconductor components mounted on it and with a cable connected to it, to execute steps of: inputting board design information on a circuit board; creating a simplified analysis model with a simplified virtual cable arranged in it, as an analysis model of the circuit board, on the basis of the board design information; calculating virtual cable current flowing in the virtual cable by performing electromagnetic field analysis of the simplified analysis model; calculating actual cable current flowing in the cable by the use of the virtual cable current and a cable length correction characteristic for deriving an EMI characteristic; and calculating a characteristic of EMI radiated from the cable by the use of the actual cable current.

### Advantageous Effects of Invention

According to the circuit board design system of the present invention, it becomes possible, in the design stage of a PCB with a cable connected to it, to design a PCB for which a characteristic of EMI generated from the cable is at a low level, in a short time and with high accuracy.

### BRIEF DESCRIPTION OF DRAWINGS

FIG. 1 a diagram showing a system configuration of a circuit board design system according to a first exemplary embodiment of the present invention

FIG. 2 a diagram showing a flow chart relating to operation of the circuit board design system according to the first exemplary embodiment of the present invention

FIG. 3 a top view showing an example of a structure of a printed circuit board treated by the circuit board design system according to the first exemplary embodiment of the present invention

FIG. 4 a cross-sectional view showing the example of a structure of a printed circuit board treated by the circuit board design system according to the first exemplary embodiment of the present invention

FIG. 5 a diagram showing an example of an electromagnetic field analysis model of a printed circuit board treated by the circuit board design system according to the first exemplary embodiment of the present invention

FIG. 6 a diagram showing an example of a detailed board model treated by the circuit board design system according to the first exemplary embodiment of the present invention

FIG. 7 a diagram showing an example of a simplified board model treated by the circuit board design system according to the first exemplary embodiment of the present invention

FIG. 8 a diagram showing an image of a process of calculating a cable length correction characteristic performed by the circuit board design system according to the first exemplary embodiment of the present invention

FIG. 9 a diagram showing an example of deriving actual cable current from virtual cable current and a cable length correction characteristic, in the circuit board design system according to the first exemplary embodiment of the present invention

FIG. 10 a diagram showing a system configuration of a circuit board design system according to a second exemplary embodiment of the present invention

FIG. 11 a diagram showing a flow chart relating to operation of the circuit board design system according to the second exemplary embodiment of the present invention

FIG. 12 a diagram showing a system configuration of a circuit board design system according to a third exemplary embodiment of the present invention

FIG. 13 a diagram showing a flow chart relating to operation of a circuit board design system according to the third or a fourth exemplary embodiment of the present invention

FIG. 14 a diagram showing a flow chart of a process of deriving a cable length correction characteristic performed by the circuit board design system according to the third exemplary embodiment of the present invention

FIG. 15 a diagram showing a system configuration of a circuit board design system according to the fourth or a fifth exemplary embodiment of the present invention

FIG. 16 a diagram showing a flow chart relating to operation of the circuit board design system according to the fifth exemplary embodiment of the present invention

FIG. 17 a diagram showing an example of a result of comparison between an EMI characteristic and an EMI permissive condition, both treated by the circuit board design system according to the fifth exemplary embodiment of the present invention

FIG. 18 a top view of an example of a printed circuit board with a plurality of candidates for cable connection position treated by the circuit board design system according to the fifth exemplary embodiment of the present invention

FIG. 19 a diagram showing a system configuration of a circuit board design system according to a sixth exemplary embodiment of the present invention

FIG. 20 a diagram showing a flow chart relating to operation of a circuit board design system according to the sixth or a seventh exemplary embodiment of the present invention.

FIG. 21 a diagram showing a system configuration of a circuit board design system according to the seventh exemplary embodiment of the present invention.

FIG. 22 a cross-sectional view showing difference in print circuit board structure which occurs when a change of PCB design information is performed as a board configuration change process by the circuit board design system according to the seventh exemplary embodiment of the present invention

FIG. 23 a top view showing difference in print circuit board structure which occurs when the change of PCB design information is performed as a board configuration change process by the circuit board design system according to the seventh exemplary embodiment of the present invention

FIG. 24 a diagram showing difference in a signal voltage V which occurs when a change of LSI design information is performed in the board configuration change process by the circuit board design system according to the seventh exemplary embodiment of the present invention

FIG. 25 a diagram showing difference in a signal voltage V which occurs when the change of LSI design information is performed in the board configuration change process by the circuit board design system according to the seventh exemplary embodiment of the present invention

FIG. 26 a diagram showing difference in a cable which occurs when a change of cable structure design information is performed in the board configuration change process by the circuit board design system according to the seventh exemplary embodiment of the present invention

FIG. 27 a diagram showing difference in common mode radiation which occurs when the change of cable structure design information is performed in the board configuration change process by the circuit board design system according to the seventh exemplary embodiment of the present invention

FIG. 28 A top view showing the structure of a printed circuit board treated by a circuit board design system of a practical example of the present invention

FIG. 29 a cross-sectional view showing the structure of the printed circuit board treated by the circuit board design system of the practical example of the present invention

FIG. 30 a diagram showing an example of a detailed board model of the printed circuit board treated by the circuit board design system of the practical example of the present invention

FIG. 31 a diagram showing an example of a simplified board model of the printed circuit board treated by the circuit board design system of the practical example of the present invention

FIG. 32 a diagram showing virtual cable current and actual cable current derived by the circuit board design system of the practical example of the present invention

FIG. 33 a diagram showing a cable length correction characteristic derived by the circuit board design system of the practical example of the present invention

FIG. 34 a diagram showing an EMI characteristic with respect to a cable connection position candidate A, derived by the circuit board design system of the practical example of the present invention

FIG. 35 a diagram showing an EMI characteristic with respect to a cable connection position candidate B, derived by the circuit board design system of the practical example of the present invention

FIG. 36 a diagram showing an EMI characteristic with respect to a cable connection position candidate C, derived by the circuit board design system of the practical example of the present invention

FIG. 37 a diagram showing a result of comparison between an EMI characteristic with respect to the cable connection position candidate A, derived by the circuit board design system of the practical example of the present invention, and an EMI permissive condition

FIG. 38 a diagram showing a result of comparison between an EMI characteristic with respect to the cable connection position candidate B, derived by the circuit board design system of the practical example of the present invention, and the EMI permissive condition

FIG. 39 a diagram showing a result of comparison between an EMI characteristic with respect to the cable connection position candidate C, derived by the circuit board design system of the practical example of the present invention, and the EMI permissive condition

FIG. 40 a configuration diagram of an electromagnetic field strength calculation device of Patent Literature 1

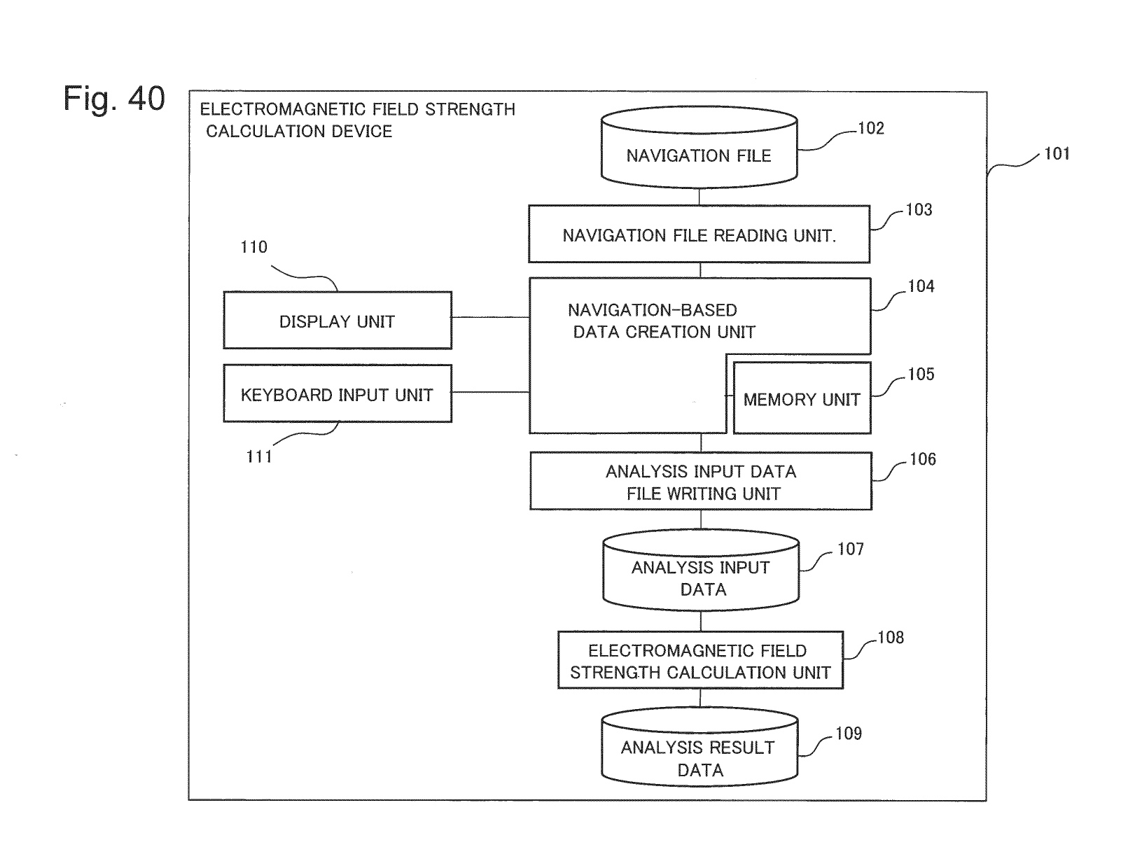

FIG. 41 a configuration diagram of an electromagnetic field strength calculation device of Patent Literature 2

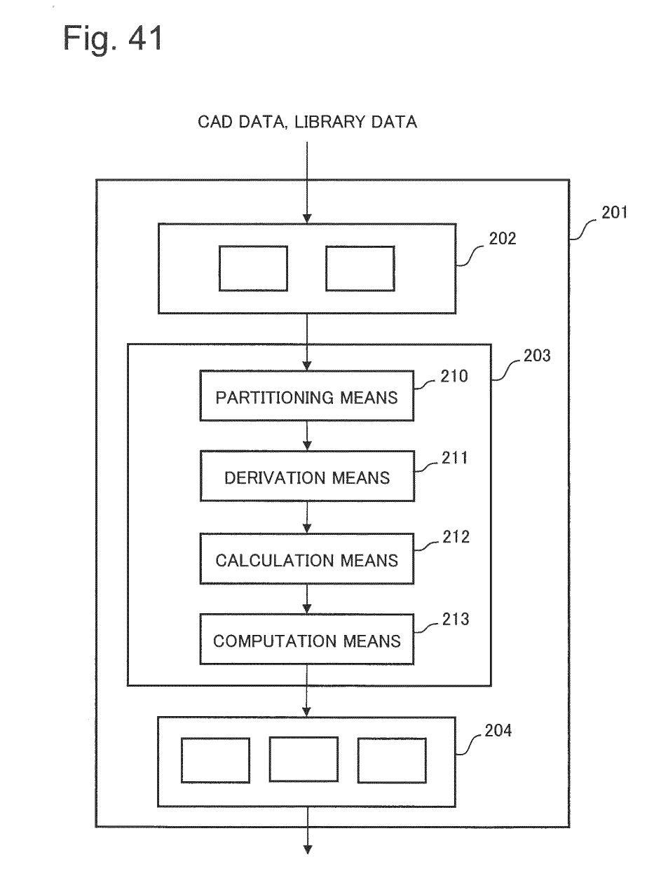

### DESCRIPTION OF EMBODIMENTS

Hereinafter, exemplary embodiments of the present invention will be described using drawings. Here, in exemplary embodiments and a practical example described below, some restrictions which are technically preferable for implementation of the present invention will be made, but the present invention is not intended to be limited, in its scope, to the following exemplary embodiments and practical example.

### First Exemplary Embodiment

First, a first exemplary embodiment for implementing the present invention will be described in detail, with reference to drawings.

(Configuration)

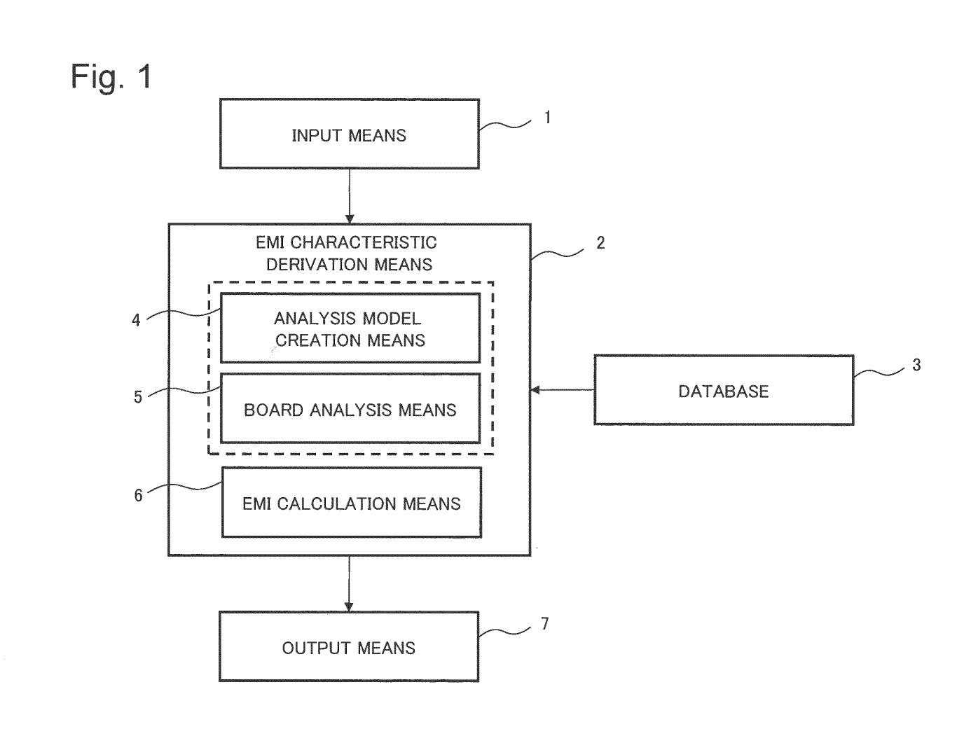

FIG. 1 shows a configuration of a circuit board design system according to the first exemplary embodiment of the present invention.

The circuit board design system of FIG. 1 comprises an input means 1, an EMI characteristic derivation means 2, a database 3 and an output means 7.

The input means 1 is a means for inputting, into the EMI characteristic derivation means 2, input information including data such as structure information on a PCB with a cable connected to it and design information on components including an LSI mounted on the PCB.

Using the input information inputted from the input means 1, the EMI characteristic derivation means 2 derives a characteristic of EMI generated from the PCB with a cable connected to it. The EMI characteristic derivation means 2 comprises an analysis model creation means 4, a board analysis means 5 and an EMI calculation means 6.

The analysis model creation means 4 is a means for creating an analysis model of the PCB from the input information. The analysis model creation means 4 creates an electromagnetic field analysis model of the PCB (hereafter, also referred to as a “simplified board model”) where a cable having a virtual length (hereafter, also referred to as a “virtual cable”) is connected to the PCB, with the virtual length being sufficiently smaller than the length of the cable actually connected (hereafter, also referred to as an “actual cable”).

The board analysis means 5 is a means for performing electromagnetic field analysis by the use of the simplified board model created by the analysis model creation means 4, and it derives electric current flowing in the virtual cable (hereafter, also referred to as “virtual cable current”) by the electromagnetic field analysis.

The EMI calculation means 6 is a means for deriving a characteristic of electric current flowing in the actual cable (hereafter, also referred to as “actual cable current”), by the use of the virtual cable current derived by the board analysis means 5 and a characteristic corresponding to a relationship between the characteristic of the virtual cable current and that of the actual cable current (hereafter, also referred to as a “cable length correction characteristic”), and also calculating common mode radiation according to a relation between electric current and radiation. The EMI calculation means 6 also can derive an EMI characteristic equivalent to a characteristic of common mode radiation generated from the cable, with respect to the PCB structure included in the input information.

The database 3 is a storage means for storing the cable length correction characteristic. The system configuration is made such that the cable length correction characteristic stored in the database 3 is read out when the actual cable current is derived in the EMI calculation means 6.

The output means 7 is a means for outputting the EMI characteristic derived by the EMI characteristic derivation means 2. It may also output design information from which the EMI characteristic is obtained. It may further output data relating to the EMI characteristic derived by the EMI derivation means in a form of a graph or the like.

The above is the configuration of the circuit board design system according to the first exemplary embodiment of the present invention.

(Operation)

Here, features of operation of circuit board design systems according to exemplary embodiments of the present invention will be briefly summarized.

First, in order to derive an EMI characteristic corresponding to common mode radiation generated from a cable, an electromagnetic field analysis model is created by the use of board information and LSI information on a PCB and information on a cable. It is assumed that, in the analysis model, a cable connected to the board is a virtual cable having a virtual length which is sufficiently smaller than the length of the actual cable.

Then, electromagnetic field analysis is performed using the simplified board model in which the virtual cable is connected to the board, and thereby, virtual cable current is derived.

Further, setting in advance a cable length correction characteristic corresponding to a characteristic for correcting the virtual cable current into actual cable current to flow when the actual cable is connected, the actual cable current is derived from the virtual cable current and the cable length correction characteristic.

Then, using an equation for calculating common mode radiation from common mode current, common mode radiation generated from the cable by the effect of the actual cable current is calculated.

By the series of operations described above, an EMI characteristic of the PCB is derived.

The above is the most basic operation procedure of circuit board design systems according to exemplary embodiments of the present invention.

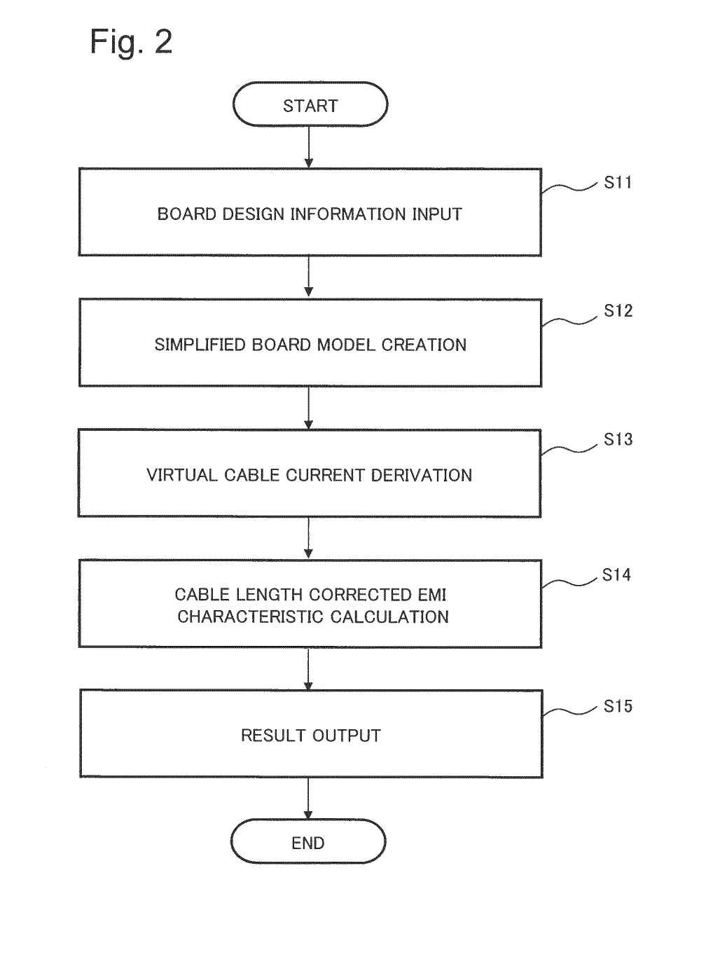

Hereinafter, a detail description will be given of a series of operations according to the first exemplary embodiment of the present invention, following a flow chart shown in FIG. 2.

The flow chart of FIG. 2 starts from a board design information input process (step 11).

Information to be inputted in the board design information input process of the step 11 is necessary information for deriving a characteristic of EMI generated from a PCB, which includes, for example, with respect to the PCB having a configuration with an LSI and other components mounted on and a cable connected to the board, the physical structure of the board including its layout and layer structure, that of the cable, information on the mounted LSI and other components, and the like. Hereafter, such pieces of information are totally referred to as board design information. The board design information is inputted by the input means 1 of FIG. 1.

Next, the analysis model creation means 4 comprised in the EMI characteristic derivation means 2 of FIG. 1 performs a simplified board model creation process using the inputted board design information (step 12).

In the simplified board model creation process of the step 12, the analysis model creation means 4 creates a simplified board model in which the PCB structure except for the cable is reflected and a virtual cable is connected as an alternative cable.

Next, the board analysis means 5 comprised in the EMI characteristic derivation means 2 of FIG. 1 performs a virtual cable current derivation process using the simplified board model (step 13).

In the a virtual cable current derivation process of the step 13, the board analysis means 5 derives virtual cable current flowing in the virtual cable.

Next, the EMI calculation means 6 comprised in the EMI characteristic derivation means 2 of FIG. 1 performs a cable length corrected EMI characteristic calculation process using the virtual cable current (step 14).

In the cable length corrected EMI characteristic calculation process of the step 14, the EMI calculation means 6 reads out the cable length correction characteristic stored in the database 3 of FIG. 1, and derives actual cable current from the virtual cable current and the cable length correction characteristic. Using the actual cable current, the EMI calculation means 6 further calculates a characteristic of common mode radiation generated from the cable, according to a relation between current flowing in a cable and radiation from the cable.

Then, the EMI characteristic derivation means 2 performs a result output process where it outputs the common mode radiation characteristic derived in the step 14 to the output means 7 of FIG. 1 (step 15).

The series of processes described above is the procedure according to the first exemplary embodiment.

Here, a length of the virtual cable to be connected in the simplified board model may be automatically obtained by a following equation 1, where the maximum frequency of the analysis is represented by F_{c} and the maximum value for the length of the virtual cable by L_{c1}.

L_{c1}=300×10⁶/(4×F_{c}) (1)

The equation 1 is usually expressed in the form of an inequality expressing that the left side is equal to or smaller than the right side, and in that case, the equation 1 expresses that the maximum value for the length of the virtual cable is equal to or smaller than ¼ of the wavelength λ_{c} of the maximum analysis frequency F_{c}. When the cable length is equal to ¼ of the wavelength, a resonance component appears in the cable current. Considering that, by setting the virtual cable length at a value equal to or smaller than ¼ of the smallest wavelength corresponding to the maximum frequency in the analysis range, it becomes possible to obtain a virtual cable current including no resonance component due to the cable length.

When the virtual cable length is too small, the length becomes little different from the size in thickness direction of the board model, and accordingly, highly accurate reproduction of an actual cable current from the virtual cable current becomes difficult. In that regard, when the virtual cable length equals to about ¼ of the wavelength, highly accurate reproduction of an actual cable current from the virtual cable current becomes possible, because the virtual cable length is sufficiently larger than the size in thickness direction of the board model.

### Specific Example

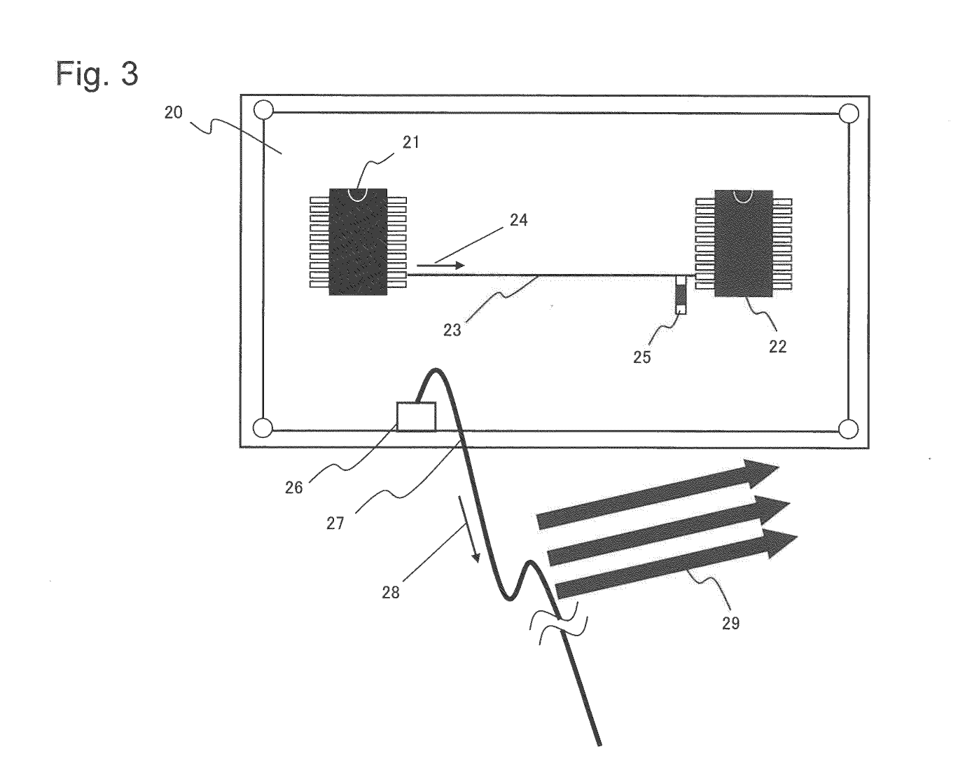

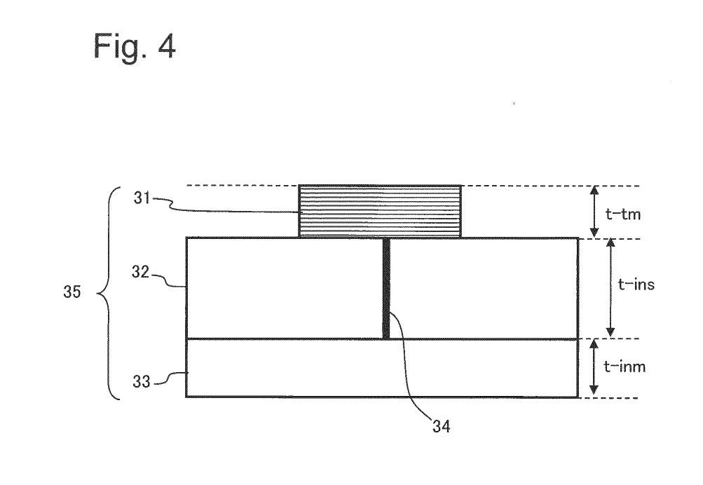

Here, as a specific example, a description will be given of an example of the first exemplary embodiment where the input information is set to be the board information on a PCB having a configuration with LSIs and other components mounted on and a cable connected to the board in a manner expressed by a layout in the horizontal plane shown in FIG. 3 and a cross-sectional structure in FIG. 4.

FIG. 3 is an example of a layout in the horizontal plane of a PCB 20.

In FIG. 3, a transmission-side LSI 21 and a reception-side LSI 22 are mounted on the PCB 20, a signal wiring 23 is connected between the LSIs, and a wiring electric current 24 flows in the signal wiring 23. On the PCB 20, a mounting component 25 such as a capacitor or a resistor is also mounted, in addition to the LSIs. Also onto the PCB 20, a cable 27 is connected via a connector 26.

When the wiring current 24 flows in the signal wiring 23, there occurs electromagnetic coupling between the signal wiring 23 and the cable 27, and accordingly, a cable current 28 flows in the cable 27.

As a result, EMI 29 corresponding to common mode radiation is generated, with the cable current 28 and the cable 27 being the generating source and the antenna, respectively.

Here, EMI 29 is generated also from the signal wiring 23 and wirings within the LSIs 21 and 22, and from between a power supply and GND of the PCB 20, which are not illustrated in the diagram. However, because the cable current 28 is common mode current with no return path, the common mode radiation generated from the cable 27 is predominant among the whole kinds of radiation in the system. Accordingly, in the present specific example, an EMI characteristic will be described as that obtained by taking only the common mode radiation generated from the cable 27 into consideration.

FIG. 4 shows an example of a cross section of the PCB 20. There, the signal wiring 23 and a pad for mounting the mounting component 25 are formed in a surface conductor layer 31 (with a thickness t-tm) of the PCB 20, and a ground layer, a power supply layer and internal wirings, which are not illustrated in the diagram, are formed in an internal conductor layer 33 (with a thickness t-inm). Further, the configuration is made such that the portion with no conductor layer consists of a dielectric layer 32 (with a thickness t-ins), within which a via 34 connecting electrically the surface conductor layer 31 and the internal conductor layer 33 is present.

Operation of the specific example will be described, following the flow chart of FIG. 2.

First, in the board design information input process of FIG. 2 (step 11), the input means 1 inputs board design information with respect to the above-described configuration of the PCB 20 to the EMI characteristic derivation means 2 of FIG. 1.

Next, using the inputted board design information, the analysis model creation means 4 of FIG. 1 creates a simplified board model, in the analysis model creation process of FIG. 2 (step 12).

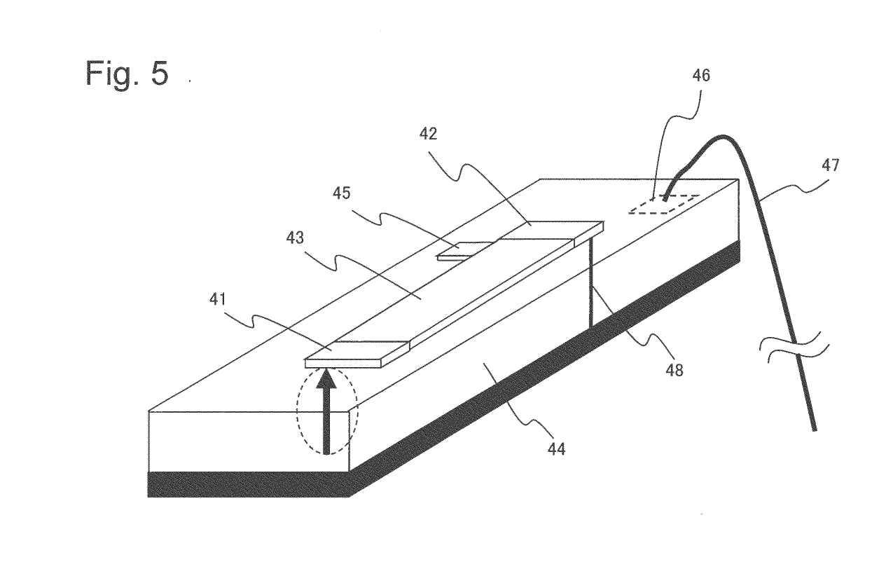

Here, it is assumed that a system performing electromagnetic field analysis by the use of an FDTD method as a means for analyzing the simplified board model is employed. In that case, from the above-described board design information on the PCB 20, an electromagnetic field analysis model of a three-dimensional (hereafter, also described as “3D”) structure shown in FIG. 5 is created.

In the electromagnetic field analysis model of FIG. 5, a signal from a transmission signal source (not illustrated) adapted to 3D analysis for generating the wiring electric current 24 flowing from the transmission-side LSI 21 is set as input.

A transmission-side parameter 41 is a parameter obtained by extracting only necessary part for the analysis from the structure and electrical characteristics of the transmission-side LSI 21. A reception-side parameter 42 is a parameter obtained by extracting only necessary part for the analysis from the structure and electrical characteristics of the reception-side LSI 22. A wiring parameter 43 is a parameter obtained by extracting 3D structure information on and electrical characteristics of the signal wiring 23. A board portion parameter 44 is a parameter obtained by extracting necessary information from the layer configuration 35, corresponding to the thickness and electrical characteristics of each layer. A component parameter 45 is a parameter obtained by extracting only necessary part for the analysis from the structure and characteristics of the mounting component 25. A connector parameter 46 is a parameter obtained by extracting only necessary part for the analysis from the structure and characteristics of the connector 26. A cable parameter 47 is a parameter including the structure and electrical characteristics of the cable and the structure and characteristics of a component connected to the cable. A via parameter 48 is a parameter obtained by extracting 3D structure information on and electrical characteristics of the via 34.

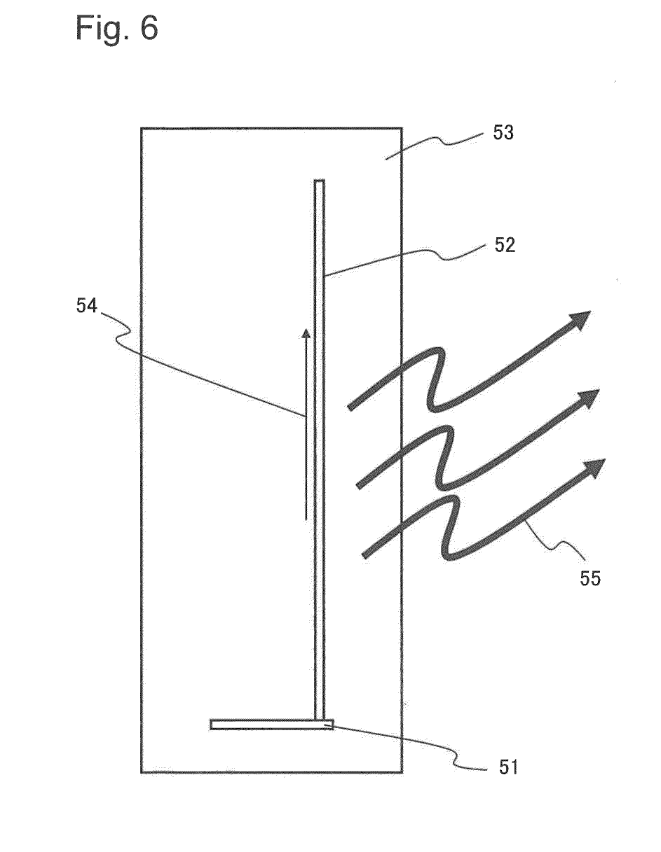

Here, if a model is created using the actual cable length in the cable parameter 47, the model turns out to be that shown in FIG. 6.

In FIG. 6 where, for convenience, a model of the cable part is expressed as a cable model 52 and that of the remaining part as a board model 51, the length of the cable is considerably larger than the size of the PCB, and accordingly, the size of an analysis space 53 depends almost only on the size of the cable.

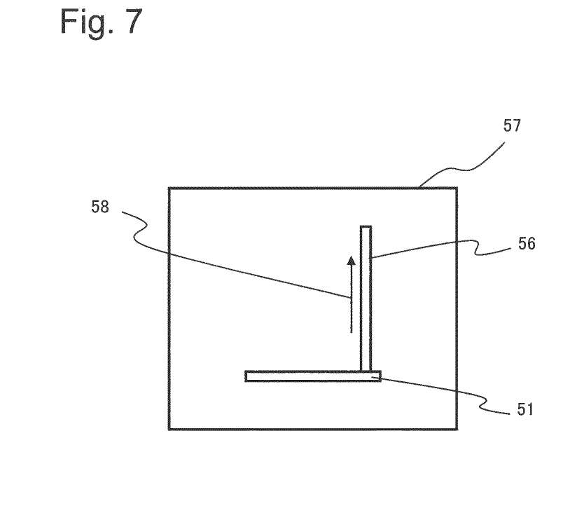

Because a model created in the present specific example is a simplified board model in which a virtual cable model 56 is connected, as shown in FIG. 7, its analysis space 57 becomes sufficiently smaller than that of the model shown in FIG. 6. Accordingly, using the simplified board model shown in FIG. 7, a characteristic of EMI 55 corresponding to a characteristic of common mode radiation generated from the cable can be directly derived by analysis in a short time.

At the present stage, the board analysis means 5 of FIG. 1 calculates a virtual cable current 58 with respect to the simplified board model shown in FIG. 7, by the virtual cable current derivation process of FIG. 2 (step 13). The board analysis means 5 partitions the created simplified board model into mesh elements of an appropriate size, by its adjustment function based on a guideline which instructs such as to adjust the number of mesh elements in a manner to make the size of the mesh elements to be an appropriate one set in advance. Then, by performing electromagnetic field analysis on the mesh-partitioned model by means of the mechanism of an FDTD method, the board analysis means 5 derives a virtual cable current I_{c1}.

Next, the EMI calculation means 6 of FIG. 1 derives an EMI characteristic based on the inputted board design information, by performing the cable length corrected EMI characteristic calculation process of the step 14 of FIG. 2.

Here, a description will be given of details of the cable length corrected EMI characteristic calculation process of the step 14.

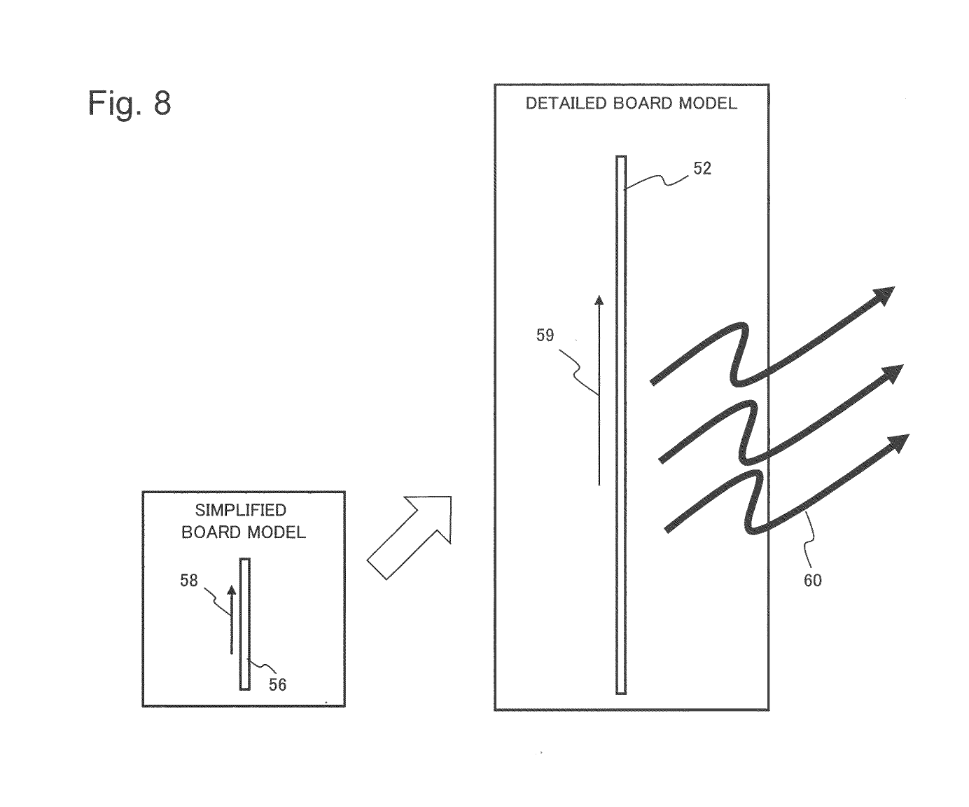

First, the EMI calculation means 6 reads out a cable length correction characteristic rc stored in the database 3 of FIG. 1, and then, from the virtual cable current I_{c1}, corresponding to a virtual cable current 58 shown in FIG. 8, and the cable length correction characteristic rc, derives an actual cable current I_{c} (actual cable current 59 in FIG. 8) flowing in the actual cable.

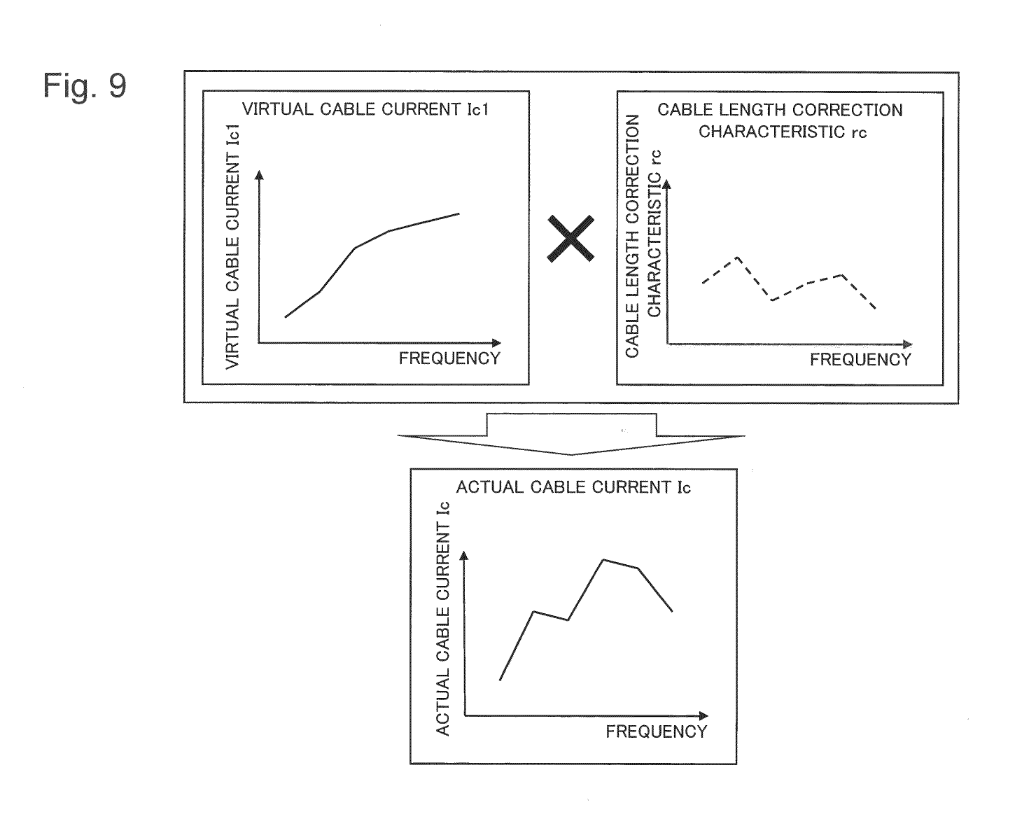

The characteristic of the actual cable current I_{c} is derived, for example, by multiplying the characteristic of the virtual cable current I_{c1} by the cable length correction characteristic rc, as shown in FIG. 9.

Next, using thus calculated actual cable current I_{c}, the EMI calculation means 6 derives an EMI characteristic 60 corresponding to a characteristic of common mode radiation generated from the cable model 52. As an equation for the derivation, one described in Non-Patent Literature 1 (NPL 1: Shigeo Suzuki, “Comprehensible introduction to practical noise countermeasures in analog/digital mixed circuits”, Nikkan Kogyo Shimbun, 2007) can be used. NPL 1 describes that, expressing the frequency of the virtual cable current I_{c1} by F, its cable length by L, and the distance of a position from the cable by D, the common mode radiation field strength Ecm at the position can be calculated by a following equation 2.

Ecm=1.257×10⁻⁶×I_{c1}×F×L/D (2)

Next, the EMI characteristic corresponding to common mode radiation from the cable 27 is outputted by the output process 7 of FIG. 2, with which the series of processes is completed (step 15).

By using the series of processes, it becomes possible to accurately derive an EMI characteristic with respect to such a PCB configuration as shown in FIGS. 3 and 4 in a short time.

Thus, the detail description of the first exemplary embodiment has been given above, using the specific example. Here, the above-described specific example is just an example, and any other examples obtained by making various changes to the configuration and operation of the above-described specific example also should be included within the scope of the present invention.

If using an electromagnetic field analysis model of the PCB where the actual cable is directly modeled with no change (hereafter, also referred to as a “detailed board model”), the analysis scale becomes considerably large, because the length of the cable is a dominant cause of the increase in the analysis space. In contrast, in the case of using the simplified board model described in the first exemplary embodiment of the present invention, the length of the virtual cable is substantially smaller than the actual cable length, and accordingly, the analysis space can be diminished, and the analysis scale is decreased by that amount.

Further, in the case of using the simplified board model described in the first exemplary embodiment of the present invention, it is not necessary to intentionally decrease the number of mesh elements because the analysis space naturally becomes small, and accordingly, a virtual cable current can be derived in a shorter time with no decrease in the analysis accuracy.

That is, by the above-described series of operations according to the first exemplary embodiment of the present invention, it is possible to derive common mode radiation in a shorter time than when performing the analysis using the detailed board model. Additionally, if the cable correction characteristic is set with high accuracy, the derivation of common mode radiation can be performed with no decrease in the analysis accuracy.

Further, according to the circuit board design system of the present invention, in the design stage of a PCB with a cable connected to it, it becomes possible for even a person not having deep knowledge of electrical circuits and electromagnetic waves to design a PCB making a characteristic of EMI (common mode radiation) generated from the cable become at a low level, in a short time and with high accuracy.

As the EMI characteristic derivation means for deriving EMI generated from a PCB, in particular, common mode radiation generated from a cable, by the use of design information on the PCB, for example, a general electromagnetic field analysis tool or system can be used.

What needs to be set as input information to that kind of EMI characteristic derivation means includes CAD (Computer Aided Design) data including the external structure of the PCB and information on its connection with a component and a connector, a data sheet showing the operation and structure of a mounted LSI, a data sheet for a mounted component, and the like. These kinds of data are those which generally can be obtained by a designer at an early PCB design stage. There also exists an input tool or system which enables to create an analysis model by inputting those kinds of information into an analysis tool, and it also can be employed as an input means.

Further, by providing a program reflecting the above-described series of processes, it becomes possible for even a person not having deep knowledge of electrical circuits and electromagnetic waves to design a PCB configuration having a low level EMI characteristic, in a short time and with high accuracy.

### Second Exemplary Embodiment

Next, a second exemplary embodiment of the present invention will be described in detail, with reference to drawings.

(Configuration)

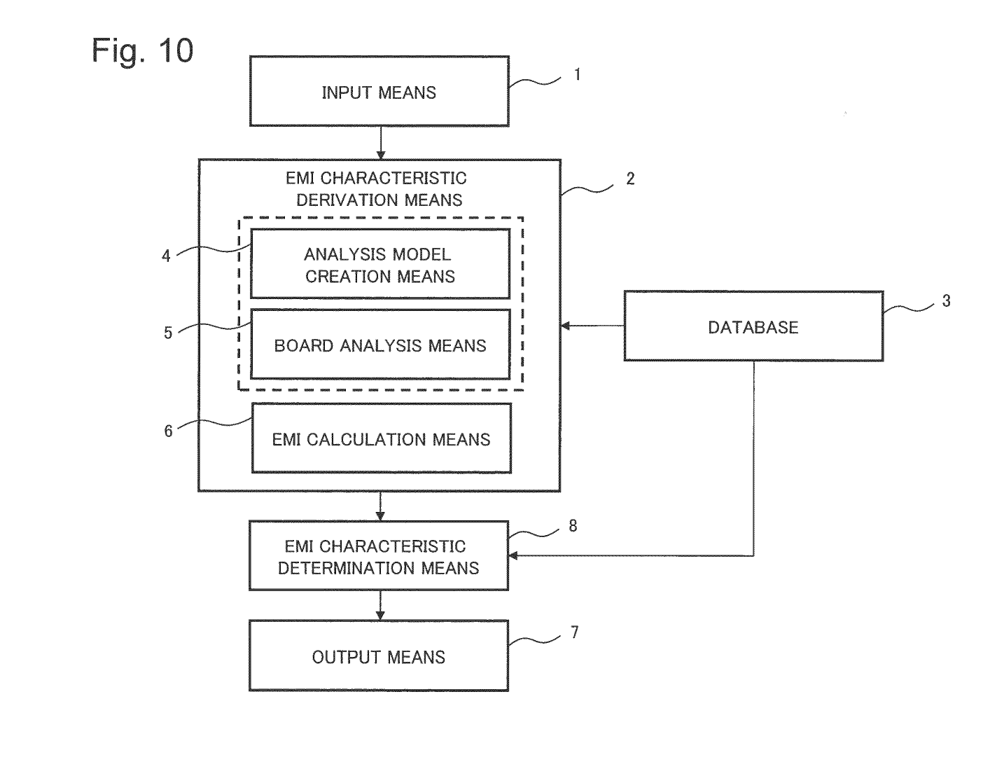

FIG. 10 shows a system configuration according to the second exemplary embodiment of the present invention. The second exemplary embodiment has a configuration obtained by adding an EMI characteristic determination means 8 to the system configuration of the first exemplary embodiment shown in FIG. 1. In FIG. 10, to the constituent elements other than the EMI characteristic determination means 8, the respective same signs as that used in FIG. 1 are assigned.

The EMI characteristic determination means 8 is a means which compares an EMI characteristic derived by the EMI characteristic derivation means 2 with an EMI permissive condition stored in the database 3 as a condition for permitting an EMI characteristic, and thereby determines whether the derived EMI characteristic satisfies the EMI permissive condition or not.

Accordingly, the system configuration is made such that, to the output means 7, not only the derived EMI characteristic but also the result of determining whether or not the inputted PCB configuration satisfies the EMI permissive condition are outputted.

(Operation)

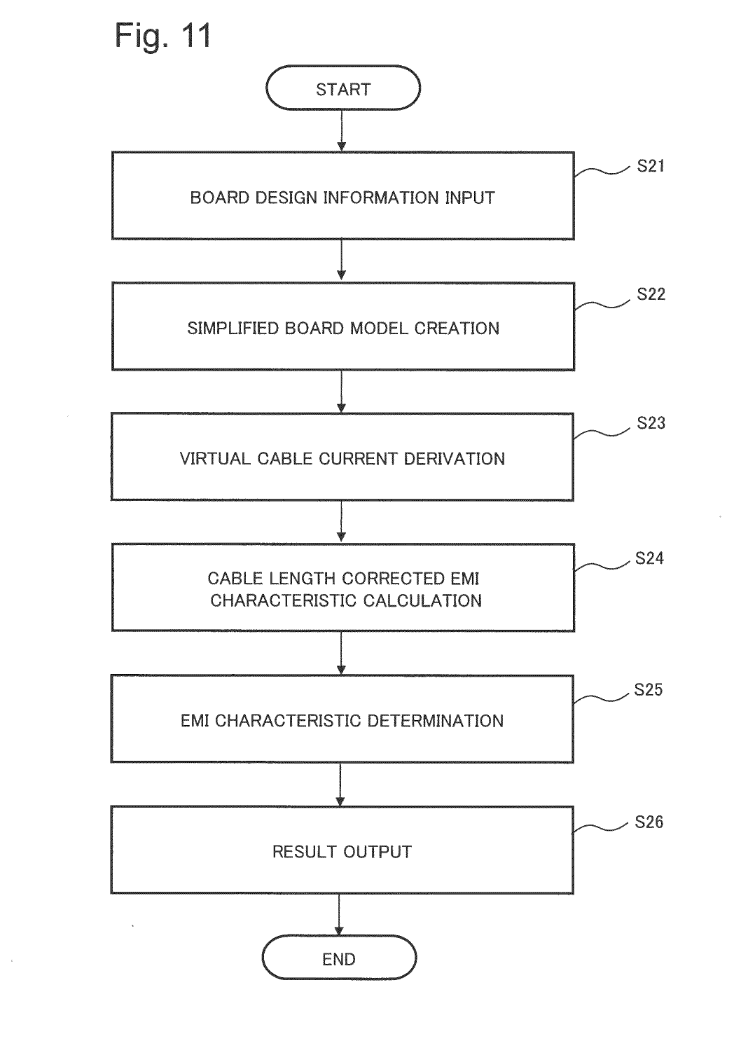

FIG. 11 is a flow chart showing a series of processes according to the second exemplary embodiment of the present invention. This flow chart corresponds to the one obtained by adding an EMI characteristic determination process to the flow chart in FIG. 2 showing the series of processes of the first exemplary embodiment.

Hereinafter, the series of processes according to the second exemplary embodiment will be described, following the flow chart of FIG. 11.

First, the input means 1 performs the board design information input process where it inputs board design information on a PCB into the EMI characteristic derivation means 2 of FIG. 10 (step 21).

Next, the analysis model creation means 4 in the EMI characteristic derivation means 2 of FIG. 10 performs the simplified board model creation process where it creates a simplified board model on the basis of the inputted board design information (step 22).

Then, the board analysis means 5 in the EMI characteristic derivation means of FIG. 10 performs the virtual cable current derivation process where it derives virtual cable current flowing in a virtual cable, using the simplified board model (step 23).

Next, the EMI calculation means 6 in the EMI characteristic derivation means 2 of FIG. 10 performs the cable length corrected EMI characteristic calculation process using the virtual cable current (step 24).

In the cable length corrected EMI characteristic calculation process of the step 24, the EMI calculation means 6 firstly reads out a cable length correction characteristic stored in the database 3 of FIG. 10, and derives actual cable current flowing in the actual cable from the virtual cable current and the cable length correction characteristic. Using the actual cable current derived as above, the EMI calculation means 6 further calculates a characteristic of common mode radiation generated from the cable, according to a predetermined relation between current flowing in a cable and radiation from the cable.

The above-described steps 21 to 24 according to the second exemplary embodiment, shown in FIG. 11, are the same as the steps 11 to 14 according to the first exemplary embodiment, shown in FIG. 2.

Subsequently to those steps, the EMI characteristic determination means 8 of FIG. 10 performs the EMI characteristic determination process (step 25).

In the EMI characteristic determination process of the step 25, the EMI characteristic determination means 8 reads out an EMI permissive condition stored in the database 3 of FIG. 10, compares the EMI permissive condition with the derived common mode radiation characteristic, and thereby determines whether or not the common mode radiation characteristic satisfies the EMI permissive condition.

Then, the EMI characteristics determination means 8 performs a result output process where it outputs, to the output means 7 of FIG. 10, an EMI characteristic equivalent to the derived common mode radiation characteristic and the result of determining whether or not the EMI characteristic satisfies the EMI permissive condition (step 26).

The series of processes described above is the one according to the second exemplary embodiment.

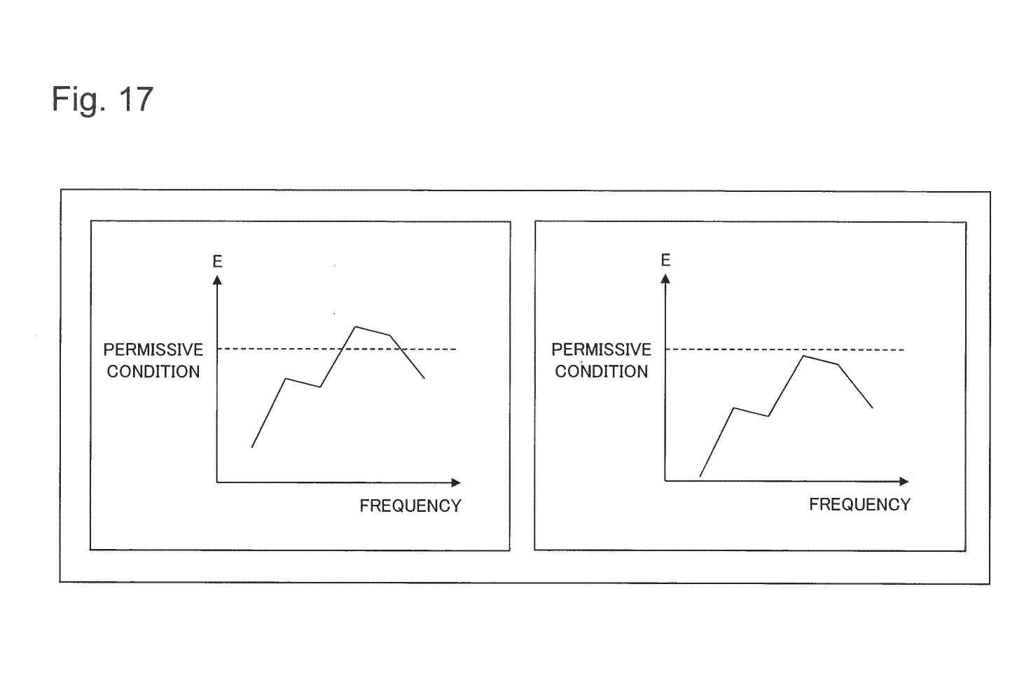

Here, an example of comparison performed by the EMI determination means is shown in FIG. 17.

FIG. 17 shows results of comparison between a derived EMI characteristic and an EMI permissive condition. There, results of comparison of two kinds of EMI characteristics with one EMI permissive condition are shown. The present EMI permissive condition is defined as the electric field strength E being of a constant value not depending on frequency F, and accordingly, in such a case as the right diagram where the EMI characteristic never exceeds the value of the EMI permissive condition, it is determined that the permissive condition is satisfied.

In the example shown in the left diagram of FIG. 17, it is determined that the EMI permissive condition is not satisfied, because there is a frequency range where the EMI characteristic (solid line) exceeds the value of the EMI permissive condition (dotted line).

In contrast, in the example shown in the right diagram of FIG. 17, it is determined that the EMI permissive condition is satisfied, as already described above, because the EMI characteristic (solid line) does not exceed the value of the EMI permissive condition (dotted line) in any part of the whole frequency range.

As a result of such determination, what is outputted to the output means 7 of FIG. 10 becomes, depending on the board design information, a combination of the EMI permissive condition (dotted line), a graph of an EMI curve (solid line) and a determination result indicating non-satisfaction of the EMI permissive condition (for example, the left diagram of FIG. 17), or a combination of the EMI permissive condition (dotted line), a graph of an EMI curve (solid line) and a determination result indicating satisfaction of the EMI permissive condition (for example, the right diagram of FIG. 17).

By outputting such a comparison result as shown in FIG. 17, it becomes possible to know the present conditions such as in what frequency band the EMI characteristic does not satisfy the EMI permissive condition, to what extent improvement is necessary, or what amount of margin remains against the EMI permissive condition, and accordingly to perform quantitative evaluation, according to a configuration of the PCB 20.

Thus, as in the second exemplary embodiment, it is possible to set in advance an EMI permissive condition and add a process of determining whether a derived EMI characteristic satisfies the EMI permissive condition or not. By adding the process to the series of processes according to the first exemplary embodiment already described, it becomes possible to automatically determine whether or not a PCB has been designed in a manner to satisfy an EMI permissive condition.

Further, according to the second exemplary embodiment of the present invention, it is possible to derive in a short time a characteristic of common mode radiation generated from a PCB with a cable connected to it, and thereby perform determination with respect to an EMI permissive condition corresponding to a condition for permitting EMI generated from the cable in a short time. As a result, it becomes possible to determine whether or not a PCB has been designed to have a structure and specifications making the characteristic of EMI generated from the PCB become at a low level, and accordingly, design of a PCB structure satisfying a permissive EMI value can be performed easily.

Further, because an EMI characteristic derived in the second exemplary embodiment of the present invention is a quantitative value, it also becomes possible to determine what amount of margin against an EMI permissive condition remains for a designed PCB structure. Therefore, by changing a characteristic of the EMI permissive condition if necessary, a PCB structure or PCB specifications with a larger amount of margin can be designed.

### Third Exemplary Embodiment

Next, a third exemplary embodiment of the present invention will be described in detail, with reference to drawings.

(Configuration)

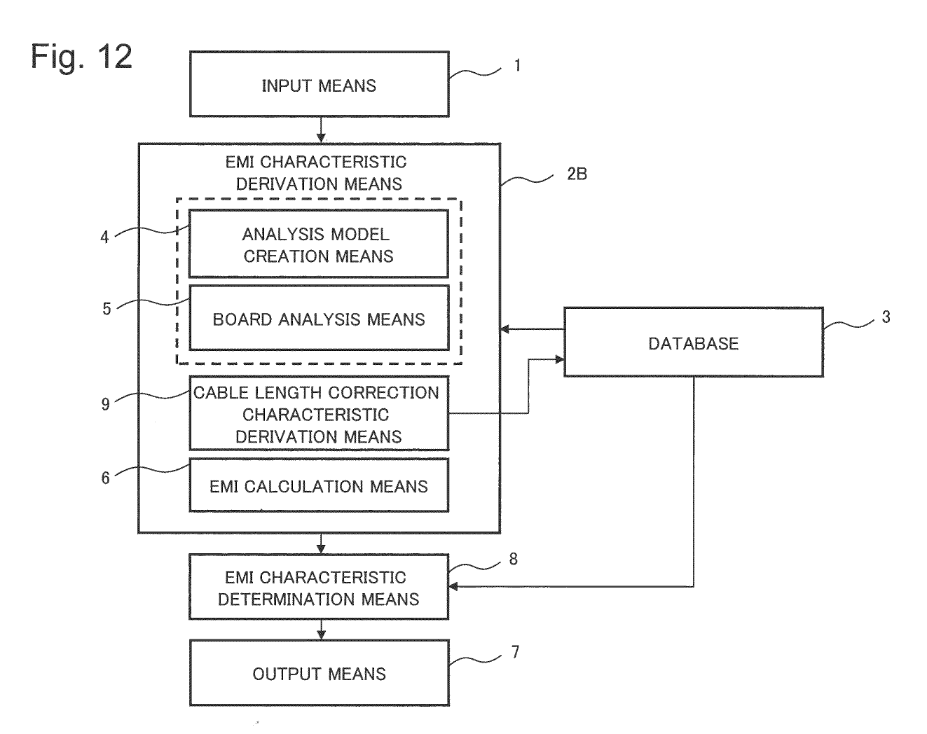

FIG. 12 shows a system configuration according to the third exemplary embodiment of the present invention. The system configuration in the third exemplary embodiment corresponds to the one obtained by adding a cable length correction characteristic derivation means 9 to the system configuration of the second exemplary embodiment shown in FIG. 10. A cable length correction characteristic derived by the cable length correction characteristic derivation means 9 is fed back to the database 3.

The third exemplary embodiment is configured such that, when no cable length correction characteristic is stored in the database 3, a cable length correction characteristic can be derived by the cable length correction characteristic derivation means 9, from an analysis result obtained by the analysis model generation means 4 and the board analysis means 5, and can be fed back to the database 3. The cable length correction characteristic created by the cable length correction characteristic derivation means 9 is stored in the database 3, and can be read out later when other board design information is inputted. The system according to the third exemplary embodiment is also configured such that an EMI characteristic derived at an intermediate stage during derivation of the cable length correction characteristic and a determination result obtained by the EMI characteristic determination means 8 can be outputted to the output means 7.

(Operation)

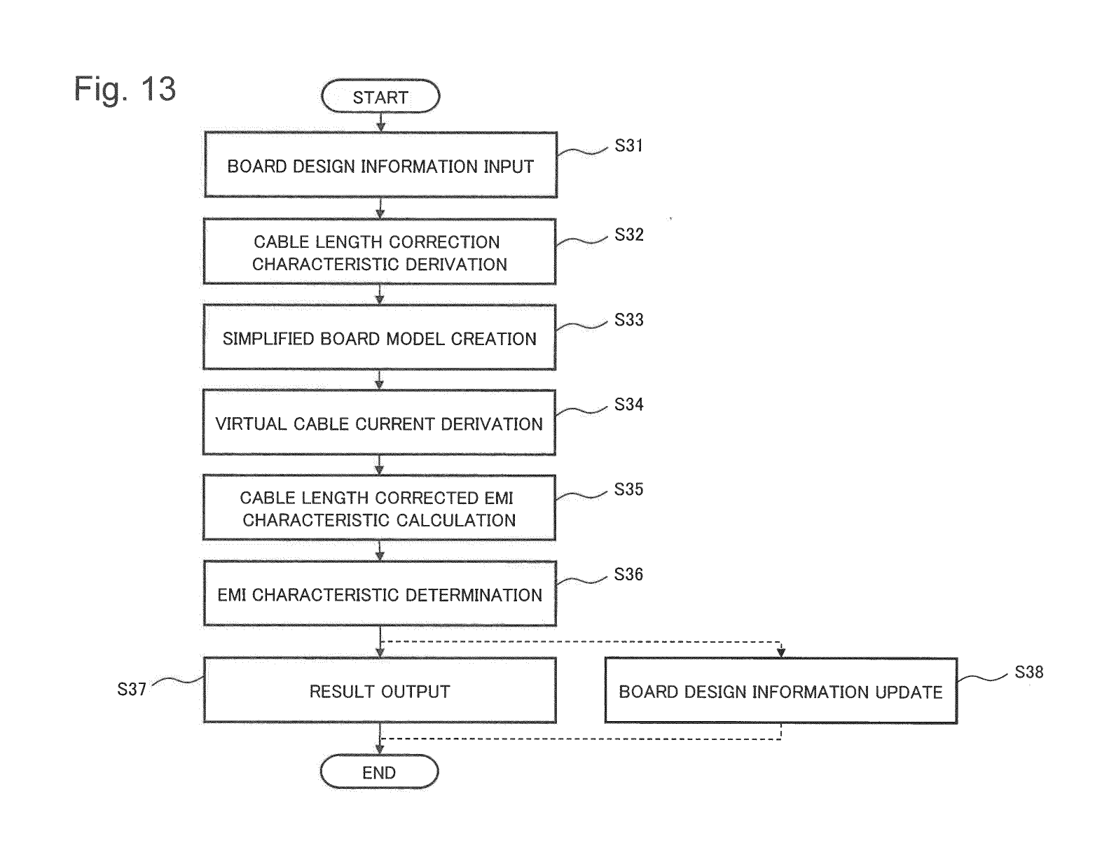

FIG. 13 is a flow chart showing a series of processes according to the third exemplary embodiment of the present invention. This flow chart corresponds to the one obtained by adding a cable length correction characteristic derivation process to the flow chart in FIG. 11 showing the series of processes of the second exemplary embodiment.

First, the input means 1 performs the board design information input process where it inputs board design information on a PCB into the EMI characteristic derivation means 2B of FIG. 12 (step 31).

Next, using the inputted board design information, the analysis model creation means 4, board analysis means 5 and the cable length correction characteristics derivation means 9, of FIG. 12, perform the cable length correction characteristic derivation process (step 32).

In the present step, the detailed board model shown in FIG. 6 and the simplified board model shown in FIG. 7 are created by a board generation means consisting of the analysis model creation means 4 and the board analysis means 5. The board analysis means 5 further derives the actual cable current 54 shown in FIG. 6 and the virtual cable current 58 shown in FIG. 7. Then, using the actual cable current 54 and the virtual cable current 58, the cable length correction characteristic derivation means 9 derives a cable length correction characteristic. The cable length correction characteristic derivation means 9 stores thus obtained cable length correction characteristic into the database 3 of FIG. 12.

Next, the analysis model creation means 4 of FIG. 12 performs the simplified board model creation process (step 33). Here, because a simplified board model has already been created in the cable length correction characteristic derivation process of the step 32, the process of the step 33 may be a process of only calling for the already created simplified board model, or may be skipped.

Next, the board analysis means 5 of FIG. 12 performs the virtual cable current derivation process (step 34). Here, because the virtual cable current 58 has already been derived in the cable length correction characteristic derivation process of the step 32, the process of the step 34 may be a process of only calling for the already derived virtual cable current 58, or may be skipped.

Next, the EMI calculation means 6 of FIG. 12 performs the cable length corrected EMI characteristic calculation process (step 35). Here, the actual cable current 54 has already been derived in the cable length correction characteristic derivation process. Accordingly, the EMI calculation means 6 may read out the cable length correction characteristic stored in the database 3 of FIG. 12, and then perform the process of deriving the actual cable current 59 (in FIG. 8) flowing in the actual cable from the virtual cable current and the cable length correction characteristic. Alternatively, the EMI calculation means 6 may only call for the actual cable current 54 already derived in the cable length correction characteristic derivation process. Using the actual cable current (54 or 59) obtained as above, the EMI calculation means 6 further calculates a characteristic of common mode radiation generated from the cable, according to a relation between current flowing in a cable and radiation from the cable.

Then, the EMI characteristic determination means 8 of FIG. 12 performs the EMI characteristic determination process (step 36).

In the EMI characteristic determination process of the step 36, the EMI characteristic determination means 8 reads out an EMI permissive condition stored in the database 3 of FIG. 12, compares the EMI permissive condition with the derived common mode radiation characteristic, and thereby determines whether or not the common mode radiation characteristic satisfies the EMI permissive condition.

Subsequently, the EMI characteristics determination means 8 performs the result output process where it outputs, to the output means 7 of FIG. 12, an EMI characteristic equivalent to the derived common mode radiation characteristic and the result of determining whether or not the EMI characteristic satisfies the EMI permissive condition (step 37).

The series of processes described above is the process flow according to the third exemplary embodiment. Here, it is assumed that a step 38 shown in FIG. 13 is not performed in the third exemplary embodiment.

According to the series of processes, even if no cable length correction characteristic is stored in advance in the database 3, a cable length correction characteristic can be derived from actual board design information at an early stage of the process flow. Then, thus derived cable length correction characteristic can be used when an EMI characteristic is to be derived from different board design information.

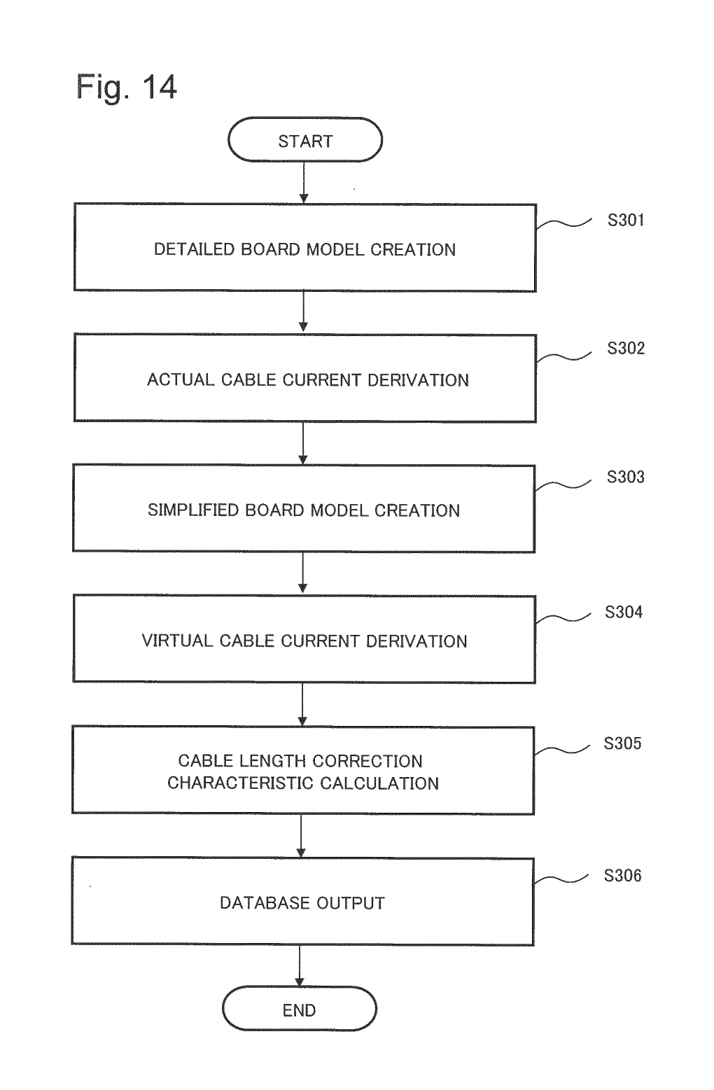

FIG. 14 shows a detailed flow chart of the cable length correction characteristic derivation process of the step 32.

First, the analysis model creation means 4 of FIG. 12 performs a detailed board model creation process (step 301).

The detailed board model creation process of the step 301 is a process of creating the detailed board model shown in FIG. 6 from board design information on the PCB 20 shown in FIGS. 3 and 4. The cable model 52 connected to the PCB 20 is created in a manner to reproduce the actual cable length.

Next, the board analysis means 5 of FIG. 12 performs an actual cable current derivation process (step 302).

In the actual cable current derivation process of the step 302, the board analysis means 5 derives the actual cable current 54 by performing electromagnetic field analysis of the detailed board model shown in FIG. 6.

Next, the analysis model creation means 4 of FIG. 12 performs a simplified board model creation process where it creates the simplified board model shown in FIG. 7 (step 303).

Then, the board analysis means 5 of FIG. 12 performs a virtual cable current derivation process (step 304).

In the virtual cable current derivation process of the step 304, the board analysis means 5 derives the virtual cable current 58 by performing electromagnetic field analysis of the simplified board model shown in FIG. 7.

Next, the cable length correction characteristic derivation means 9 of FIG. 12 performs a cable length correction characteristic calculation process (step 305).

In the cable length correction characteristic calculation process of the step 305, the cable length correction characteristic derivation means 9 derives a cable length correction characteristic from the actual cable current 54 and the virtual cable current 58. Referring to the graphs shown in FIG. 9, a method which derives a cable length correction characteristic by dividing an actual cable current characteristic by a virtual cable current characteristic is considered as an example of a method which can used in the cable length correction characteristic derivation process.

Next, the cable length correction characteristic derivation means 9 of FIG. 12 performs a database output process (step 306).

In the database output process of the step 306, the cable length correction characteristic derivation means 9 outputs the derived cable length correction characteristic to the database 3 of FIG. 12, with which the series of processes in the present cable length correction characteristic derivation process is completed.

According to the third exemplary embodiment of the present invention, a cable length correction characteristic having been derived from a piece of actual board design information on a PCB can be used also when deriving an EMI characteristic of the PCB by the use of different board design information. As a result, when a plurality of pieces of board design information are set, a final result can be obtained by the present method in a shorter time than a method which performs, with respect to each and every one of the plurality of pieces of board design information, creation of a detailed model, direct derivation of an EMI characteristic from the model, and determination of whether or not the EMI characteristic satisfies an EMI permissive condition. This advantage of the present exemplary embodiment increases with increase in the number of patterns of board design information, on a PCB, for each of which derivation of an EMI characteristic and subsequent determination of whether or not it satisfies an EMI permissive condition is required to be performed.

According to the third exemplary embodiment of the present invention, the calculation using a virtual cable current and a cable length correction characteristic can be automatically performed by employing, for example, a method which derives a characteristic approximating the product of the virtual cable current and the cable length correction characteristic. As a result, common mode radiation generated from actual cable current can be derived by using the equation as it is, and accordingly, common mode radiation can be derived from virtual cable current automatically and in a short time.

Further, according to the third exemplary embodiment of the present invention, it is also possible, when no cable length correction characteristic is set in advance, to derive a cable length correction characteristic from results of analyses using, respectively, a detailed board model and a simplified board model. Specifically, it is possible to employ, for example, a method which calculates a current ratio from an actual cable current characteristic and a virtual cable current characteristic derived by the use of the respectively corresponding analysis models. Thus obtained cable length correction characteristic can be used as it is, in a case of performing the series of processes according to the third exemplary embodiment after the design condition is changed such as by changing a position for cable connection. Even in that case, common mode radiation can be derived in a shorter time than a method which performs, with respect to each and every position for cable connection, creation of a detailed board model, analysis of the model and subsequent derivation of common mode radiation.

### Fourth Exemplary Embodiment

Next, a fourth exemplary embodiment of the present invention will be described in detail, with reference to drawings.

(Configuration)

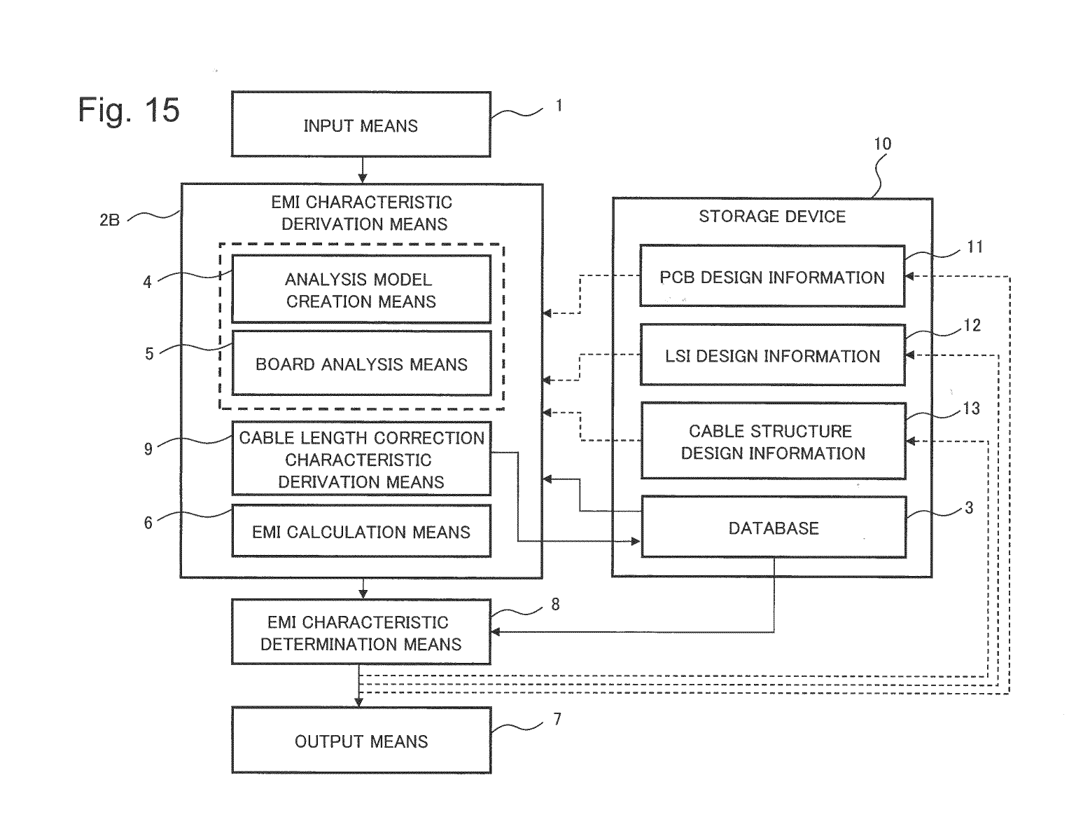

FIG. 15 shows a system configuration according to the fourth exemplary embodiment of the present invention. The fourth exemplary embodiment has a configuration obtained by adding a storage device 10 to the system configuration of the third exemplary embodiment shown in FIG. 12.

The storage device 10 is a storage means which stores the database 3, board design information including PCB design information 11 corresponding to information on a PCB's structure and components, LSI design information 12 corresponding to information on an LSI's structure and characteristics, cable structure design information 13 corresponding to a cable's physical structure, and the like.

The board design information is automatically inputted from the storage device 10 to the EMI characteristic derivation means 2B, through operation of the input means 1. The system configuration is made such that, from the inputted board design information and a cable length correction characteristic and an EMI permissive condition from the database 3, an EMI characteristic is automatically derived, and then a result of determining whether or not the EMI characteristic satisfies the EMI permissive condition is outputted. Further, the EMI characteristic determination means 8 is configured such that it not only outputs the determination result of whether or not the EMI characteristic satisfies the EMI permissive condition to the output means 7, but also reflects the output result into the board design information (PCB design information 11, LSI design information 12 and cable structure design information 13).

Examples of information included in the PCB design information 11 are that on the sizes of planes and wirings of the board, that on connection positions and characteristics of the components, and that on the cable connection, which are typically given as two-dimensional CAD data. The PCB design information 11 also includes information on the layer structure of the board shown in FIG. 4, which specifically is on the surface conductor layer 31, the dielectric layer 32, the internal conductor layer 33, the via 34 and the layer configuration 35, and information on the electrical characteristics of each of the layers, such as the electrical conductivity, the relative dielectric constant or the like. The PCB design information 11 further includes three-dimensional structures and electrical characteristics of the mounted components.

As examples of information included in the LSI design information 12, mentioned are, as information on the transmission-side LSI 21 of FIG. 3, information on a signal voltage waveform at its output buffer for generating the wiring electric current 24 to flow in the signal wiring 23 and on the structure of the output buffer, and, as information on the reception-side LSI 22, information on the structure of its input buffer.

As examples of information included in the cable structure design information 13, mentioned are information on the cable structure such as the length or the diameter, that on the electrical characteristics of the cable, that on connection at the terminal on the opposite side of the cable, and the like.

(Operation)

A series of processes according to the fourth exemplary embodiment of the present invention follows the flow chart shown in FIG. 13, similarly to that according to the third exemplary embodiment.

First, the input means 1 performs the board design information input process where it inputs the board design information on a PCB stored in the storage device 10 of FIG. 15 (PCB design information 11, LSI design information 12 and cable structure design information 13) to the EMI characteristic derivation means 2B of FIG. 15 (step 31).

It may be defined that, in the board design information input process of the step 31, for example, at the same time when the PCB design information 11 being such as CAD data on the board (circuit board design information) is inputted, information on components mounted on the board also is inputted. It may be further defined that, at the same time, the LSI design information 12 corresponding to information on an LSI to be mounted (semiconductor integrated circuit design information) and the cable structure design information 13 corresponding to information on a cable to be connected are inputted.

Next, the analysis model creation means 4, the board analysis means 5 and the cable length correction characteristic derivation means 9, of FIG. 15, perform the cable length correction characteristic derivation process using the inputted board design information (step 32).

In the cable length correction characteristic derivation process of the step 32, the board generation means consisting of the analysis model creation means 4 and the board analysis means 5 creates the detailed board model (FIG. 6) and the simplified board model (FIG. 7). Then, the board analysis means 5 derives the actual cable current 54 (FIG. 6) and the virtual cable current 58 (FIG. 7). Subsequently, using the actual cable current 54 and the virtual cable current 58, the cable length correction characteristic derivation means 9 derives a cable length correction characteristic. The obtained cable length correction characteristic is stored into the database 3 of the storage device 10 in FIG. 15.

Next, the board analysis means 5 of FIG. 15 performs the simplified board model creation process (step 33). Here, because a simplified board model has already been created in the cable length correction characteristic derivation process of the step 32, the process of the step 33 may be a process of only calling for the already created simplified board model, or may be skipped.

Next, the board analysis means 5 of FIG. 15 performs the virtual cable current derivation process (step 34). Here, because the virtual cable current 58 has already been derived in the cable length correction characteristic derivation process of the step 32, the process of the step 34 may be a process of only calling for the already derived virtual cable current 58, or may be skipped.

Next, the EMI calculation means 6 of FIG. 15 performs the cable length corrected EMI characteristic calculation process (step 35). Here, the actual cable current 54 has already been derived in the cable length correction characteristic derivation process. Accordingly, the EMI calculation means 6 may read out the cable length correction characteristic stored in the database 3 of FIG. 15, and perform the process of deriving the actual cable current 59 (FIG. 8) flowing in the actual cable, from the virtual cable current and the cable length correction characteristic. Alternatively, the EMI calculation means 6 may only call for the actual cable current 54 already derived in the cable length correction characteristic derivation process of the step 32. Using the actual cable current (54 or 59) obtained as above, the EMI calculation means 6 further calculates a characteristic of common mode radiation generated from the cable, according to a relation between current flowing in a cable and radiation from the cable.

Then, the EMI characteristic determination means 8 of FIG. 15 performs the EMI characteristic determination process (step 36).

In the EMI characteristic determination process of the step 36, the EMI characteristic determination means 8 reads out an EMI permissive condition stored in the database 3 of the storage device 10 in FIG. 15, and compares it with the derived common mode radiation characteristic. On the basis of the result of the comparison, the EMI characteristic determination means 8 determines whether or not the common mode radiation characteristic satisfies the EMI permissive condition.

Subsequently, the EMI characteristic determination means 8 performs the result output process where it outputs, to the output means 7 of FIG. 15, an EMI characteristic equivalent to the derived common mode radiation characteristic and the result of determining whether or not the EMI characteristic satisfies the EMI permissive condition (step 37).

With that, the series of operations according to the fourth exemplary embodiment is completed. Here, a board design information update process may be performed simultaneously and in parallel with the step 37 (step 38).

In the board design information update process of the step 38, the board design information in the storage device 10 (PCB design information 11, LSI design information 12 and cable structure design information 13) is updated in a manner to reflect the EMI characteristic and the EMI permissive condition. For example, the result of determining whether the set EMI permissive condition is satisfied or not may be reflected into the board design information in the storage device 10. When the EMI permissive condition is not satisfied, for example, a process which records an error into the CAD data and simultaneously outputs a result of comparison with the EMI permissive condition, like that shown in the left diagram of FIG. 17, may be performed.

Thus, in the fourth exemplary embodiment, the PCB design information 11, the LSI design information 12 and the cable structure design information 13, which are included in the set board design information, are simultaneously inputted. On the basis of the board design information, an EMI characteristic is derived, and then a result of determining whether or not the derived EMI characteristic satisfies an EMI permissive condition is outputted. As a result, it is possible for even a person not having deep knowledge of electrical circuits and electromagnetic waves to cause the system to perform the series of processes, if the person can at least set board design information into the storage device 10. It consequently becomes possible to easily design a PCB structure and PCB specifications making common mode radiation generated from a cable become at a low level.

In a system into which the fourth exemplary embodiment of the present invention is reflected, structure information on a PCB, design information on components mounted on the PCB, including LSIs, and structure information on a cable are set as input information. By causing a computer to execute the series of processes by the use of the input information, it becomes possible to design a PCB structure and PCB specifications making common mode radiation generated from a cable become at a low level. Such operation can be performed easily by even a person not having deep knowledge of electrical circuits and electromagnetic waves.

Further, according to the fourth exemplary embodiment, a cable length correction characteristic can be calculated by means of electromagnetic field analysis, contrarily to in the preceding exemplary embodiments. Accordingly, it is also possible to derive a cable length correction characteristic in performing the procedure on a certain pattern and then apply the derived cable length correction characteristic also to a plurality of different patterns. As a result, it becomes possible to derive an EMI characteristic with respect to each of the plurality of patterns with high accuracy and in a shorter time.

As has been described above, in the fourth exemplary embodiment of the present invention, design information including a structure, specifications and the like of a PCB, an EMI permissive condition and a cable length correction characteristic are set in advance. Accordingly, the system according to the fourth exemplary embodiment makes it possible for even a person not having deep knowledge of electrical circuits and electromagnetic waves to automatically determine whether or not a characteristic of EMI generated from the PCB is at a low level and also automatically design an optimum structure.

### Fifth Exemplary Embodiment

Next, a fifth exemplary embodiment of the present invention will be described in detail, with reference to drawings.

(Configuration)

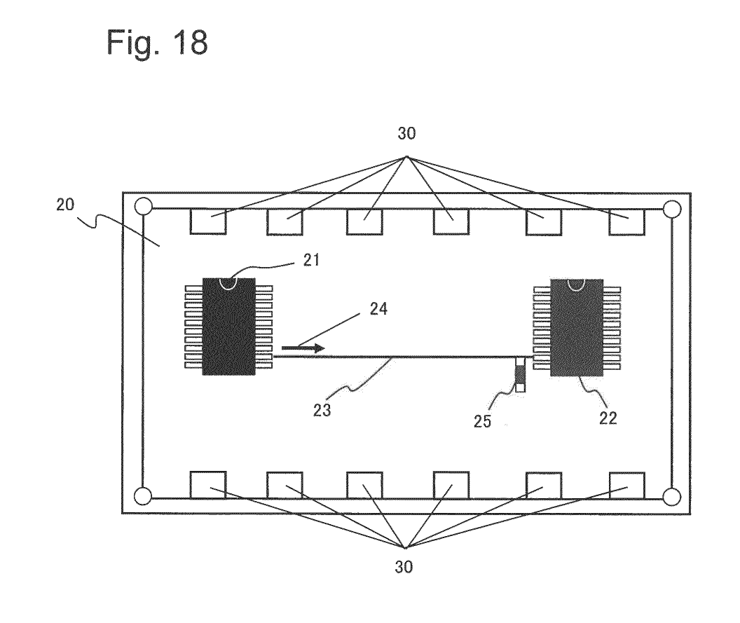

In the fifth exemplary embodiment of the present invention, the system configuration shown in FIG. 15 is employed, similarly to in the fourth exemplary embodiment. In the fifth exemplary embodiment, the system shown in FIG. 15 is applied to, for example, a use for finding an optimum cable connection position (connector position) from among a plurality of cable connection position candidates 30 for connecting a cable, shown in FIG. 18, which are provided on the PCB 20. It is assumed that, in principle, the database 3 does not include any cable length correction characteristic, in the initial state.

(Operation)

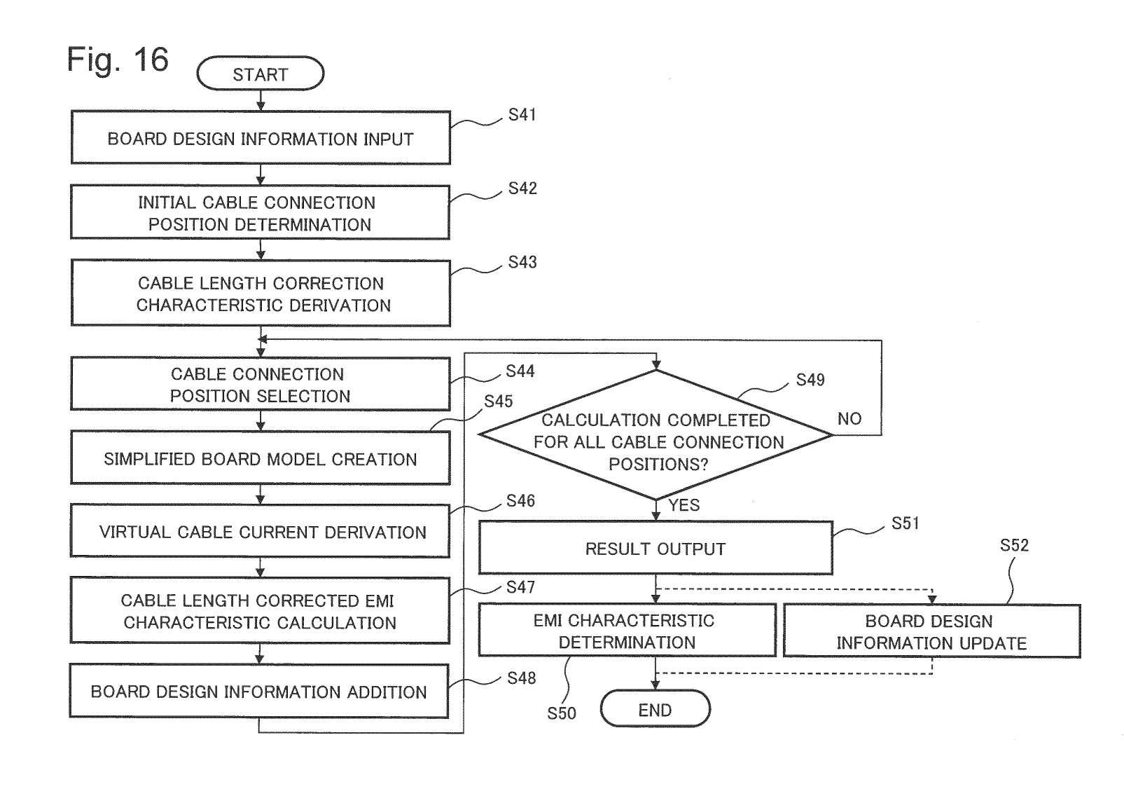

FIG. 16 is a flow chart showing a series of processes according to the fifth exemplary embodiment of the present invention.

First, the input means 1 performs the board design information input process where it inputs the board design information on a PCB stored in the storage device 10 of FIG. 15 (PCB design information 11, LSI design information 12 and cable structure design information 13) to the EMI characteristic derivation means 2B of FIG. 15 (step 41).

It may be defined that, in the board design information input process of the step 41, with respect to the structure of the PCB 20 in FIG. 18, at the same time when the PCB design information 11 being such as CAD data on the board is inputted, information on components mounted on the PCB 20 also is inputted. It may be further defined that, at the same time, the LSI design information 12 including information on LSIs to be mounted and the cable structure design information 13 including information on a cable to be connected are inputted. Here, because there are a plurality of cable connection position candidates 30 in the fifth exemplary embodiment, it is assumed that, in the board design information, information on at which position the cable is connected to the board is not included, but position information on the cable connection position candidates 30 is included as positions having a possibility of the cable's being connected there.

Next, the EMI characteristic derivation means 2B of FIG. 15 performs an initial cable connection position determination process using the inputted board design information (step 42).

In the initial cable connection position determination process of the step 42, the EMI characteristic derivation means 2B determines a position at which the cable is connected first, from among the cable connection position candidates 30 of FIG. 18. A method of the determination may be already set in the board design information, and in particular, it is preferable that the method is set in the PCB design information 11. For example, a method may be set to be such as that which connects the cable first at the lower left position among the cable connection position candidates 30 of FIG. 18.

Next, the analysis model creation means 4, the board analysis means 5 and the cable length correction characteristic derivation means 9, of FIG. 15, perform the cable length correction characteristic derivation process of FIG. 16 (step 43).

In the cable length correction characteristic derivation process of the step 43, the board generation means consisting of the analysis model creation means 4 and the board analysis means 5 creates a detailed board model (FIG. 6) and a simplified board model (FIG. 7), into both of which information on the initial cable connection position is reflected. Then, the board analysis means 5 derives the actual cable current 54 and the virtual cable current 58. Subsequently, using the actual cable current 54 and the virtual cable current 58, the cable length correction characteristic derivation means 9 derives a cable length correction characteristic. The cable length correction characteristic derivation means 9 stores the obtained cable length correction characteristic into the database 3 of the storage device 10 in FIG. 15.

Next, the EMI characteristic derivation means 2B of FIG. 15 performs a cable connection position selection process (step 44).

The cable connection position selection process of the step 44 is a process of selecting a cable connection position with respect to which a common mode radiation characteristic is to be calculated, and at the present stage, the initial cable connection position is selected without substitution.

Next, the board analysis means 5 of FIG. 15 performs the simplified board model creation process (step 45). Here, a simplified board model with respect to the initial cable connection position has already been created in the cable length correction characteristic derivation process of the step 43. Accordingly, the process of the step 33 may be a process of only calling for the already created simplified board model with respect to the initial cable connection position, or may be skipped.

Next, the board analysis means 5 of FIG. 15 performs the virtual cable current derivation process (step 46). Here, the virtual cable current 58 with respect to the initial cable connection position has already been derived in the cable length correction characteristic derivation process of the step 43. Accordingly, the process of the step 46 may be a process of only calling for the already derived virtual cable current 58 with respect to the initial cable connection position, or may be skipped.

Next, the EMI calculation means 6 of FIG. 15 performs the cable length corrected EMI characteristic calculation process (step 47). Here, the actual cable current 54 with respect to the initial cable connection position has already been derived in the cable length correction characteristic derivation process of the step 43. Accordingly, the EMI calculation means 6 may read out the cable length correction characteristic stored in the database 3 of FIG. 15, and perform the process of deriving the actual cable current 59 (FIG. 8) flowing in the actual cable, with respect to the initial cable connection position, from the virtual cable current and the cable length correction characteristic. Alternatively, the EMI calculation means 6 may only call for the actual cable current 54, with respect to the initial cable connection position, already derived in the cable length correction characteristic derivation process of the step 43. Using the actual cable current (54 or 59) obtained as above, the EMI calculation means 6 further calculates a characteristic of common mode radiation generated from the cable connected at the initial cable connection position, according to a relation between current flowing in a cable and radiation from the cable.

Then, the EMI characteristic derivation means 2B of FIG. 15 performs a board design information addition process (step 48). In the board design information addition process of the step 48, the EMI characteristic derivation means 2B registers the cable connection position with respect to which a common mode radiation characteristic has already been calculated as above, into the inputted board design information.

Next, the EMI characteristic derivation means 2B of FIG. 15 performs a cable connection position completion determination process (step 49). In the cable connection position completion determination process of the step 49, the EMI characteristic derivation means 2B determines whether or not a common mode radiation characteristic has been derived with respect to each and every one of the cable connection position candidates 30 shown in FIG. 18.

Here, the present description will be continued for the case where the derivation of common mode radiation characteristics with respect to all of the cable connection positions has not yet been completed (No at the Step 49). In that case, that is, if the step 49 results in No, returning to the cable connection position selection process of the step 44, the EMI characteristic derivation means 2B performs a process of selecting a cable connection position with respect to which a common mode radiation characteristic is to be derived next. A method of determining the cable connection position may be set already in the board design information, and in particular, it is preferable that the method is included in the PCB design information 11. For example, the method may be set to be such as that which selects one of the cable connection position candidates 30 of FIG. 18 neighboring in the counterclockwise direction to the previously selected one, starting from the lower left one.

Next, the board analysis means 5 of FIG. 15 performs the simplified board model creation process (step 45). Here, while the board analysis means 5 creates a simplified board model with respect to the selected cable connection position, there is no need of change in the board model 51 of the simplified board model shown in FIG. 7, and accordingly, the present process may be a process of changing only the virtual cable model 56 and then connecting it to the board model 51 of the simplified board model already created with respect to the initial cable connection position.

Next, the board analysis means 5 of FIG. 15 performs the virtual cable current derivation process (step 46). Here, the board analysis means 5 derives the virtual cable current 58 by performing electromagnetic field analysis of the simplified board model created in the step 45.

Next, the EMI calculation means 6 of FIG. 15 performs the cable length corrected EMI characteristic calculation process (step 47). Here, the EMI calculation means 6 performs a process of reading out the cable length correction characteristic which has already been derived with respect to the initial cable connection position and stored in the database 3 of FIG. 15, and then deriving the actual cable current 59 from the virtual cable current 58 and the cable length correction characteristic. Using the actual cable current 59, the EMI calculation means 6 further calculates a characteristic of common mode radiation generated from the cable, according to a relation between electric current flowing in a cable and radiation from the cable.

Then, the EMI characteristic derivation means 2B of FIG. 15 performs the board design information addition process (step 48). Here, the EMI characteristic derivation means 2B registers the cable connection position with respect to which a common mode radiation characteristic has already been calculated as above, into the inputted board design information.

Next, the EMI characteristic derivation means 2B of FIG. 15 performs the cable connection position completion determination process (step 49). In the cable connection position completion determination process of the step 49, the EMI characteristic derivation means 2B determines whether or not a common mode radiation characteristic has been derived with respect to each and every one of the cable connection position candidates 30 shown in FIG. 18.

If, even at the present stage, the derivation of common mode radiation characteristics with respect to all of the cable connection position candidates 30 has not yet been completed, returning to the cable connection position selection process of the step 44, the procedure of selecting a cable connection position with respect to which a common mode radiation characteristic is to be derived next, and then deriving a common mode radiation characteristic for when the cable is connected at the selected position is repeated.

The above is the operation flow of when the derivation of common mode radiation characteristics with respect to all of the cable connection positions has not yet been completed (No at the step 49).

On the other hand, if it is determined, in the cable connection position completion determination process of the step 49, that a common mode radiation characteristic has been derived with respect to each and every one of the cable connection position candidates 30 shown in FIG. 18 (Yes at the step 49), the EMI characteristic determination means 8 of FIG. 15 performs the EMI characteristic determination process (step 50).

In the EMI characteristic determination process of the step 50, the EMI characteristic determination means 8 reads out an EMI permissive condition stored in the database 3 of the storage device 10 in FIG. 15, compares it with each and every one of the derived common mode radiation characteristics with respect to the respective cable connection position candidates, and thereby determines whether each of the common mode radiation characteristics satisfies the EMI permissive condition or not.

Then, the EMI characteristic determination means 8 performs the result output process where it outputs, to the output means 7 of FIG. 15, EMI characteristics corresponding to the common mode radiation characteristics derived with respect to all cable connection position candidates and results of the determination of whether the EMI permissive condition is satisfied or not (step 51).

With that process, the series of operations according to the fifth exemplary embodiment is completed. Here, a board design information update process (step 52) may be performed simultaneously and in parallel with the step 51.

In the board design information update process of the step 52, the board design information in the storage device 10 (PCB design information 11, LSI design information 12 and cable structure design information 13) is updated in a manner to reflect the EMI characteristics and the EMI permissive condition. For example, the results of determining whether or not the set EMI permissive condition is satisfied with respect to respective ones of the cable connection position candidates 30 can be reflected into the board design information set in the storage device 10. As a way of the reflection, it may be defined that an error sign is recorded into the CAD data for any of the cable connection position candidates 30 which does not satisfy the EMI permissive condition, or the like. Alternatively, a process of outputting a result of comparison with the EMI permissive condition, like that shown in FIG. 17, may be performed with respect to each of the cable connection position candidates 30. For example, a process of changing the color may be performed only on a position candidate given an error sign among the cable connection position candidates 30 on the CAD.

Thus, in the fifth exemplary embodiment, the PCB design information 11, the LSI design information 12 and the cable structure design information 13, which are included in the set board design information, are simultaneously inputted, and on the basis of those pieces of information, an EMI characteristic is derived with respect to each cable connection position candidate, and then a result of determining whether or not each of the derived EMI characteristics satisfies an EMI permissive condition is outputted. As a result, what needs to be done by a user becomes only to cause the system to perform the series of processes if the user can at least set the board design information into the storage device 10, and accordingly, it becomes possible for the user to easily find a cable connection position making common mode radiation generated from the cable become at a low level, and to design a PCB structure and PCB specifications on the basis of the finding result. Further, because derivation of an EMI characteristic with respect to a single piece of input information can be performed in a short time, it becomes possible, even when a plurality of patterns need to be analyzed, to derive EMI characteristics with respect to all of the patterns in a realistic time. The above-described user operation can be easily dealt with by even a person not having deep knowledge of electrical circuits and electromagnetic waves.

### Sixth Exemplary Embodiment

Next, a sixth exemplary embodiment of the present invention will be described in detail, with reference to drawings.

(Configuration)

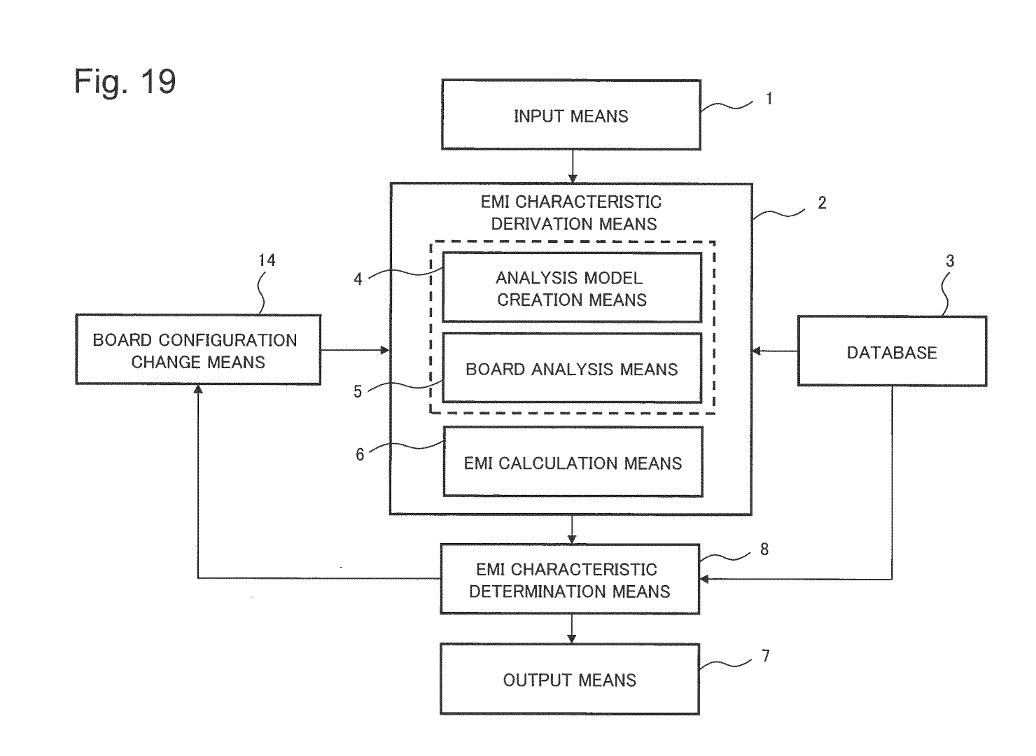

FIG. 19 shows a system configuration according to the sixth exemplary embodiment of the present invention. The present exemplary embodiment has a configuration obtained by adding a board configuration change means 14 to the system configuration according to the second exemplary embodiment shown in FIG. 10. In the sixth exemplary embodiment, if it is determined by the EMI characteristic determination means 8 that an EMI characteristic derived by the EMI characteristic derivation means 2 does not satisfy an EMI permissive condition, the board design information on a PCB is changed by means of the board configuration change means 14. Thus changed board design information is inputted again to the EMI characteristic derivation means 2. A guideline on changing a PCB configuration may be set in advance in the database 3. For example, the EMI characteristic determination means 8 may be configured to be able to call for also the guideline on change at the same time when it calls for an EMI permissive condition from the database 3.

(Operation)

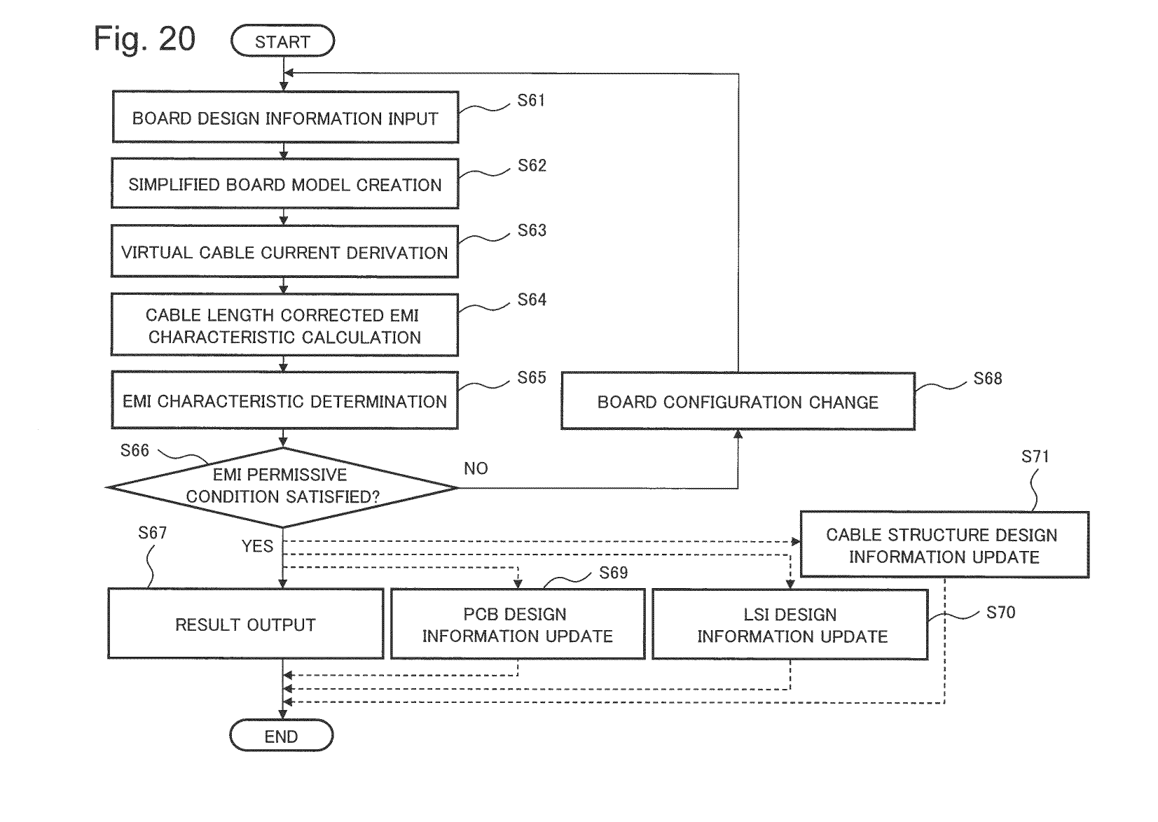

FIG. 20 is a flow chart showing a series of processes according to the sixth exemplary embodiment of the present invention. The flow chart corresponds to the one obtained by adding a change determination process and a board configuration change process to the flow chart in FIG. 11 showing the series of processes of the second exemplary embodiment.

First, the input means 1 performs the board design information input process where it inputs board design information on a PCB into the EMI characteristic derivation means 2 of FIG. 19 (step 61).

Next, the analysis model creation means 4 in the EMI characteristic derivation means 2 of FIG. 19 performs the simplified board model creation process where it creates a simplified board model by the use of the inputted board design information (step 62).

Then, on the basis of the simplified board model (FIG. 7), the board analysis means 5 in the EMI characteristic derivation means of FIG. 19 performs the virtual cable current derivation process where it derives the virtual cable current 58 flowing in the virtual cable model 56 (step 63)

Next, the EMI calculation means 6 in the EMI characteristic derivation means 2 of FIG. 19 performs the cable length corrected EMI characteristic calculation process using the virtual cable current 58 (step 64).

In the cable length corrected EMI characteristic calculation process of the step 64, the EMI calculation means 6 reads out a cable length correction characteristic stored in the database 3 of FIG. 19, and derives the actual cable current 59 from the virtual cable current 58 and the cable length correction characteristic. Using the actual cable current 59, the EMI calculation means 6 further calculates a characteristic of common mode radiation generated from the cable, according to a relation between current flowing in a cable and radiation from the cable.

Then, the EMI characteristic determination means 8 of FIG. 19 performs the EMI characteristic determination process (step 65).

In the EMI characteristic determination process of the step 65, the EMI characteristic determination means 8 reads out an EMI permissive condition stored in the database 3 of FIG. 19 and compares it with the derived common mode radiation characteristic, and thereby determines whether or not the common mode radiation characteristic satisfies the EMI permissive condition.

Next, the EMI characteristic determination means 8 of FIG. 19 performs the change determination process (step 66).

In the change determination process of the step 66, according to the result of determining whether or not the EMI permissive condition is satisfied, the EMI characteristic determination means 8 selects whether or not to perform the board configuration change process on the PCB.

Here, when the derived common mode radiation characteristic does not satisfy the EMI permissive condition (No at the step 66), the board configuration change means 14 of FIG. 19 performs the board configuration change process (step 68).

The board configuration change process of the step 68 will be described below.

First, in the EMI characteristic determination process of the step 65, at the same time when the board configuration change means 14 calls for an EMI permissive condition from the database 3, it also calls for a guideline on changing a PCB configuration to be performed when the EMI permissive condition is not satisfied. Then, in accordance with the guideline on change, the board configuration change means 14 performs a process of changing the PCB design information 11, the LSI design information 12 and the cable structure design information 13, which have been prepared as the board design information on the PCB. With respect to the board design information based on the changed PCB configuration, the board configuration change means 14 performs again the series of processes starting from the step 61 of FIG. 20.

When, in the change determination process of the step 66, the derived common mode radiation characteristic satisfies the EMI permissive condition (Yes at the step 66), the EMI characteristic determination means 8 performs the result output process where it outputs the determination result to the output means 7 (Step 67). Here, the determination result corresponds to an EMI characteristic equivalent to the derived common mode radiation characteristic and whether or not the EMI characteristic satisfies the EMI permissive condition.

With that process, the series of processes according to the sixth exemplary embodiment is completed. Here, it is assumed that steps 69, 70 and 71 of FIG. 20 are not performed in the sixth exemplary embodiment.

At the present stage of the processes, if the board design information has been changed, the changed board design information may be outputted simultaneously and in parallel with the step 67. At the same time, diagrams comparing the EMI permissive condition with the EMI characteristics obtained respectively before and after the change of board design information may be also outputted. For example, a comparison diagram for the case of not satisfying the EMI permissive condition before the change of board design information, like that in the left diagram of FIG. 17, and a comparison diagram for the case of satisfying the EMI permissive condition after the change of board design information, like that in the right diagram of FIG. 17, may be outputted. By thus presenting the radiation characteristic curves for before and after the change of board design information, it becomes possible to obtain knowledge about how the radiation characteristic has been changed by changing the board design information.

Further, a plurality of guidelines on changing a board configuration may be set. When the EMI permissive condition has not been satisfied by one change of board design information, if next change guidelines had been set, it becomes possible to obtain a PCB configuration satisfying the EMI permissive condition by repeating change of the board configuration. For example, the guidelines may be set to be such as that instructs to change also the LSI design information 12 if the EMI permissive condition is not satisfied even by changing the PCB design information 11, and to change also the cable structure design information 13 if the EMI permissive condition is not satisfied even by changing the LSI design information 12. The orders of changing the prepared board design information may be combined optionally.

Thus, in the present exemplary embodiment, what needs to be done by a user is to cause the system to perform the series of processes if the user has set board design information, an EMI permissive condition and a guideline(s) on changing the board configuration, and as a result, it becomes possible to easily design a PCB structure and PCB specifications making common mode radiation generated from the cable become at a low level.

### Seventh Exemplary Embodiment

Next, a seventh exemplary embodiment of the present invention will be described in detail, with reference to drawings.

(Configuration)

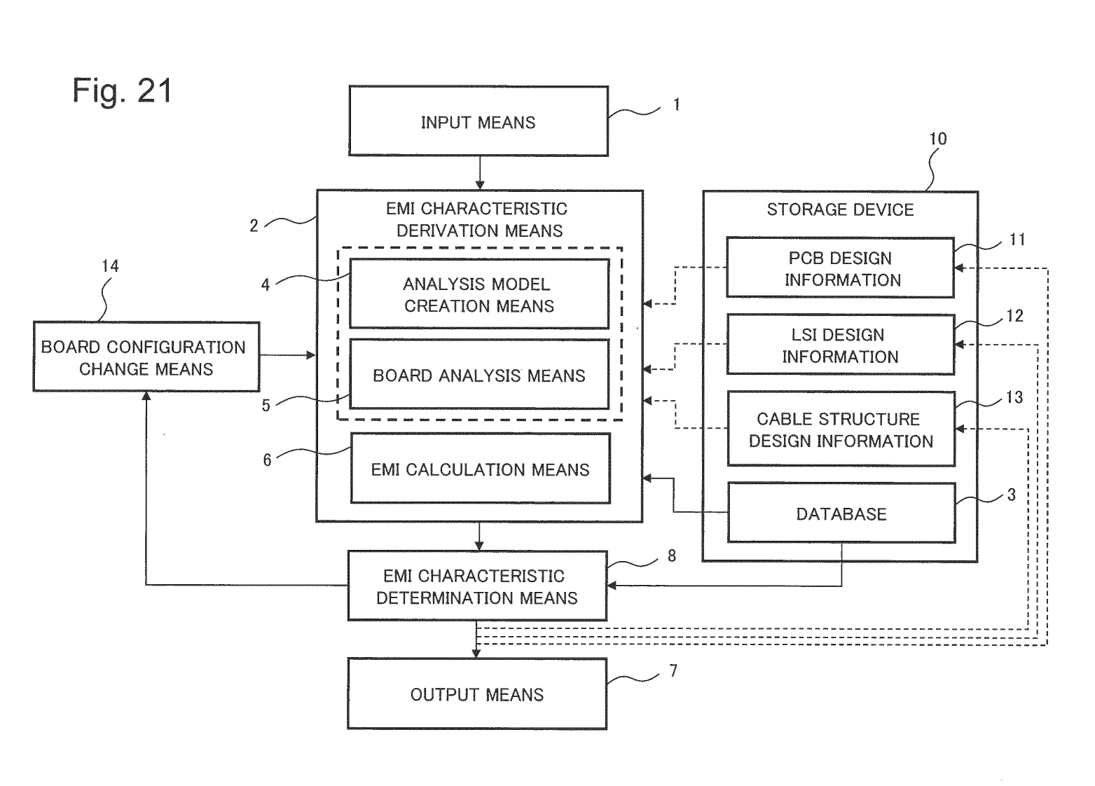

FIG. 21 shows a system configuration according to the seventh exemplary embodiment of the present invention. The seventh exemplary embodiment has a configuration obtained by adding a storage device 10 to the system configuration according to the sixth exemplary embodiment shown in FIG. 19,

The storage device 10 stores, similarly to in the fourth exemplary embodiment, the database 3 and board design information including the PCB design information 11 corresponding to information on a PCB's structure and components, the LSI design information 12 corresponding to information on an LSI's structure and characteristics, and the cable structure design information 13 corresponding to a cable's physical structure.

In the seventh exemplary embodiment, the input means 1 automatically inputs the board design information from the storage device 10 to the EMI characteristic derivation means 2. From the inputted board design information and a cable length correction characteristic and an EMI permissive condition obtained from the database 3, the EMI characteristic determination means 8 automatically performs derivation of an EMI characteristic and determination of whether the derived EMI characteristic satisfies the EMI permissive condition or not. Here, the system configuration is made such that, if the EMI characteristic determination means 8 determines that the inputted PCB configuration does not satisfy the EMI permissive condition, the board configuration change means 14 changes the board configuration, according to a guideline on changing the PCB configuration set in advance. In accordance with the configuration change, the board configuration change means 14 changes the board design information on the PCB and inputs the changed board design information again to the EMI characteristic derivation means 2. The guideline on changing the PCB configuration may be set in advance in the database 3, and may also be set such that the EMI characteristic determination means 8 can call for the guideline on change at the same time when it calls for the EMI permissive condition from the database 3. Further, the system configuration is made such that the derived EMI characteristic and PCB configuration information for a case of satisfying the EMI permissive condition is not only outputted to the output means 7, but the outputted result is also reflected into the board design information (PCB design information 11, LSI design information 12 and cable structure design information 13).

(Operation)

In the seventh exemplary embodiment, a series of processes is performed according to the flow chart of FIG. 20, similarly to in the sixth exemplary embodiment.

First, the input means 1 performs the board design information input process where it inputs the PCB design information 11 into the EMI characteristic derivation means 2 of FIG. 21 (step 61).

In the board design information input process of the step 61, at the same time when the PCB design information 11 including such as CAD data on a board is inputted, information on components mounted on the board may also be inputted. Also at the same time, the LSI design information 12 corresponding to information on LSIs mounted on the board and the cable structure design information 13 corresponding to information on a cable connected to the board may be inputted.

Next, the board analysis means 5 of FIG. 21 performs the simplified board model creation process where the simplified board model (FIG. 7) is created using the board design information inputted in the step 61 (step 62).

Then, using the simplified board model (FIG. 7) created in the step 62, the board analysis means 5 in the EMI characteristic derivation means of FIG. 21 performs the virtual cable current derivation process where it derives the virtual cable current 58 flowing in the virtual cable model 56 (step 63)

Next, using the virtual cable current 58, the EMI calculation means 6 in the EMI characteristic derivation means 2 of FIG. 21 performs the cable length corrected EMI characteristic calculation process (step 64).

In the cable length corrected EMI characteristic calculation process of the step 64, the EMI calculation means 6 reads out the cable length correction characteristic stored in the database 3 of FIG. 21 first. Then, from the virtual cable current 58 and the cable length correction characteristic, the EMI calculation means 6 derives the actual cable current 59 (FIG. 8) flowing in the actual cable. Using the actual cable current 59, the EMI calculation means 6 further calculates a characteristic of common mode radiation generated from the cable, according to a relation between current flowing in a cable and radiation from the cable.

Subsequently, the EMI characteristic determination means 8 of FIG. 21 performs the EMI characteristic determination process (step 65).

In the EMI characteristic determination process of the step 65, the EMI characteristic determination means 8 reads out the EMI permissive condition stored in the database 3 of FIG. 21 and compares it with the derived common mode radiation characteristic, and thereby determines whether or not the common mode radiation characteristic satisfies the EMI permissive condition.

Next, the EMI characteristic determination means 8 of FIG. 21 performs the change determination process (step 66).

In the change determination process of the step 66, according to the determination result derived in the step 65, the EMI characteristic determination means 8 selects whether or not to perform the board configuration change process on the PCB.

Here, when the derived common mode radiation characteristic does not satisfy the EMI permissive condition (No at the step 66), the board configuration change means 14 of FIG. 21 performs the board configuration change process (step 68).

The board configuration change process of the step 68 will be described below.

First, in the EMI characteristic determination process of the step 65, at the same time when the board configuration change means 14 calls for the EMI permissive condition from the database 3, it also calls for a guideline on changing the PCB configuration to be performed when the EMI permissive condition is not satisfied.

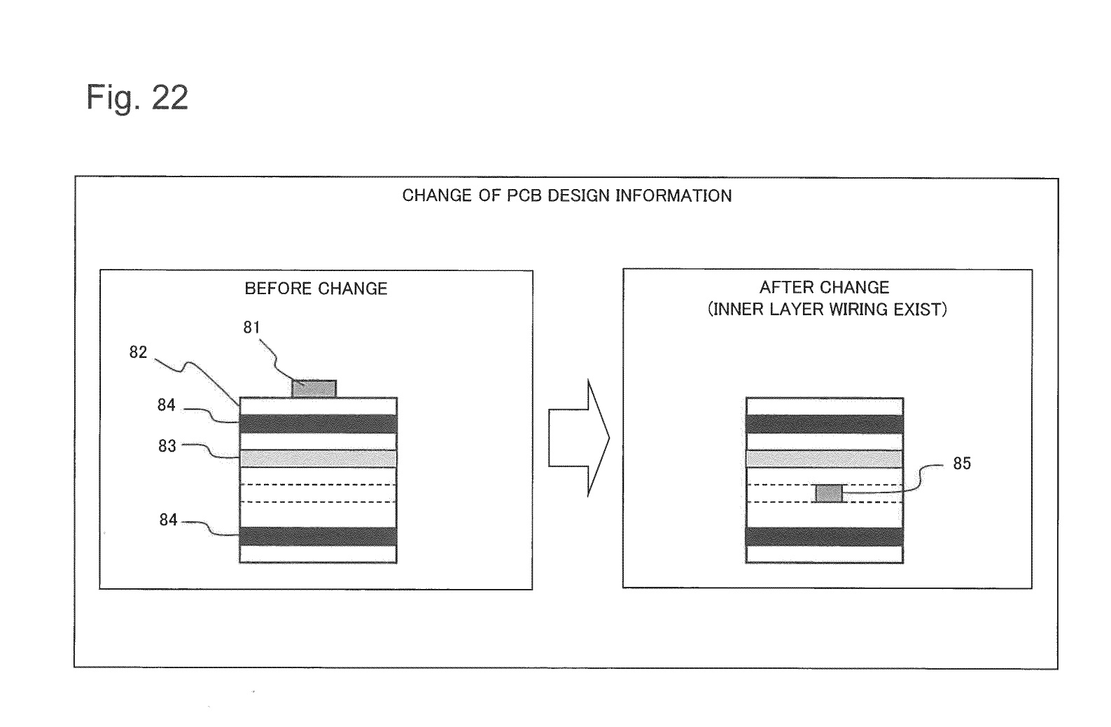

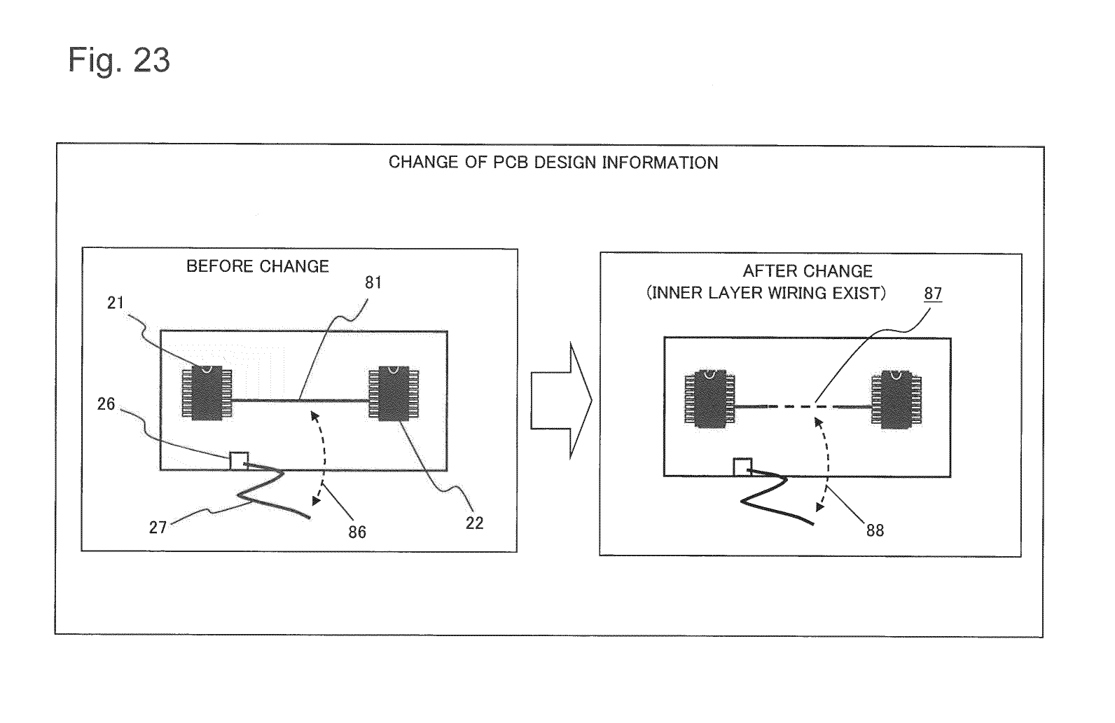

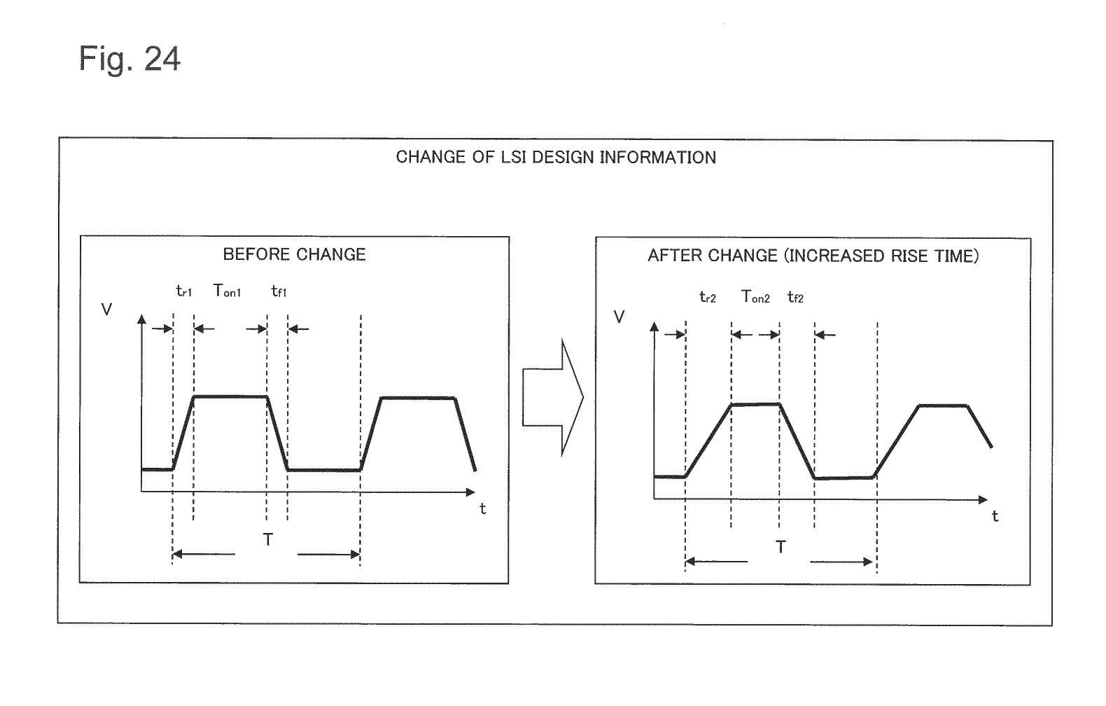

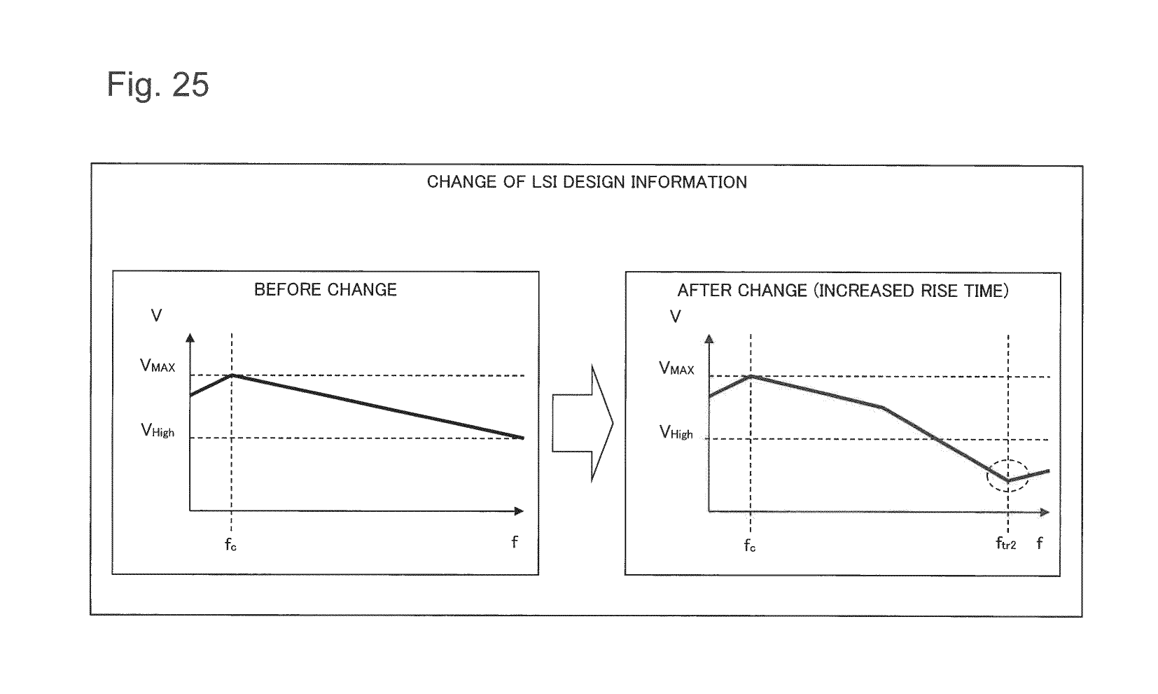

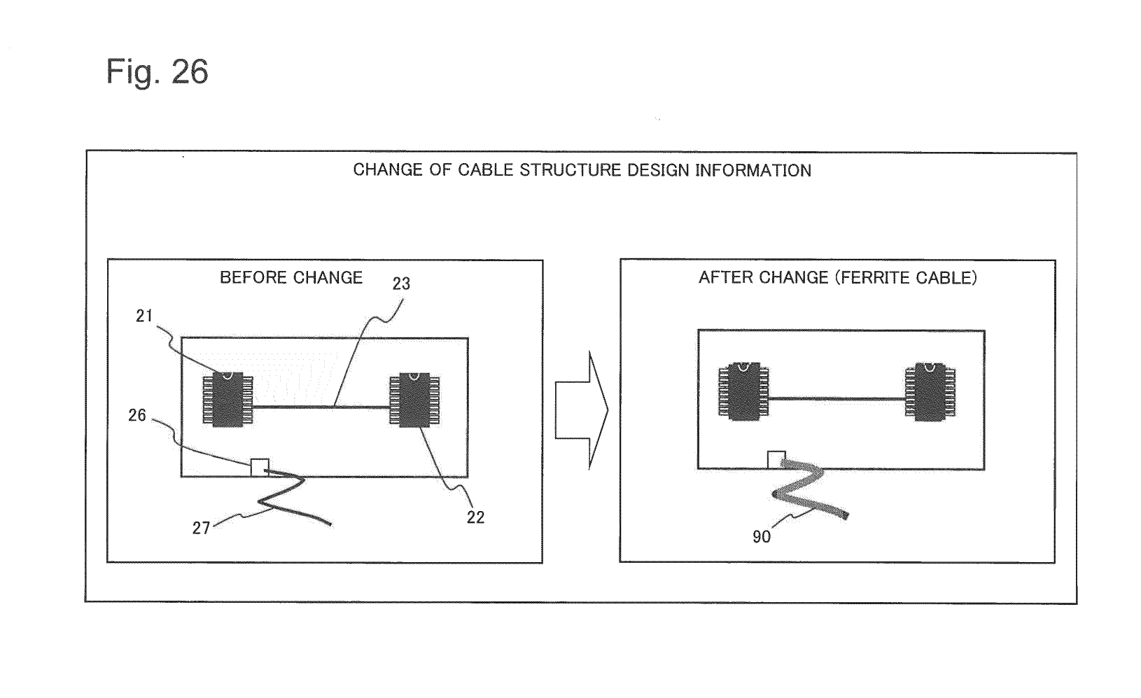

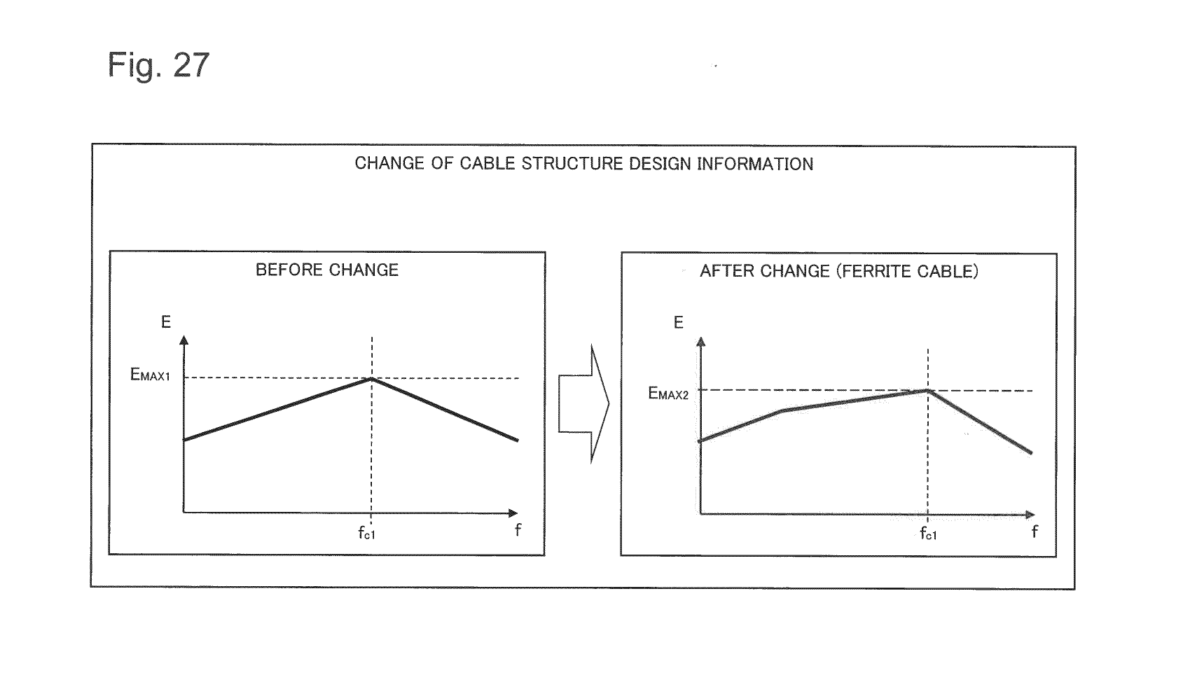

Accordingly, following the guideline on change, the board configuration change means 14 performs a process of changing the board design information on the PCB, in such a manner as shown in FIGS. 22 to 27, where the PCB design information 11 (FIGS. 22 and 23), the LSI design information 12 (FIGS. 24 and 25) and the cable structure design information 13 (FIGS. 26 and 27) are changed as shown in the respective figures. With respect to the board design information based on the changed PCB configuration, the board configuration change means 14 performs again the series of processes starting from the step 61 of FIG. 20.

On the other hand, when, in the change determination process of the step 66, the derived common mode radiation characteristic satisfies the EMI permissive condition (Yes at the step 66), the result output process is performed. In the result output process, the EMI characteristic determination means 8 outputs, to the output means 7 of FIG. 21, an EMI characteristic equivalent to the derived common mode radiation characteristic and the result of determining whether or not the EMI characteristic satisfies the EMI permissive condition (step 67).

With that process, the series of processes according to the seventh exemplary embodiment is completed.

At the present stage of the processes, if the board design information has been changed, the changed board design information and diagrams comparing the EMI permissive condition with the EMI characteristics obtained respectively before and after the change of board design information may be outputted simultaneously and in parallel with the step 67. Further, the board design information in the storage device 10 may be updated at the same time, in accordance with the change of board design information.

Specifically, if the PCB design information 11 has been changed, a PCB design information update process is performed, where the PCB design information 11 in the storage device 10 of FIG. 21 is updated in a manner to reflect the result of change (step 69). If the LSI design information 12 has been changed, an LSI design information update process is performed, where the LSI design information 12 in the storage device 10 of FIG. 21 is updated in a manner to reflect the result of change (step 70). If the cable structure design information 13 has been changed, a cable structure design information update process is performed, where the cable structure design information 13 in the storage device 10 of FIG. 21 is updated in a manner to reflect the result of change (step 71).

The above is the description of the series of processes according to the seventh exemplary embodiment.

(Example of Board Design Information Change)

Here, a description will be given of an example of changing board design information in the steps 69 to 71 according to the seventh exemplary embodiment, using FIGS. 22 to 27.

FIGS. 22 and 23 show, on the basis of the PCB shown in FIGS. 3 and 4 which has been referred to in the above descriptions, respectively, an example for before changing the PCB design information 11 (left diagram) and an example for after changing of the PCB design information 11 where part of the signal wiring is formed as an internal layer (right diagram).

FIG. 22 is a cross-sectional view of the board. The left diagram in FIG. 22 shows the example with a signal wiring 81 formed in the surface layer, and the right diagram in FIG. 22 shows the example after the change which has an internal layer wiring 85. In the internal layer structure of the board, a power supply layer 83 and ground layers 84 are embedded in a dielectric material 82. In the example after the change shown in the right diagram of FIG. 22, the internal layer wiring 85 is arranged in between the two ground layers 84.

FIG. 23 is a top view of the board. In the example shown in the left diagram of FIG. 23, electromagnetic coupling 86 occurs between the signal wiring 81 and the cable 27, and accordingly, when the wiring current 24 flows in the signal wiring 23, the cable current 28 flows in the cable 27, and as a result, the common mode radiation 29 is generated from the cable 27.

In contrast, in the case of the example shown in the right diagram of FIG. 23 where a signal wiring 87 comprises the internal layer wiring 85, the part corresponding to the internal layer wiring 85 is sandwiched in between the ground layers 84, and accordingly, electromagnetic coupling 88 between the signal wiring 87 and the cable 27 is reduced in accordance with the proportion of the internal layer wiring 85. As a result, the cable current 28 is reduced, and accordingly, the common mode radiation 29 can be suppressed.

In the above-described case, as updated information to be included into the PCB design information 11, mentioned are the change in the layer for the signal wiring (when the wiring is partially changed into an internal layer wiring, the corresponding part only), the change in the three-dimensional structure due to the change of layers, and addition and position change of a via associated with the change of the wiring partially into an internal layer wiring. Those pieces of updated information are written into the PCB design information 11 in the PCB design information update process of the step 69 in FIG. 20.

FIGS. 24 and 25 show an example in which the rise time of a signal voltage V is changed, as an example of changing the LSI design information 12.

In an example for before changing the configuration (the left diagram in FIG. 24), the signal voltage V is a pulse signal defined by a cycle T, a rise time tr1, a fall time tf1 and an ON time Ton1. Here, an example of a change in which the rise time tr1 is changed to a larger value tr2, as in an example for after the change (the right diagram in FIG. 24), will be shown.

In FIG. 25 showing frequency characteristics of the signal voltage, the left diagram shows that of before the configuration change, and the right diagram shows that of after the configuration change, where, as shown in the right diagram, a voltage component at a frequency corresponding to the rise time (ftr2 in FIG. 25) is reduced, and high frequency components of the voltage are also reduced. As a result, high frequency components of common mode radiation are reduced. Practically, a voltage component at a frequency ftr1 corresponding to tr1 is small even before the change, but by the change of the rise time to a larger value tr2, a frequency giving a small voltage is shifted to a lower frequency (here, ftr2), and thereby, the effect of suppressing common mode radiation is increased. In the above-described case, as updated information to be included into the LSI design information 12, mentioned are the change of the rise time from tr1 to tr2, that of the fall time from tf1 to tf2, and that of the ON time from Ton1 to Ton2. Those pieces of updated information are written into the LSI design information 12 in the LSI design information update process of the step 70 in FIG. 20.

FIGS. 26 and 27 show an example in which the material of the cable is changed, as an example of changing the cable structure design information 13.

In this example of change, the cable 27 before the change shown in the left diagram in FIG. 26 is changed to a cable 90 coated with ferrite, as in the right diagram in FIG. 26. As shown in FIG. 27, common mode radiation before the change shown in the left diagram has a maximum value EMax1 at a high frequency fc1. In contrast, in an example for after the change shown in the right diagram in FIG. 27, common mode radiation in the high frequency region is suppressed by the effect of the ferrite coating, and the maximum value is reduced to EMax2.

In the above-described case, as a change of the cable structure design information 13, mentioned is that in the material and diameter of the cable 90 caused by the ferrite coating. The updated information is written into the cable structure design information 13 in the cable structure design information update process of the step 71 in FIG. 20.

The above is the description of the steps 69 to 71 of FIG. 20 using the examples of change.

As has been described above, in the seventh exemplary embodiment, the PCB design information 11, the LSI design information 12 and the cable structure design information 13, which are included in the board design information set in advance, are simultaneously inputted. Then, the board design information is changed on the basis of a guideline on change, in a manner to obtain an EMI characteristic satisfying an EMI permissive condition, and the changed board design information is outputted. Accordingly, if it is possible at least to set the board design information and a guideline on change for when the EMI permissive condition is not satisfied, to the storage device 10, then the series of processes are performed by the system, and a PCB configuration satisfying the EMI permissive condition is outputted. As a result, it becomes possible for even a person not having deep knowledge of electrical circuits and electromagnetic waves to easily design a PCB structure and PCB specifications making common mode radiation generated from the cable become at a low level.

In the circuit board design system according to the seventh exemplary embodiment, what needs to be done by a user is only to set a plurality of patterns of PCB design information and then cause the system to perform the series of processes on the basis of input information with respect to each of the patterns. Accordingly, it becomes possible for the user to easily design a PCB structure and PCB specifications making common mode radiation generated from the cable become at a low level. The above-described user operation can be easily dealt with by even a person not having deep knowledge of electrical circuits and electromagnetic waves.

Further, according to the seventh exemplary embodiment, when PCB design information having a plurality of different patterns has been set, by repeatedly performing the series of processes described above with respect to each of the patterns, it becomes possible to automatically determine which one of the design patterns satisfies an EMI permissive condition, and thereby extract an optimum design pattern. Also in that case, because the determination on a single pattern can be performed in a short time, it becomes possible to extract an optimum pattern in a realistic design time.

### Practical Example

Here, as a practical example according to one of the exemplary embodiments of the present invention (the fifth exemplary embodiment), an example of designing a PCB configuration will be described.

(Configuration)

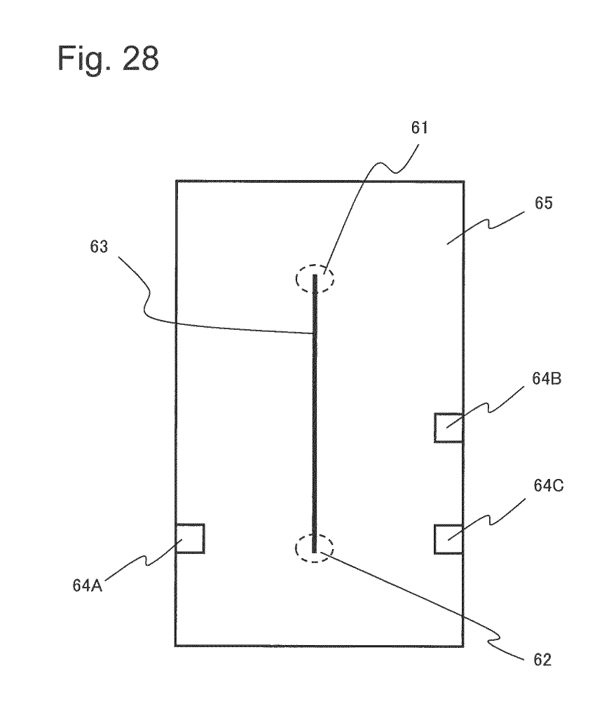

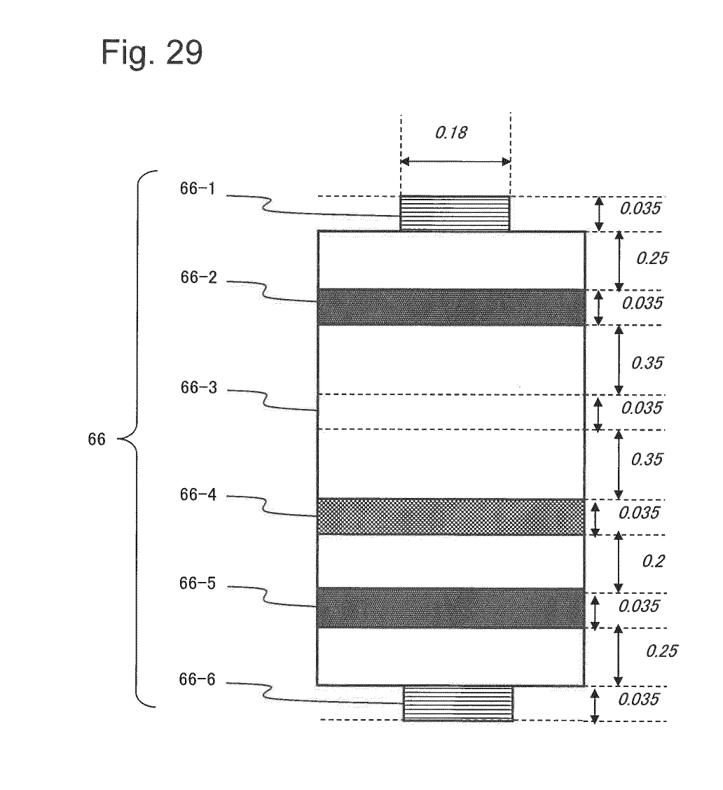

FIGS. 28 and 29 show the structure of a PCB treated in the present practical example. Here, the system according to the fifth exemplary embodiment, shown in FIG. 15, is used as a circuit board design system.

FIG. 28 is a top view of the PCB in the present practical example. In FIG. 28, information on portions of the PCB which are unnecessary for creating an analysis model is omitted. In FIG. 28, a signal wiring 63 made of a copper wiring with 60 mm length and 0.18 mm width is arranged on the surface of a board 65 having a size of 100 mm×50 mm. The signal wiring 63 is arranged such that its center coincides with the center of the board 65 corresponding to the intersection between the diagonal lines in the surface of the board 65. At both ends of the signal wiring 63, a transmission end 61 and a reception end 62 are respectively provided, and LSIs not illustrated in the diagram are connected respectively to the transmission end 61 and the reception end 62. Three cable connection position candidates 64 (cable connection position candidates A, B and C) are provided along sides of the board 65.

FIG. 29 is a cross-sectional structure of the PCB in the present practical example.

The board 65 has a set of conductor layers 66 in a form of a six-layer structure. The set of conductor layers 66 held by the board 65 is arranged in a manner to line up the constituent layers as S-G-S-V-G-S in order from the surface layer (the first layer). Here, S represents a signal layer, G a ground layer (also referred to as a GND layer), and V a power supply layer (voltage layer, also referred to as a VCC layer). It is defined that the constituent layers of the set of conductor layers 66 are called, in order from the surface layer, respectively, first signal layer 66-1, first GND layer 66-2, second signal layer 66-3, VCC layer 66-4, second GND layer 66-5 and third signal layer 66-6. A dielectric material with a relative dielectric constant ∈ r=4.2 is present between each of the layers. A number shown at the right side of each of the layers in FIG. 29 indicates an example of the thickness of the layer (in unit of mm).

The transmission-side and reception-side LSIs not illustrated in the diagram and the signal wiring are all arranged on or in the first S layer 66-1 being the top layer. The transmission-side and reception-side LSIs are each connected to one of the GND layers and the VCC layer through vias not illustrated in the diagram.

Cable connectors (with a size of 5 mm×5 mm) are also provided on the top layer, and they are each connected to one of the GND layers through a via not illustrated in the diagram. As selectable cable connectors, the cable connection position candidates A, B and C are set. The cable connection position candidate A is located at a position which abuts on the left end of the board and is 20 mm away from the bottom end (64A in FIG. 28). The cable connection position candidate B is located at a position which abuts on the right end of the board and is 38 mm away from the bottom end (64B in FIG. 28). The cable connection position candidate C is located at a position which abuts on the right end of the board and is 20 mm away from the bottom end (64C in FIG. 28).

The GND layers (both of the two layers) and the VCC layer each have a full plane structure and the same lateral size as that of the board. The third and sixth layers are set to be signal layers, but in the present pattern, they exist only as constituent layers of the six-layer board and accordingly are not in use. The above-described information is included in the PCB design information 11 of FIG. 15, as two-dimensional CAD data, a layer structure, the structures and characteristics of components.

In the LSI design information 12 of FIG. 15, included is information that the voltage characteristic of the transmission end 61 corresponds to an AC voltage of 1 V amplitude and that the capacitance of the reception end 62 is 10 pF, as characteristics of the LSIs.

While the cable connection position has not been determined yet, structure information that the material of the cable is copper, its diameter is 1 mm and its length is 1 m is included in the cable structure connection information 13 of FIG. 15.

Here, assuming that an EMI permissive condition “a characteristic of EMI to be generated should be equal to or lower than 65 μV/m over a frequency range up to 500 MHz” is set, performed is determination, with respect to the above-described PCB, of selecting which cable connection position from among the cable connection position candidates A, B and C enables to design a PCB structure satisfying the EMI permissive condition, by the use of the system according to the fifth exemplary embodiment. There, it is assumed that no cable length correction characteristic is set in the initial stage.

(Operation)

A series of processes in the present practical example will be described below. The series of processes in the present practical example is performed following the flow chart of FIG. 16.

First, the PCB design information 11, the LSI design information 12 and the cable structure design information 13 corresponding to board design information on the PCB shown in FIGS. 28 and 29 are set into the storage device 10 of FIG. 15. It is assumed that the above-described EMI permissive condition has already been set in the database 3 of the storage device 10.

The board design information input process of FIG. 16 is performed first, where the PCB design information 11, the LSI design information 12 and the cable structure design information 13 corresponding to the board design information on the PCB shown in FIGS. 28 and 29 are inputted to the EMI characteristic derivation means 2B of FIG. 15 (step 41).

Next, the initial cable connection position determination process of FIG. 16 is performed, where a position at which the cable is first connected is determined (step 42). Here, assuming that information that the initial cable connection position is the cable connection position candidate A has been included in the PCB design information 11, the determination is made to set the initial cable connection position to be the cable connection position candidate A.

Next, the cable length correction characteristic derivation process of FIG. 16 is performed (step 43).

The cable length correction characteristic derivation process of the step 43 will be described below, using FIG. 14.

First, by performing the detailed board model creation process of the step 301 in FIG. 14, the analysis model creation means 4 of FIG. 15 creates a detailed board model whose cable connection position is the cable connection position candidate A, according to the board design information on the PCB shown in FIG. 28.

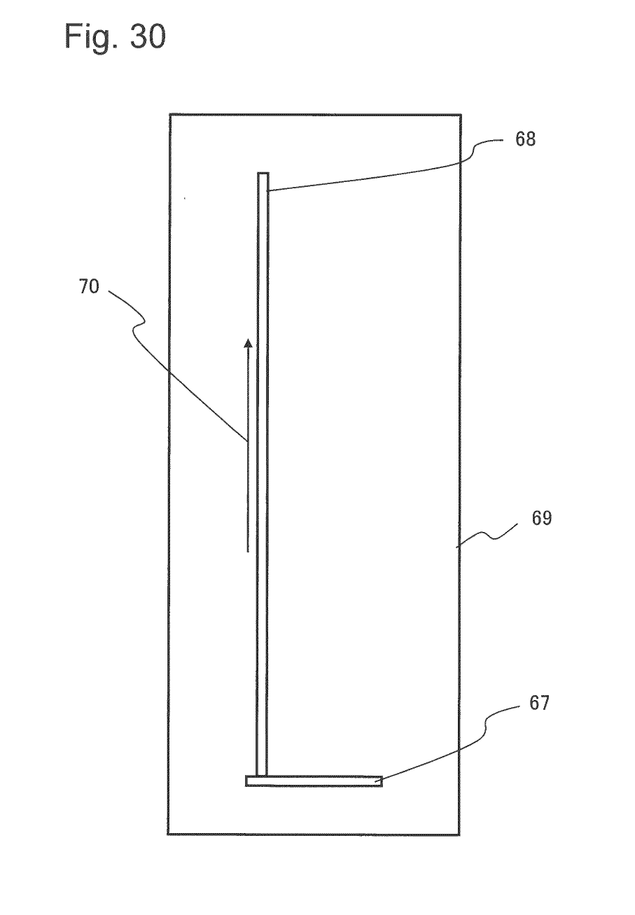

FIG. 30 shows a detailed board model to be an electromagnetic field analysis model for when the cable connection position is the cable connection position candidate A.

In creating the detailed board model of FIG. 30, the analysis model creation means 4 creates a board model 67 from the board design information set as above, in a manner to represent the PCB configuration shown in FIGS. 28 and 29. The board model 67 is composed of information on the structure and electrical characteristics of each of the layers for wiring, ground and the like, and their connections through vias, and is further composed of an electric power supply model at the transmission end 61 (AC source of 1 V amplitude) and a termination model at the reception end 62 (capacitance model of 10 pF). Also in the detailed board model of FIG. 30, a cable model 68 is created to be a model which is connected to the board model at a position representing the cable connection position candidate A, and reflects the cable length (1 m), the cable diameter and the cable material. Thus, an analysis space 69 corresponding to the detailed board model is formed.

Next, the board analysis means 5 of FIG. 15 performs the actual cable current derivation process of the step 302 in FIG. 14. In the actual cable current derivation process, the board analysis means 5 analyzes the detailed board model shown in FIG. 30 and thereby derives the actual cable current 70. Hereafter, when giving a description using FIG. 30, the description will be given without distinguishing between the actual cable current obtained from the detailed board model and that obtained from a virtual cable current calculated from both a simplified board model and the cable length correction characteristic. A frequency step of the analysis is assumed to be 50 MHz.

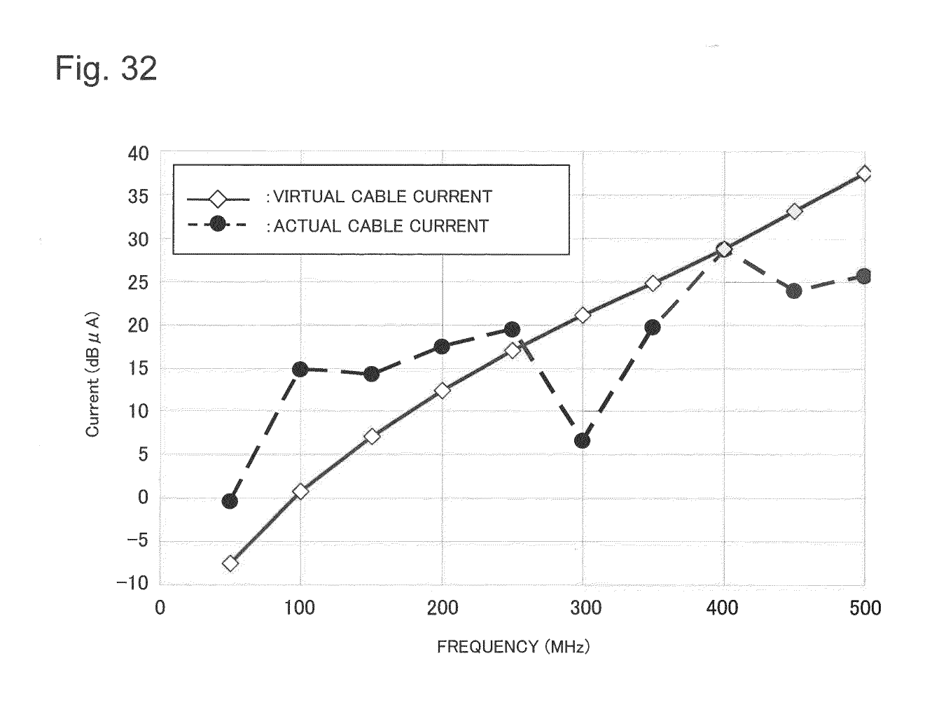

Here, the actual cable current 70 derived as above shows a characteristic represented by a dashed line in FIG. 32, where it is recognized that various resonance components caused by the cable length are included.

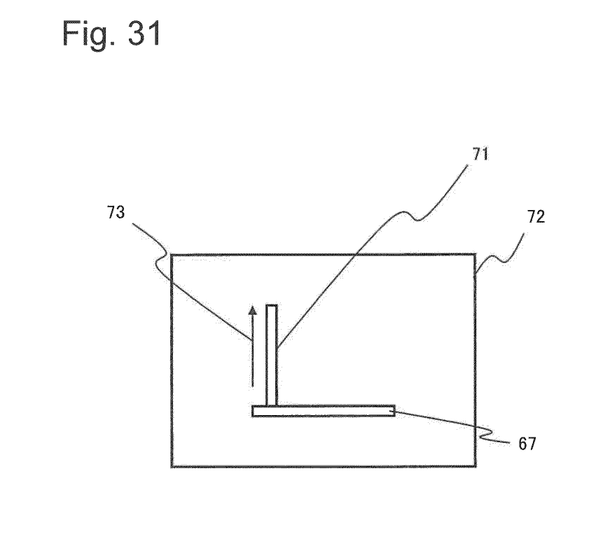

Next, by performing the simplified board model creation process of the step 303 in FIG. 14, the analysis model creation means 4 of FIG. 15 creates a simplified board model shown in FIG. 31, which is an electromagnetic field analysis model for when the cable connection position is the cable connection position candidate A.

There, because there should be no difference in the board model between the detailed and simplified board models, the board model used in the detailed board model creation process of the step 301 in FIG. 14 may be used with no change. Of a virtual cable model 71, the connection position, diameter and material are not changed, but only the length is changed, from the cable model 68. Because the maximum frequency is determined to be 500 MHz by the EMI permissive condition, the maximum value L_{c1} of the length of the virtual cable model 71 is calculated by a following equation 3. The equation 3 is an equation obtained by substituting 500×10⁶ for F_{c} in the equation 1 shown in the first exemplary embodiment.

L_{c1}=300×10⁶/(4×500×10⁶)=150×10⁻³ (3)

Here, in consideration of the accuracy, the virtual cable length is set at 150 mm, which is the maximum value L_{c1} calculated as above. This condition may be set in advance in the cable structure connection information 13, or the system may be configured such that the virtual cable length L_{c1} is automatically determined if reading the cable structure connection information, and then the virtual cable model 71 is created to have the virtual cable length L_{c1}.

In the present stage, an analysis space 72 is formed in relation to the virtual cable model 71, as shown in FIG. 31, which becomes considerably smaller in size compared to the analysis space 69 of the detailed board model shown in FIG. 30.

Next, the board analysis means 5 of FIG. 15 performs the virtual cable current derivation process of the step 304 of FIG. 14. In the virtual cable current derivation process, the board analysis means 5 analyzes the simplified board model shown in FIG. 31 and thereby derives the virtual cable current 73. A frequency step of the analysis is set at 50 MHz, similarly to the case of the detailed board model. Because the analysis space 72 has been reduced, the present analysis is performed in a shorter time than the analysis of the detailed board model of FIG. 30 to derive the actual cable current 70.

A characteristic of the virtual cable current 73 becomes that represented by a solid line in FIG. 32, where it is recognized that no resonance component caused by the cable length is included.

Next, the cable length correction characteristic derivation means 9 of FIG. 15 performs the cable length correction characteristic calculation process of the step 305 in FIG. 14. In the cable length correction characteristic calculation process, the cable length correction characteristic derivation means 9 derives a cable length correction characteristic from the characteristic of the actual cable current 70 and that of the virtual cable current 73, shown in FIG. 32. In the present step, the cable length correction characteristic derivation means 9 derives the cable length correction characteristic by a method which divides the actual cable current characteristic by the virtual cable current characteristic to obtain a current ratio and further obtains an approximate curve of the current ratio characteristic. However, because a ¼ wavelength resonance corresponding to the cable length of 1 m exists at 75 MHz in the low frequency region, values of the characteristic at 50 MHz and 100 MHz, which are frequencies around the resonance frequency, are calculated using the respective current ratios without approximation.

The method for deriving a cable length correction characteristic may be installed in advance into the cable length correction characteristic derivation means 9, where it may be installed in a manner to enable its customization when change in the cable length occurs. Information about a cable length correction characteristic may be included in the cable structure connection information 13 and automatically selected when the cable structure connection information 13 is inputted.

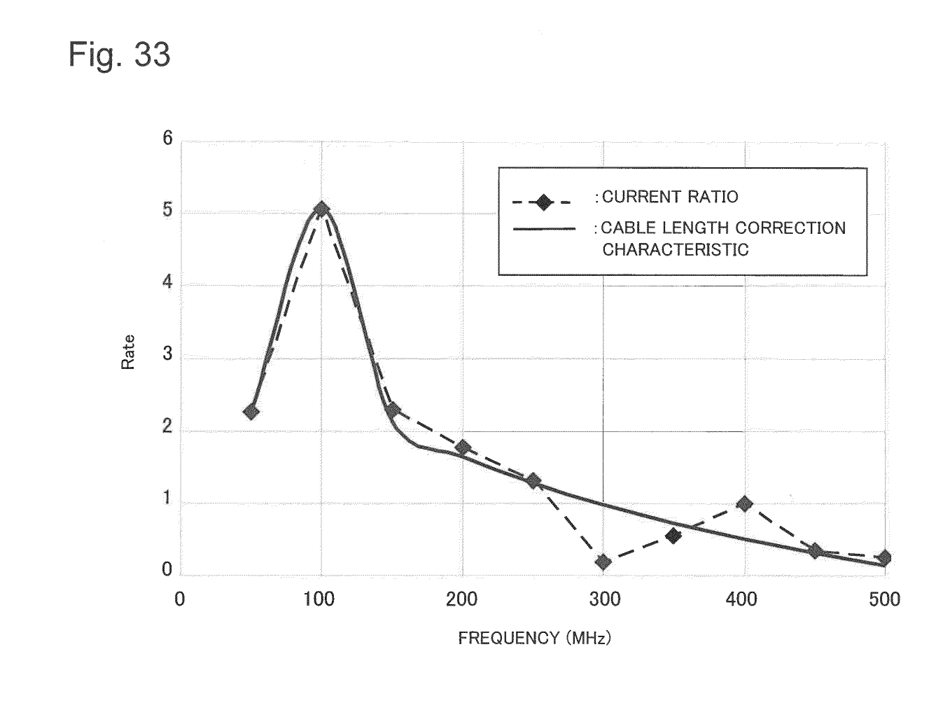

FIG. 33 shows the current ratio calculated as above (dashed line) and the cable length correction characteristic derived from the current ratio (solid line). While the current ratio (dashed line) has a plurality of resonance components, the cable length correction characteristic (solid line) becomes the one which does not reflect the other resonance components than that of the ¼ wavelength resonance corresponding to the cable length.

Next, the database output process of the step 306 in FIG. 14 is performed, where the derived cable length correction characteristic is stored into the database 3 of FIG. 15, and with that, the cable length correction characteristic derivation process is completed.

The above-described processes of the steps 301 to 306 in FIG. 14 are performed within the cable length correction characteristic derivation process of the step 43 in FIG. 16.

Next, the EMI characteristic derivation means 2B of FIG. 15 performs the cable connection position selection process of the step 44 in FIG. 16. At the present stage, the cable is to be connected at the cable connection position candidate A, which is the initial connection position, and therefore, the cable connection position candidate A is selected with no change.

In the process flow according to the fifth exemplary embodiment, it is usual that, next, the board analysis means 5 of FIG. 15 performs the simplified board model creation process of the step 45 in FIG. 16. However, at the present stage, a simplified board model for when the cable connection position is the cable connection position candidate A has already been created in the cable length correction characteristic derivation process of the step 43 in FIG. 16, and accordingly, the simplified board model creation process is skipped.

In the process flow according to the fifth exemplary embodiment, it is usual that, next, the board analysis means 5 of FIG. 15 performs the virtual cable current derivation process of the step 46 in FIG. 16. However, at the present stage, the virtual cable current 73 for when the cable connection position is the cable connection position candidate A has already been derived in the cable length correction characteristic derivation process of the Step 43 in FIG. 16, and accordingly, the virtual cable current derivation process is skipped.

Next, the EMI calculation means 6 of FIG. 15 performs the cable length corrected EMI characteristic calculation process of the step 47 in FIG. 16.

At the present stage, the EMI calculation means 6 has already derived the actual cable current 70 for when the cable connection position is the cable connection position candidate A in the cable length correction characteristic derivation process of the step 43 in FIG. 16. However, it is defined that, in the cable length corrected EMI characteristic calculation process of the step 47 in FIG. 16, in consideration of comparison with the other cable connection position candidates 64, the EMI calculation means 6 reads out the cable length correction characteristic shown in FIG. 33 stored in the database 3 of FIG. 15, and then, from the virtual cable current 73 and the cable length correction characteristic, derives the actual cable current 70, flowing in the actual cable, for when the cable connection position is the cable connection position candidate A. Then, using the actual cable current 70, the EMI calculation means 6 further calculates a characteristic of common mode radiation generated from the cable whose present cable connection position is the cable connection position candidate A, according to the equation 2 relating between current flowing in a cable and radiation from the cable.

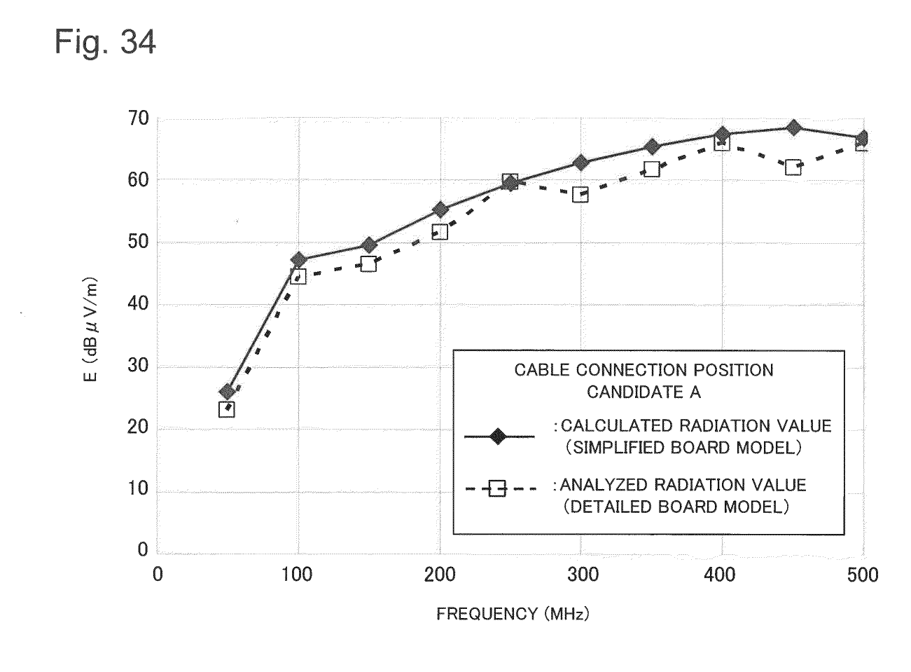

FIG. 34 shows a common mode radiation characteristic (solid line) which has been calculated as above for when the cable connection position is the cable connection position candidate A. For comparison, also shown is a result of analyzing common mode radiation by the use of the detailed board model of FIG. 30 (dashed line).

According to FIG. 34, discrepancy between the common mode radiation characteristic calculated by the detailed board model of FIG. 30 (dashed line) and that by the simplified board model of FIG. 31 (solid line) is at most about 6 dB, and accordingly, it can be said that the two radiation characteristics show considerably good agreement.

Next, the EMI characteristic derivation means 2B of FIG. 15 performs the board design information addition process of the step 48 in FIG. 16. In the board design information addition process, the EMI characteristic derivation means 2B registers the cable connection position candidate A, as a cable connection position with respect to which a common mode radiation characteristic has already been calculated, into the inputted board design information.

Next, the EMI characteristic derivation means 2B of FIG. 15 performs the cable connection position completion determination process of the step 49 in FIG. 16. In the cable connection position completion determination process, performed is determination of whether or not a common mode radiation characteristic has been derived with respect to each and every one of the cable connection position candidates 64 shown in FIG. 28.

At the present stage, because the derivation has been performed only with respect to the cable connection position candidate A, which is the initial design position, returning to the cable connection position selection process of the step 44 in FIG. 16, the EMI characteristic derivation means 2B performs a process of selecting a cable connection position with respect to which a common mode radiation characteristic is to be derived next. A method for determining a cable connection position may be set in advance in the board design information, specifically as the PCB design information 11, and, in the present practical example, it is assumed that a method of “selecting in the order of candidate A→candidate B→candidate C” is set in advance in the board design information.

At the present stage, because the derivation of an EMI characteristic has already been completed with respect to the cable connection position candidate A, the cable connection position candidate B is selected next, according to the above-described method for determining a cable connection position.

Next, the board analysis means 5 of FIG. 15 performs the simplified board model creation process of the step 45 in FIG. 16. In the simplified board model creation process, the board analysis means 5 creates a simplified board model with respect to the cable connection position candidate B having been selected as above, where there is no need of change in the board model 67 of the simplified board model shown in FIG. 31. Accordingly, the board analysis means 5 performs a process of connecting the virtual cable model 71 to the board model 67 of the simplified board model having been created for when the cable connection position is the cable connection position candidate A, where the cable connection position is changed to the cable connection position candidate B. In that way, the board analysis means 5 creates a simplified board model for when the cable connection position is the cable connection position candidate B.

Next, the board analysis means 5 of FIG. 15 performs the virtual cable current derivation process of the step 46 in FIG. 16. In the virtual cable current derivation process, the board analysis means 5 performs electromagnetic field analysis of the created simplified board model, and thereby derives the virtual cable current 73 for when the cable connection position is the cable connection position candidate B.

Next, the EMI calculation means 6 of FIG. 15 performs the cable length corrected EMI characteristic calculation process of the step 47 in FIG. 16. In the cable length corrected EMI characteristic calculation process, the EMI calculation means 6 reads out the cable length correction characteristic shown in FIG. 33 (solid line), which is stored in the database 3 of FIG. 15, and then, from the virtual cable current 73 and the cable length correction characteristic, derives the actual cable current 70 for when the cable connection position is the cable connection position candidate B. Using the actual cable current 70, the EMI calculation means 6 further calculates a characteristic of common mode radiation generated from the cable, according to the equation 2 relating between electric current flowing in a cable and radiation from the cable.

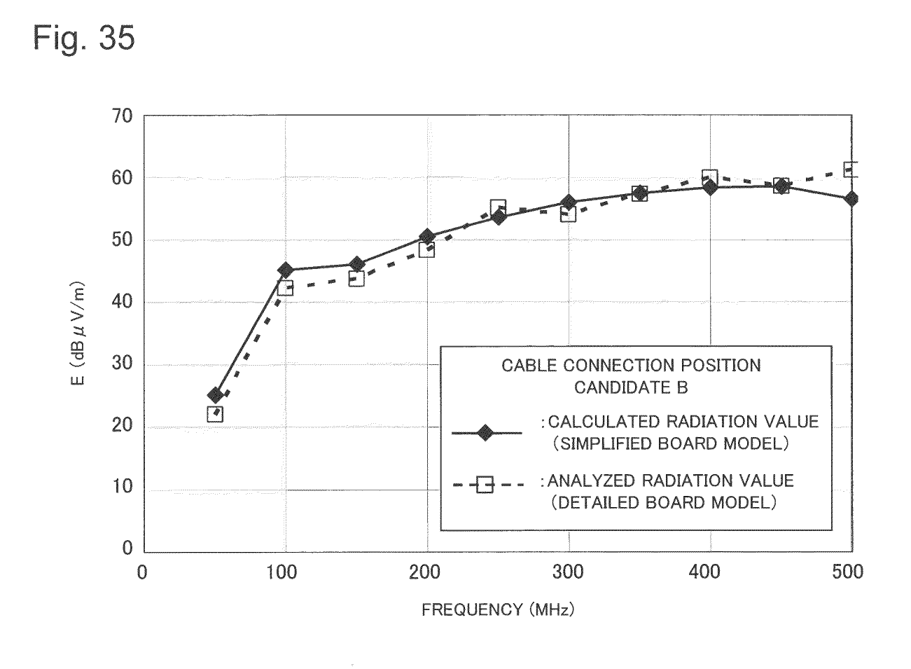

Thus obtained characteristic becomes the one represented by a solid line in FIG. 35. Also in the present case, if the characteristic is shown along with a result of deriving an EMI characteristic by the use of a detailed board model for when the cable connection position is the cable connection position candidate B (dashed line), as in FIG. 35, for comparison, the difference between the two is at most about 3 dB, and they therefore show good agreement.

Next, the EMI characteristic derivation means 2B of FIG. 15 performs the board design information addition process of the step 48 in FIG. 16. In the board design information addition process, the EMI characteristic derivation means 2B adds and registers, into the inputted board design information, the cable connection position candidate B as a cable connection position with respect to which a common mode radiation characteristic has already been calculated.

Next, the EMI characteristic derivation means 2B of FIG. 15 performs the cable connection position completion determination process of the step 49 in FIG. 16. In the cable connection position completion determination process, the EMI characteristic derivation means 2B determines whether or not a common mode radiation characteristic has been derived with respect to each and every one of the cable connection position candidates 64 shown in FIG. 28. Still at the present stage, derivation of common mode radiation characteristics with respect to all of the cable connection position candidates 64 has not been completed yet. Accordingly, returning to the cable connection position selection process of the step 44 in FIG. 16, the EMI characteristic derivation means 2B performs again the process of selecting a cable connection position with respect to which a common mode radiation characteristic is to be derived next. According to the set method for determining a cable connection position, the cable connection position candidate C is selected next, because derivation of an EMI characteristic has just been completed with respect to the cable connection position candidate B.

Next, the board analysis means 5 of FIG. 15 performs the simplified board model creation process. In the simplified board model creation process, the board analysis means 5 creates a simplified board model with respect to the cable connection position candidate B having been selected as above, where there is no need of change in the board model 67 of the simplified board model shown in FIG. 31. Accordingly, the board analysis means 5 performs a process of connecting the virtual cable model 71 to the board model 67 of the simplified board model already created for when the cable connection position is the cable connection position candidate A, where the cable connection position is changed to the cable connection position candidate C. In that way, the board analysis means 5 creates a simplified board model for when the cable connection position is the cable connection position candidate C.

Next, the board analysis means 5 of FIG. 15 performs the virtual cable current derivation process of the step 46 in FIG. 16. In the virtual cable current derivation process, the board analysis means 5 performs electromagnetic field analysis of the created simplified board model, and thereby derives the virtual cable current 73 for when the cable connection position is the cable connection position candidate C.

Next, the EMI calculation means 6 of FIG. 15 performs the cable length corrected EMI characteristic calculation process of the step 47 in FIG. 16. In the cable length corrected EMI characteristic calculation process, the EMI calculation means 6 reads out the cable length correction characteristic shown in FIG. 33 (solid line), which is stored in the database 3 of FIG. 15, and then, from the virtual cable current 73 and the cable length correction characteristic, derives the actual cable current 70 for when the cable connection position is the cable connection position candidate C. Using the actual cable current 70, the EMI calculation means 6 further calculates a characteristic of common mode radiation generated from the cable, according to the equation 2 relating between electric current flowing in a cable and radiation from the cable.

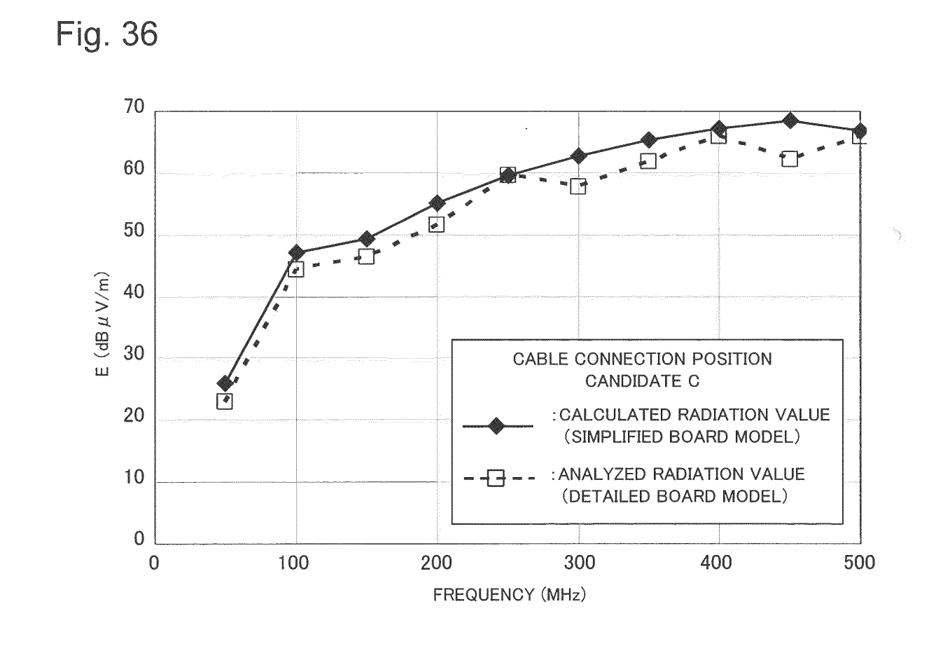

Thus obtained characteristic becomes the one represented by a solid line in FIG. 36. Also in the present case, if the characteristic is shown along with a result of deriving an EMI characteristic by the use of a detailed board model for when the cable connection position is the cable connection position candidate C (dashed line), as in FIG. 35, for comparison, the difference between the two is still at most about 6 dB, and they therefore show good agreement.

Next, the EMI characteristic derivation means 2B of FIG. 15 performs the board design information addition process of the step 48 in FIG. 16. In the board design information addition process, the EMI characteristic derivation means 2B adds and registers, into the inputted board design information, the cable connection position candidate C as a cable connection position with respect to which a common mode radiation characteristic has already been calculated.

Next, the EMI characteristic derivation means 2B of FIG. 15 performs the cable connection position completion determination process of the step 49 in FIG. 16. In the cable connection position completion determination process, the EMI characteristic derivation means 2B determines whether or not a common mode radiation characteristic has been derived with respect to each and every one of the cable connection position candidates 64 shown in FIG. 28. At the present stage, a common mode radiation characteristic has already been derived with respect to each and every one of the cable connection position candidates 64, which are the cable connection position candidates A, B and C. Accordingly, it is determined that a common mode radiation characteristic has already been derived with respect to every one of the cable connection position candidates 64, and accordingly, the EMI characteristic determination means 8 of FIG. 15 performs the EMI characteristic determination process of the step 50 in FIG. 16. In that process, the EMI characteristic determination means 8 reads out an EMI permissive condition stored in the database 3 of the storage device 10 in FIG. 15, compares it with each and every one of the derived common mode radiation characteristics with respect to the respective cable connection position candidates, and determines whether each of the common mode radiation characteristics satisfies the EMI permissive condition or not.

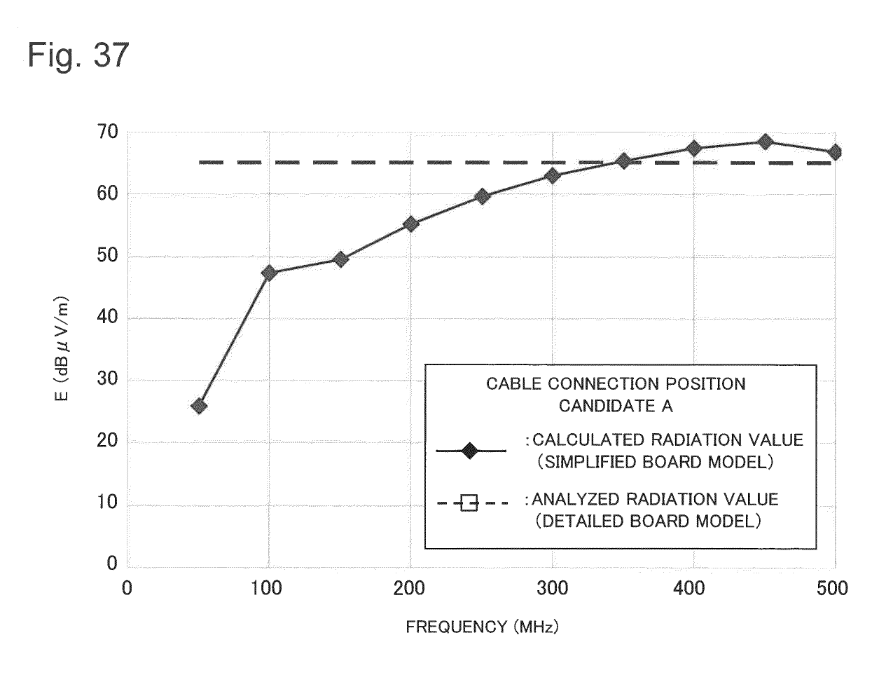

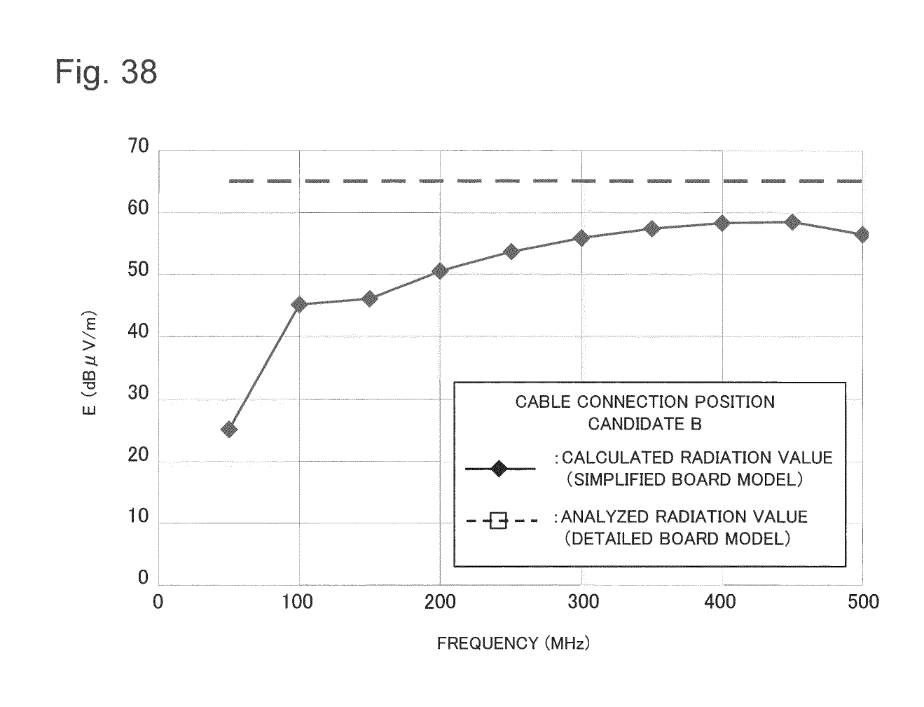

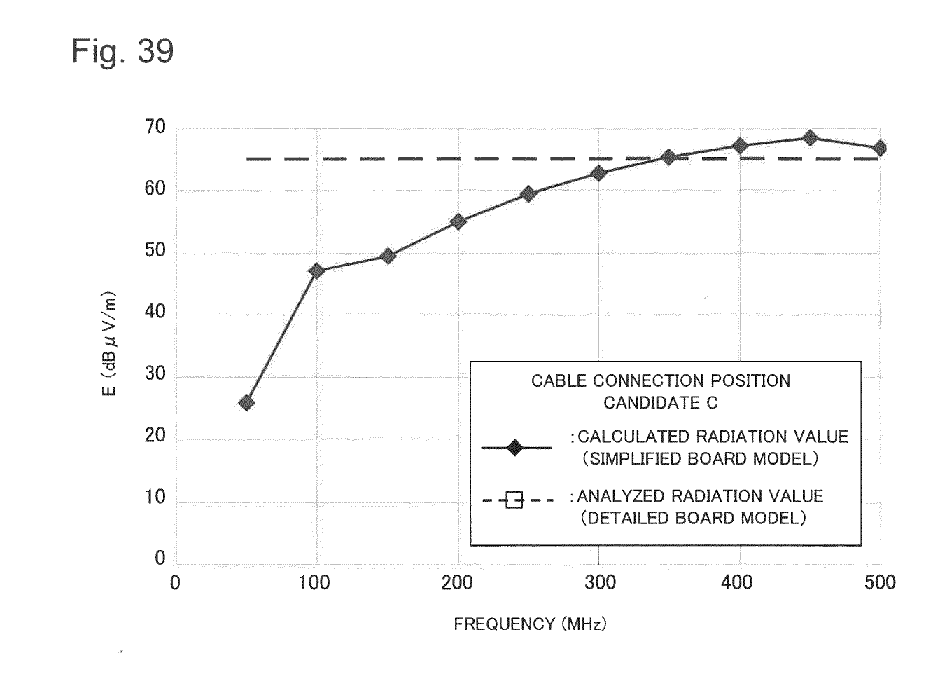

Results of the comparison are shown in FIGS. 37 to 39. FIGS. 37, 38 and 39 show results of comparison of the EMI permissive condition with, respectively, the common mode radiation characteristics with respect to the cable connection position candidates A, B and C. The EMI permissive condition “a characteristic of EMI to be generated should be equal to or lower than 65 μV/m over a frequency range up to 500 MHz” is satisfied only in the case of the cable connection position candidate B shown in FIG. 38, but is not satisfied in the cases of the cable connection position candidates A and C. Accordingly obtained is a determination result “The EMI permissive condition is satisfied by the cable connection position candidate B, but not satisfied by the cable connection position candidates A and C”.

Then, in the result output process of the step 51 in FIG. 16, the above-mentioned determination result is outputted to the output means 7 of FIG. 15.

At that time, simultaneously with the step 51 in FIG. 16, the board design information update process of the step 52 is performed, where the board design information (mainly, the PCB design information 11) stored in the storage device 10 of FIG. 15 is updated in a manner to reflect the EMI characteristics and the EMI permissive condition.

The above description is that of the series of processes according to the practical example of the fifth exemplary embodiment shown in FIG. 16.

In the result output process of the step 51, for example, the two-dimensional CAD data shown in FIG. 28 may be displayed to indicate errors such as by changing the colors of the positions corresponding to the cable connection position candidates A and C displayed there. Further, referring to the cable connection position candidates A, B and C, the EMI characteristics with respect to the respective positions and results of their comparison with the EMI permissive condition, respectively shown FIGS. 37 to 39, may be outputted.

As has been described above, if setting board design information and also setting an EMI permissive condition in the database, as in the present practical example, it is possible for even a person not having deep knowledge of electrical circuits and electromagnetic waves to perform PCB design, with the cable connection position candidate B corresponding to a cable connection position satisfying the EMI permissive condition being automatically set as the cable connector. Accordingly, it becomes possible for such a person to design a PCB structure and PCB specifications making common mode radiation generated from the cable become at a low level. While there are three cable connection position candidates 64 in the present practical example, analysis using a detailed board model needs to be performed with respect to only one pattern, and analysis using a simplified board model comes to have a considerably smaller analysis space than that of the detailed board model, and accordingly, it is possible to find an optimum cable connection position in a shorter time. Further, an EMI characteristic derived by means of the derivation method used by the present invention shows good agreement with a result of analysis using a detailed board model, as in the examples shown in FIGS. 34 to 36, and accordingly, it is possible to estimate an EMI characteristic quantitatively and with high accuracy, and to perform quantitative comparison with an EMI permissive condition also with high accuracy.

Although the present invention has been described above with reference to the exemplary embodiments and the practical example, the present invention is not limited to the above-described exemplary embodiments and practical example. To the configurations and details of the present invention, various changes which can be understood by those skilled in the art may be made within the scope of the present invention.

### INDUSTRIAL APPLICABILITY

The present invention can be applied to a use where an EMI characteristic is to be derived at each design stage without spending a large cost, with respect to a PCB with a cable connected to it and with an LSI mounted on it.

It is also applicable to a use where an optimum cable connection position is to be automatically found such that it has a characteristic of EMI to occur satisfying a permissive condition, and a use where a design of a PCB is changes such as in the PCB structure.

A main usage of the system of the present invention is the one where a printed wiring board manufacturer use the system for the purpose of proposing a PCB board structure designed to make the EMI characteristic become at a low level, in relation to necessary operation of an LSI to be mounted on the PCB. By setting a general EMI standard as an EMI permissive condition with respect to a PCB structure including an LSI to be mounted on it, and then designing a board structure, a cable connection position and the like in a manner to satisfy the EMI permissive condition, by the use of the system of the present invention, it becomes possible to provide a board structure which can make a characteristic of generated EMI become at a low level even when the mounted LSI is in the necessary operation.

It is also possible for an LSI vender to use the system of the present invention for the purpose of providing an LSI configuration with a low EMI characteristic. At the vender side, the configuration of a PCB expected to be used by a user or that of a standard PCB is used as input information. By setting a general EMI standard as an EMI permissive condition, and then designing operation, a terminal condition and the like satisfying the EMI permissive condition by the use of the system of the present invention, it becomes possible to provide a user with an LSI capable of realizing a low EMI characteristic when mounted on a PCB.

Part or the whole of the above-described exemplary embodiments can also be described as, but is not limited to, the following supplementary notes.

(Supplementary Note 1)

A circuit board design system for designing a circuit board with a semiconductor component mounted on it and with a cable connected to it, the circuit board design system comprising:

an input means for inputting board design information about the board configuration of said circuit board;

an EMI characteristic derivation means for deriving a characteristic of EMI generated from said cable connected to said circuit board, on the basis of said board design information; and

a storage means for storing a cable length correction characteristic for deriving said EMI characteristic, wherein

said EMI characteristic derivation means has:

an analysis model creation means for creating, as an analysis model of said circuit board, a simplified analysis model with a simplified virtual cable arranged in it, on the basis of said board design information;

a board analysis means for calculating virtual cable current flowing in said virtual cable by performing electromagnetic field analysis of said simplified analysis model; and

an EMI calculation means for calculating actual cable current flowing in said cable by the use of said virtual cable current and said cable length correction characteristic, and then by the use of said actual cable current, calculating said characteristic of EMI generated from said cable.

(Supplementary Note 2)

The circuit board design system according to supplementary note 1, wherein

said storage means stores an EMI permissive condition corresponding to a permissive condition of said EMI characteristic, and

the circuit board design system further comprises an EMI characteristic determination means for comparing said EMI characteristic derived by said EMI characteristic derivation means with said EMI permissive condition.

(Supplementary Note 3)

The circuit board design system according to supplementary note 2, wherein:

said EMI characteristic derivation means

has a cable length correction characteristic derivation means for deriving said cable length correction characteristic on the basis of said virtual cable current;

said analysis model creation means

creates a detailed board model in which the actual cable is reproduced, as an analysis model of said circuit board;

said board analysis means

calculates actual cable current flowing in the actual cable of said detailed board model, by performing electromagnetic field analysis of said detailed board model; and

said cable length correction characteristic derivation means

calculates a cable length correction characteristic by the use of the actual cable current calculated by said detailed board model and of said virtual cable current, and stores the cable length correction characteristic calculated on the basis of said detailed board model into said storage means.

(Supplementary Note 4)

The circuit board design system according to supplementary note 3, wherein:

said board design information includes circuit board design information corresponding to configuration information on said circuit board, semiconductor integrated circuit design information corresponding to internal design information on a semiconductor integrated circuit arranged on said circuit board and cable structure design information corresponding to information on said cable;

said input means

inputs said pieces of information extracted from said board design information into said EMI derivation means; and

said EMI characteristic derivation means

stores, into said storage means, said cable length correction characteristic derived by said cable length correction characteristic derivation means on the basis of said pieces of information included in said board design information, and updates said board design information, according to said EMI characteristic and said EMI permissive condition.

(Supplementary Note 5)

The circuit board design system according to supplementary note 4, wherein:

said EMI derivation means

derives said EMI characteristic with respect to each of a plurality of cable connection position candidates for connecting said cable, which are set on said circuit board; and

said EMI characteristic determination means

determines whether or not said EMI characteristic with respect to each of a plurality of cable connection position candidates satisfies said EMI permissive condition.

(Supplementary Note 6)

The circuit board design system according to supplementary note 5, wherein a graph of comparing said EMI characteristic with respect to each of a plurality of cable connection position candidates with said EMI permissive condition is outputted.

(Supplementary Note 7)

The circuit board design system according to supplementary note 2,

further comprising a board configuration change means for changing said board configuration if said EMI characteristic determination means determines that said EMI permissive condition is not satisfied, wherein:

said storage means

stores a guideline on change of said board configuration;

said board configuration change means

changes said board design information on the basis of said guideline on change; and

said EMI characteristic derivation means

derives said EMI characteristic by the use of said changed board design information.

(Supplementary Note 8)

The circuit board design system according to supplementary note 7, wherein said EMI characteristics with respect to, respectively, said board design information before change and said board design information after change are outputted, along with graphs of comparing the EMI characteristics with said EMI permissive condition.

(Supplementary Note 9)

The circuit board design system according to supplementary note 7, wherein:

said board design information includes circuit board design information corresponding to configuration information on said circuit board, semiconductor integrated circuit design information corresponding to internal design information on a semiconductor integrated circuit arranged on said circuit board and cable structure design information corresponding to information on said cable; and

said EMI characteristic derivation means

stores, into said storage means, said cable length correction characteristic derived by said cable length correction characteristic derivation means on the basis of pieces of information extracted from said board design information, and updates said board design information, according to said EMI characteristic and said EMI permissive condition.

(Supplementary Note 10)

The circuit board design system according to supplementary note 9, wherein,

if said EMI characteristic does not satisfy said permissive condition:

said board configuration change means

changes said board configuration, on the basis of said guideline on change which suggests that either of said circuit board design information, said semiconductor integrated circuit design information and said cable structure design information, which are included in said board design information, is to be changed sequentially until said EMI characteristic satisfies said permissive condition; and

said EMI derivation means

derives said EMI characteristic on the basis of said board configuration after change, and

if said EMI characteristic satisfies said permissive condition,

said board design information with respect to which said EMI characteristic satisfying said permissive condition is obtained is outputted.

(Supplementary Note 11)

The circuit board design system according to any one of supplementary notes 1 to 10, wherein the length of said virtual cable is set at a value equal to or smaller than ¼ of a wavelength corresponding to the maximum frequency in a frequency range where said EMI characteristic is to be derived.

(Supplementary Note 12)

A circuit board design method for designing a circuit board with a semiconductor component mounted on it and with a cable connected to it, the circuit board design method comprising:

inputting board design information on said circuit board;

creating, as an analysis model of said circuit board, a simplified analysis model with a simplified virtual cable arranged in it, on the basis of said board design information;

calculating virtual cable current flowing in said virtual cable by performing electromagnetic field analysis of said simplified analysis model;

calculating actual cable current flowing in said cable by the use of a cable length correction characteristic for deriving an EMI characteristic and said virtual cable current; and

calculating said characteristic of EMI generated from said cable by the use of said actual cable current.

(Supplementary Note 13)

The circuit board design method according to supplementary note 12, comprising:

setting an EMI permissive condition corresponding to a permissive condition of said EMI characteristic; and

comparing said EMI characteristic with said EMI permissive condition.

(Supplementary Note 14)

The circuit board design method according to supplementary note 13, comprising:

creating a detailed board model in which the actual cable is reproduced, as an analysis model of said circuit board, and calculating actual cable current flowing in the actual cable of said detailed board model, by performing electromagnetic field analysis of said detailed board model;

calculating a cable length correction characteristic by the use of the actual cable current calculated by said detailed board model and of said virtual cable current; and

using said cable length correction characteristic calculated on the basis of said detailed board model in said EMI characteristic derivation.

(Supplementary Note 15)

The circuit board design method according to supplementary note 14, comprising:

recording said cable length correction characteristic derived by the use of said board design information including circuit board design information corresponding to configuration information on said circuit board, semiconductor integrated circuit design information corresponding to internal design information on a semiconductor integrated circuit arranged on said circuit board and cable structure design information corresponding to information on said cable;

updating said board design information, according to said EMI characteristic and said EMI permissive condition.

(Supplementary Note 16)

The circuit board design method according to supplementary note 15, comprising:

setting a plurality of cable connection position candidates for connecting said cable, on said circuit board;

deriving said EMI characteristic with respect to each of said plurality of cable connection position candidates; and

determining whether or not said EMI characteristic with respect to each of a plurality of cable connection position candidates satisfies said EMI permissive condition.

(Supplementary Note 17)

The circuit board design method according to supplementary note 16, wherein,

if it is determined that said EMI permissive condition is not satisfied,

said board design information is changed on the basis of a guideline on change of said board configuration, and

said EMI characteristic is derived using said changed board design information.

(Supplementary Note 18)

The circuit board design method according to supplementary note 17, comprising:

recording said cable length correction characteristic derived by the use of said board design information including circuit board design information corresponding to configuration information on said circuit board, semiconductor integrated circuit design information corresponding to internal design information on a semiconductor integrated circuit arranged on said circuit board, and cable structure design information corresponding to information on said cable; and

updating said board design information, according to said EMI characteristic and said EMI permissive condition.

(Supplementary Note 19)

A circuit board design program, in a circuit board design system for designing a circuit board with a semiconductor component mounted on and a cable connected to it, the circuit board design program causing a computer to execute:

a process of inputting board design information on said circuit board;

a process of creating, as an analysis model of said circuit board, a simplified analysis model with a simplified virtual cable arranged in it, on the basis of said board design information;

a process of calculating virtual cable current flowing in said virtual cable by performing electromagnetic field analysis of said simplified analysis model;

a process of calculating actual cable current flowing in said cable by the use of a cable length correction characteristic for deriving an EMI characteristic and said virtual cable current; and

a process of calculating said characteristic of EMI generated from said cable by the use of said actual cable current.

(Supplementary Note 20)

The circuit board design program according to supplementary note 19, causing the computer to execute:

a process of setting an EMI permissive condition corresponding to a permissive condition of said EMI characteristic; and

a process of comparing said EMI characteristic with said EMI permissive condition.

(Supplementary Note 21)

The circuit board design program according to supplementary note 20, causing the computer to execute:

a process of creating a detailed board model in which the actual cable is reproduced, as an analysis model of said circuit board, and calculating actual cable current flowing in the actual cable of said detailed board model, by performing electromagnetic field analysis of said detailed board model;

a process of calculating a cable length correction characteristic by the use of the actual cable current calculated by said detailed board model and of said virtual cable current; and

a process of calculating said EMI characteristic by the use of said cable length correction characteristic calculated on the basis of said detailed board model.

(Supplementary Note 22)

The circuit board design program according to supplementary note 21, causing the computer to execute:

a process of recording said cable length correction characteristic derived by the use of said board design information including circuit board design information corresponding to configuration information on said circuit board, semiconductor integrated circuit design information corresponding to internal design information on a semiconductor integrated circuit arranged on said circuit board, and cable structure design information corresponding to information on said cable; and

a process of updating said board design information, according to said EMI characteristic and said EMI permissive condition.

(Supplementary Note 23)

The circuit board design program according to supplementary note 22, causing the computer to execute:

a process of setting a plurality of cable connection position candidates for connecting said cable, on said circuit board;

a process of deriving said EMI characteristic with respect to each of said plurality of cable connection position candidates; and

a process of determining whether or not said EMI characteristic with respect to each of a plurality of cable connection position candidates satisfies said EMI permissive condition.

(Supplementary Note 24)

The circuit board design program according to supplementary note 23, causing the computer to execute,

if it is determined that said EMI permissive condition is not satisfied:

a process of changing said board design information on the basis of a guideline on change of said board configuration; and

a process of deriving said EMI characteristic by the use of said changed board design information.

(Supplementary Note 25)

The circuit board design program according to supplementary note 24, causing the computer to execute:

a process of recording said cable length correction characteristic derived by the use of said board design information including circuit board design information corresponding to configuration information on said circuit board, semiconductor integrated circuit design information corresponding to internal design information on a semiconductor integrated circuit arranged on said circuit board, and cable structure design information corresponding to information on said cable; and

a process of updating said board design information, according to said EMI characteristic and said EMI permissive condition.

The present invention has been described above with reference to the exemplary embodiments and the practical example, but the present invention is not limited to the above-described exemplary embodiments and practical example. To the configurations and details of the present invention, various changes which are understandable to those skilled in the art may be made within the scope of the present invention.

This application is based upon and claims the benefit of priority from Japanese Patent Application No. 2012-255557, filed on Nov. 21, 2012, the disclosure of which is incorporated herein in its entirety by reference.

### REFERENCE SIGNS LIST

1 input means
2 EMI characteristic derivation means
3 database
4 analysis model creation means
5 board analysis means
6 EMI calculation means
7 output means
8 EMI characteristic determination means
9 cable length correction characteristic derivation means
10 storage device
11 PCB design information
12 LSI design information
13 cable structure design information
14 board configuration change means
20 PCB
21 transmission-side LSI
22 reception-side LSI
23 signal wiring
24 wiring current
25 mounting component
26 connector
27 cable.
28 cable current
29 EMI
30 cable connection position candidate
31 surface conductor layer
32 dielectric layer
33 internal conductor layer
34 via
35 layer configuration
41 transmission-side parameter
42 reception-side parameter
43 wiring parameter
44 board part parameter
45 component parameter
46 connector parameter
47 cable parameter
48 via parameter
51 board model
52 cable model
53 analysis space
54 actual cable current
55 EMI characteristic
56 virtual cable model
57 analysis space
58 virtual cable current
59 actual cable current
60 EMI characteristic
61 transmission end
62 reception end
63 signal wiring
64 cable connection position candidate
65 board
66 conductor layer
67 board model
68 cable model
69 analysis space
70 actual cable current
71 virtual cable model
72 analysis space
73 virtual cable current
81 signal wiring
82 dielectric material
83 power supply layer
84 ground layer
85 inner layer wiring
86 coupling
87 signal wiring
88 coupling
90 cable
101 electromagnetic field strength calculation device
102 navigation file
103 navigation file reading unit.
104 navigation-based data creation unit
105 memory unit
106 analysis input data file writing unit
107 analysis input data
108 electromagnetic field strength calculation unit
109 analysis result data
110 display unit
111 keyboard input unit
201 electromagnetic field strength calculation device
202 input means
203 electromagnetic field strength calculation means
204 output means
210 partitioning means
211 derivation means
212 calculation means
213 computation means

What is claimed is:

1. A circuit board design system for designing a circuit board with a semiconductor component mounted on it and with a cable connected to it, the circuit board design system comprising:
an input unit which inputs board design information about the board configuration of said circuit board;
an EMI characteristic derivation unit which derives a characteristic of EMI generated from said cable connected to said circuit board, on the basis of said board design information; and
a storage unit which stores a cable length correction characteristic for deriving said EMI characteristic, wherein
said EMI characteristic derivation unit has:
an analysis model creation unit which creates, as an analysis model of said circuit board, a simplified analysis model with a simplified virtual cable arranged in it, on the basis of said board design information;
a board analysis unit which calculates virtual cable current flowing in said virtual cable by performing electromagnetic field analysis of said simplified analysis model; and
an EMI calculation unit which calculates actual cable current flowing in said cable by the use of said virtual cable current and said cable length correction characteristic, and then by the use of said actual cable current, calculating said characteristic of EMI generated from said cable.

2. The circuit board design system according to claim 1, wherein
said storage unit stores an EMI permissive condition corresponding to a permissive condition of said EMI characteristic, and
the circuit board design system further comprises an EMI characteristic determination unit which compares said EMI characteristic derived by said EMI characteristic derivation unit with said EMI permissive condition.

3. The circuit board design system according to claim 2, wherein:
said EMI characteristic derivation unit
has a cable length correction characteristic derivation unit which derives said cable length correction characteristic on the basis of said virtual cable current;
said analysis model creation unit
creates a detailed board model in which the actual cable is reproduced, as an analysis model of said circuit board;
said board analysis unit
calculates actual cable current flowing in the actual cable of said detailed board model, by performing electromagnetic field analysis of said detailed board model; and
said cable length correction characteristic derivation unit
calculates a cable length correction characteristic by the use of the actual cable current calculated by said detailed board model and of said virtual cable current, and stores the cable length correction characteristic calculated on the basis of said detailed board model into said storage unit.

4. The circuit board design system according to claim 3, wherein:
said board design information includes circuit board design information corresponding to configuration information on said circuit board, semiconductor integrated circuit design information corresponding to internal design information on a semiconductor integrated circuit arranged on said circuit board and cable structure design information corresponding to information on said cable;
said input unit
inputs said pieces of information extracted from said board design information into said EMI derivation unit; and
said EMI characteristic derivation unit
stores, into said storage unit, said cable length correction characteristic derived by said cable length correction characteristic derivation unit on the basis of said pieces of information included in said board design information, and updates said board design information, according to said EMI characteristic and said EMI permissive condition.

5. The circuit board design system according to claim 4, wherein:
said EMI derivation unit
derives said EMI characteristic with respect to each of a plurality of cable connection position candidates for connecting said cable, which are set on said circuit board; and
said EMI characteristic determination unit
determines whether or not said EMI characteristic with respect to each of a plurality of cable connection position candidates satisfies said EMI permissive condition.

6. The circuit board design system according to claim 2,
further comprising a board configuration change unit which change said board configuration if it is determined by said EMI characteristic determination unit that said EMI permissive condition is not satisfied, wherein:
said storage unit
stores a guideline on change of said board configuration;
said board configuration change unit
changes said board design information on the basis of said guideline on change; and
said EMI characteristic derivation unit
derives said EMI characteristic by the use of said changed board design information.

7. The circuit board design system according to claim 6, wherein:
said board design information includes circuit board design information corresponding to configuration information on said circuit board, semiconductor integrated circuit design information corresponding to internal design information on a semiconductor integrated circuit arranged on said circuit board and cable structure design information corresponding to information on said cable; and
said EMI characteristic derivation unit
stores, into said storage unit, said cable length correction characteristic derived by said cable length correction characteristic derivation unit on the basis of pieces of information extracted from said board design information, and updates said board design information, according to said EMI characteristic and said EMI permissive condition.

8. The circuit board design system according to claim 1, wherein the length of said virtual cable is set at a value equal to or smaller than ¼ of a wavelength corresponding to the maximum frequency in a frequency range where said EMI characteristic is to be derived.

9. A circuit board design method for designing a circuit board with a semiconductor component mounted on it and with a cable connected to it, the circuit board design method comprising:
inputting board design information on said circuit board;
creating, as an analysis model of said circuit board, a simplified analysis model with a simplified virtual cable arranged in it, on the basis of said board design information;
calculating virtual cable current flowing in said virtual cable by performing electromagnetic field analysis of said simplified analysis model;
calculating actual cable current flowing in said cable by the use of a cable length correction characteristic for deriving an EMI characteristic and said virtual cable current; and
calculating said characteristic of EMI generated from said cable by the use of said actual cable current.

10. A program recording medium which records circuit board design program, in a circuit board design system for designing a circuit board with a semiconductor component mounted on and a cable connected to it, the circuit board design program causing a computer to execute:
a process of inputting board design information on said circuit board;
a process of creating, as an analysis model of said circuit board, a simplified analysis model with a simplified virtual cable arranged in it, on the basis of said board design information;
a process of calculating virtual cable current flowing in said virtual cable by performing electromagnetic field analysis of said simplified analysis model;
a process of calculating actual cable current flowing in said cable by the use of a cable length correction characteristic for deriving an EMI characteristic and said virtual cable current; and
a process of calculating said characteristic of EMI generated from said cable by the use of said actual cable current.
